(19) United States
(12) Patent Application Publication
(10) Pub. No.: US 2024/0316508 A1
(43) Pub. Date: Sep. 26, 2024

(54) ELECTRICAL SYNTHESIS OF CONTINUOUS METAL-ORGANIC FRAMEWORK MEMRANES

(71) Applicant: King Abdullah University of Science and Technology, Thuwal (SA)

(72) Inventors: Mohamed EDDAOUDI, Thuwal (SA); Sheng ZHOU, Thuwal (SA); Osama SHEKHAH, Thuwal (SA); Jiangtao JIA, Thuwal (SA)

(21) Appl. No.: 18/579,441

(22) PCT Filed: Jul. 13, 2022
(86) PCT No.: PCT/IB2022/056477

§ 371 Date: Jan. 15, 2024

Related U.S. Application Data
(60) Provisional application No. 63/221,110, filed on Jul. 13, 2021.

(51) Int. Cl. B01D 71/02; B01D 53/22; B01D 67/00; B01D 69/10

(52) U.S. Cl. CPC B01D 71/028; B01D 53/228; B01D 67/0079; B01D 69/108; B01D 2256/245; B01D 2257/102

(57) ABSTRACT

Embodiments include a method of making a continuous metal-organic framework membrane, the method including contacting a rare earth- or zirconium-containing compound, an acid, a solvent, and optionally water sufficient to form a hexanuclear cluster solution, contacting the hexanuclear cluster solution with one or more ditopic ligands sufficient to form a metal-organic framework (MOF) solution, contacting the MOF solution with a support, and applying a current to the MOF solution with support, sufficient to provide a continuous metal-organic framework membrane.

### BACKGROUND

There is a persisting need to explore new materials as prospective practical membranes for hydrocarbon separations since present polymers or mixed-matrix membranes (MMMs) lack the required permselectivity, and mostly plasticize at high pressures, except for some fluoropolymers. Polycrystalline membranes based on periodic porous materials, namely metal-organic frameworks (MOFs), encompassing precisely controlled pore-aperture sizes, are potential candidates for the aforementioned separations and are prone not to suffer from plasticization. To date, only polycrystalline ZIF-8/ZIF-67 membranes revealed promise for hydrocarbons separation, e.g. C₃H₆/C₃H₈, at atmospheric pressure. However, their structural instability under H₂S-containing environment, and their severely lessened selectivity at elevated feed pressures, due to the “gate-opening” effect (except for the special ZIF-8 membranes fabricated by the all-vapor process) hampered their deployment in industry-relevant conditions.

A suitable membrane material should offer mutually excellent molecular-sieving capability, inherent structure stability to H₂S, and unaltered pore-aperture size with pressure. The unique molecular-sieving properties and notable chemical stability of fcu-MOFs, assembled from 12-connected rare-earth (RE) or zirconium hexanuclear clusters and ditopic linkers, position fcu-MOFs as ideal candidates for pure MOF membranes. The fcu-MOF platform offers the ability to fine-tune the triangular windows, sole entrance to their pore system, via isoreticulation by deploying metal clusters and/or organic linkers with appropriate length and/or bulkiness. Indeed, fcu-MOFs as sorbents and fillers in MMMs were explored for various key separations and H₂S-related applications. Commonly owned U.S. Pat. Nos. 10,486,133 and 9,266,907 are herein incorporated by reference.

Nevertheless, countless attempts to fabricate defect-free polycrystalline membranes based on the elected fcu-MOFs using the conventional solvothermal approach have not been conclusive, leading to the construction of non-continuous films with visible pinholes and cracks. The ability to synthesize fcu-MOFs at room temperature offers potential to fabricate their associated continuous membranes, if the pre-assembled hexanuclear molecular building block (MBB) [RE₆(μ₃-OH)₈(O₂C—)₁₂] or [Zr₆O₄(OH)₄(O₂C—)₁₂] is available and subsequently its capping terminal ligands can be exchanged in a controlled manner with the bridging ligands. Since the ligand exchange relies on various factors (e.g. the deprotonation rate of the ditopic linkers, the ligands solubility and pKa), the direct exchange seems less controllable and not practicable for membrane assembly, where fast exchange rate resulted in amorphous products and slow kinetics afforded non-continuous layers. The introduction of a synthetic pathway affording the regulated deprotonation and continuous supply of deprotonated linkers will be beneficial, as it will provide the appropriate ligand exchange and prospects for the formation of defect-free MOF membranes.

### SUMMARY

Embodiments of the present disclosure include a method of making a continuous metal-organic framework membrane, the method including contacting a rare earth- or zirconium-containing compound, an acid, a solvent, and optionally water sufficient to form a hexanuclear cluster solution, contacting the hexanuclear cluster solution with one or more ditopic ligands sufficient to form a metal-organic framework (MOF) solution, contacting the MOF solution with a support, and applying a current to the MOF solution with support, sufficient to provide a continuous metal-organic framework membrane.

### BRIEF DESCRIPTION OF THE DRAWINGS

FIG. 1A is a flow chart illustrating electrical synthesis of continuous metal-organic framework membranes, according to one or more embodiments.

FIGS. 2A-G show schematic and graphical views of isoreticulation of fcu-MOFs and designed synthesis of the fcu-MOF membranes, according to some embodiments of the present disclosure. FIG. 2A shows three different kinds of representation of the hexanuclear cluster. RE/Zr, C, O and H are represented by light/dark blue, gray, red, and white, respectively. FIG. 2B shows the augmented fcu-net. The octahedral cage is illustrated with the ball and the tetrahedral cage is surrounded by triangles. FIG. 2C shows schematic illustration of the triangular windows as the sole entrance for guest molecules and molecular-sieving. FIG. 2D shows three strategies to tune the aperture sizes of the fcu-MOFs. FIG. 2E shows top-down isolation of the molecular-building blocks (MBB) for structure analysis and bottom-up reassembly of each MBB to get continuous, well-intergrown polycrystalline layers under the assistance of the external current. The fum linker is used as a schematic example, which could be replaced by any ditopic linker. FIGS. 2F-G show two guidelines that permit the discovery of the optimal conditions for the synthesis of continuous RE-fcu-MOF and Zr-fcu-MOF membranes, respectively. The two lines represent the formulas derived from the direct calculation ([H₂Lₓ]_{RE-fcu-MOF}=6.262×10^{(pKa-5)}, [H₂Lₓ]_{zr-fcu-MOF}=2.319×10^{(pKa-5)}). The boundary conditions are marked with different colors. Violet, amorphous layers. Dark cyan, cracked layers. Green, continuous layers. Light yellow, discrete layers. Grey, amorphous layers.

FIGS. 3A-O show image views of SEM images and XRD patterns for the explored fcu-MOF membranes. FIG. 3A, shows top-view morphology of the Y-fum-fcu-MOF layers when using the diluted cluster solution (5 mM). FIGs. B-E, Top-view morphology of the Y-fum-fcu-MOF layers when the ratio of ligand to cluster is 4:1 (B), 5.6:1 (C), 8:1 (D) and 9:1 (E) with the cluster concentration fixed at 15 mM. FIG. 3F, shows cross-section morphology of the Y-fum-fcu-MOF membrane when the ratio of ligand to cluster is 5.6:1. FIG. 3G, XRD patterns of the obtained Y-fum-fcu-MOF layers at different conditions. (FIGs. H-O), Top-view (inset) and cross-section SEM images of other 8 fcu-MOF membranes. FIG. 3H, shows Zr-fum-fcu-MOF membrane. FIG. 3I, shows Y-mes-fcu-MOF membrane, mes: mesaconate. FIG. 3J, shows Zr-mes-fcu-MOF membrane. FIG. 3K, shows Y-tpa-fcu-MOF membrane, tpa: terephthalate. FIG. 3L, shows Zr-tpa-fcu-MOF membrane. FIG. 3M, shows Y-naph-fcu-MOF membrane, naph: 1,4-naphthalenedicarboxylate. FIG. 3N, shows Zr-naph-fcu-MOF membrane. FIG. 3O, shows Y-aminotpa-fcu-MOF membrane, aminotpa: 2-aminoterephthalate.

FIGS. 4A-D show graphical views of gas separation performances of the fcu-MOF membranes. FIGS. 4A-B, shows C₃H₆/C₃H₈ (A) and nC₄/iC₄ (B) equimolar mixture separation performance of the Zr-fum-fcu-MOF membranes (★) that repeated for nine independent membranes with similar results, and Y-fum-fcu-MOF membranes (★) that repeated for five independent membranes with similar results. n value used to calculate the average performance and error bars of the Zr-fum-fcu-MOF and Y-fum-fcu-MOF membranes is 9 and 5 respectively. Other reported polymer membranes (□, Δ), mixed-matrix membranes (▴) and MOF membranes (♦, ●) are compared. The black and blue line are guides to the eye and are used to indicate the trade-off between the permeance and selectivity/separation factor in the reported polymer-based membranes and ZIF-8 membranes respectively. The blue dot line indicates the performance beyond the capability of normal ZIF-8 membranes due to the linker mobility. FIG. 4C, shows percentages of three different conformers of C₃H₈ at 298K according to the Boltzmann distribution. S-S: staggered-staggered. E-S: eclipsed-staggered. E-E: eclipsed-eclipsed (double eclipsed). Carbon, grey. Hydrogen, blue, white and green. Hydrogen atoms on different carbon atoms are marked by different colors. FIG. 4D, shows single-gas permeations of the Zr-fum-fcu-MOF membranes and Y-fum-fcu-MOF. The shadow area indicates a cut-off between two molecules.

FIGS. 5A-D show graphical views of C₃H₆/C₃H₈ separation performance of Zr-fum-fcu-MOF membranes at practical conditions. FIG. 5A, shows C₃H₆/C₃H₈ mixed-gas separation performance of the Zr-fum-fcu-MOF membranes as a function of feed pressure (1 to 7 atm) that repeated for three independent membranes with similar results. The permeance of C₃H₈ is multiplied by 30 for clearer observation. FIG. 5B, shows C₃H₆/C₃H₈ separation factor changes (lines, right Y-axis) and change percentages (columns, left Y-axis) when the feed pressure goes beyond 1 atm. The Zr-fum-fcu-MOF membrane is compared with the other state-of-the-art MOF membranes and it is so far the only membrane showing a positive change with the increased pressure. This performance is repeated for three independent membranes with similar results. (n=3) FIG. 5C, shows C₃H₆/C₃H₈ equimolar mixture separation factors and C₃H₆ fluxes of the Zr-fum-fcu-MOF membranes (★, ★, ★). Other reported MOF membranes (♦) are compared and Zr-fum-fcu-MOF membranes embrace the most attractive combinations. FIG. 5D, shows long-term stability measurement of the Zr-fum-fcu-MOF membranes during the continuous operation.

FIGS. 6A-D show graphical views of a summary of the techno-economic analysis comparison of the distillation and membrane-distillation hybrid system. FIG. 6A, shows energy and utility consumptions for both systems at 7 and 15 bar. FIG. 6B, shows distribution of the utility cost at 7 bar for both systems. FIG. 6C, shows equipment cost distribution of the hybrid system at 7 bars. DISTCOL-reb: distillation column reboiler. HEATX: heat-exchanger after the compressor. DISTCOL-cond: distillation column condenser. COMP: compressor. DISTCOL-tower: distillation column tower. FIG. 6D, shows evaluation of the purification cost per tonne of propylene in the both systems at 7 bar.

FIGS. 7A-D show views of a schematic illustration of the current-driven assembly of fcu-MOF membranes under different concentrations of the deprotonated ligands. FIG. 7A, shows a schematic illustration of the reaction around the porous support and the working mechanism during the growth of membranes. FIGs. B-D, show a schematic illustrations of the growth of membranes with suitable (B), excessive (C), and insufficient (D) concentration of the deprotonated ligands in the solution. The external current with enough density given from the porous supports can make sure all the dissociated protons from the ligands to be removed immediately so the equilibrium shifts to the right side to generate more deprotonated ligands (L²⁻) for the assembly of MOFs. However, how fast the L²⁻ is produced and how large the concentration of L²⁻ ([L²⁻]) can reach in unit time is limited by the acid dissociation constant, and different values of [L²⁻] can lead to membranes with different levels of quality. We can assume that a suitable [L²⁻] in the initial stage (t=0), namely [L²⁻]=[L²⁻]_{ideal}, will give continuous and well-intergrown polycrystalline membranes on the support (B). However, if [L²⁻] is too large, namely [L²⁻]>>[L²⁻]_{ideal}, L²⁻ cannot be confined only around the support surface, MOFs will be formed in the bulk solution, instead of on the support (C), while If [L²⁻] is too small, namely [L²⁻]<<<[L²⁻]_{ideal}, the kinetic of the MOF formation will be very slow, sometimes it could be zero due to the unmatched stoichiometric ratio. Continuous layer cannot be obtained (D).

FIG. 8 shows a schematic view of a schematic illustration of the current-driven assembly of fcu-MOF membranes from fum as a primary example and discovery of the guideline for other membranes. Y/Zr-fum-fcu-MOF membranes were first studied as primary examples, where experimental explorations were conducted to find the optimal conditions to get continuous MOF layers.

FIG. 9 shows a schematic view of a schematic illustration of the design of different fcu-MOFs by the isoreticular approach.

FIGS. 10A-I show chart views of XRD patterns of fcu-MOF membranes prepared according to the developed formulas. FIG. 10A, shows a Y-fum-fcu-MOF membrane. FIG. 10B, shows a Zr-fum-fcu-MOF membrane. FIG. 10C, shows a Y-mes-fcu-MOF membrane. FIG. 10D, shows a Zr-mes-fcu-MOF membrane. FIG. 10E, shows a Y-tpa-fcu-MOF membrane. f, Zr-tpa-fcu-MOF membrane. FIG. 10G, shows a Y-naph-fcu-MOF membrane. FIG. 10H, shows a Zr-naph-fcu-MOF membrane. FIG. 10I, shows a Y-aminotpa-fcu-MOF membrane.

FIGS. 11A-I show image views of SEM images of the resultant amorphous membranes when the ligand concentrations are obviously smaller (−90% to −70%) than the calculated values from the developed formulas. FIG. 11A, shows a Y-fum-fcu-MOF membrane (−70%). FIG. 11B, shows a Zr-fum-fcu-MOF membrane (−70%). FIG. 11C, shows a Y-mes-fcu-MOF membrane (−70%). FIG. 11D, shows a Zr-mes-fcu-MOF membrane (−90%). FIG. 11E, shows a Y-tpa-fcu-MOF membrane (−85%). FIG. 11F, shows a Zr-tpa-fcu-MOF membrane (−90%). FIG. 11G, shows a Y-naph-fcu-MOF membrane (−75%). FIG. 11H, shows a Zr-naph-fcu-MOF membrane (−85%). FIG. 11I, shows a Y-aminotpa-fcu-MOF membrane (−90%).

FIGS. 12A-I show chart views of XRD patterns of the resultant amorphous membranes when the ligand concentrations are obviously smaller (−90% to −70%) than the calculated values from the developed formulas. FIG. 12A, shows a Y-fum-fcu-MOF membrane (−70%). FIG. 12B, shows a Zr-fum-fcu-MOF membrane (−70%). FIG. 12C, shows a Y-mes-fcu-MOF membrane (−70%). FIG. 12D, shows a Zr-mes-fcu-MOF membrane (−90%). FIG. 12E, shows a Y-tpa-fcu-MOF membrane (−85%). FIG. 12F, shows a Zr-tpa-fcu-MOF membrane (−90%). FIG. 12G, shows a Y-naph-fcu-MOF membrane (−75%). FIG. 12H, shows a Zr-naph-fcu-MOF membrane (−85%). FIG. 12I, shows a Y-aminotpa-fcu-MOF membrane (−90%).

FIGS. 13A-I show graphical views of SEM images of the resultant discrete membranes when the ligand concentrations are much smaller (−65% to −25%) than the calculated values from the developed formulas. FIG. 13A, shows a Y-fum-fcu-MOF membrane (−40%). FIG. 13B, shows a Zr-fum-fcu-MOF membrane (−35%). FIG. 13C, shows a Y-mes-fcu-MOF membrane (−50%). FIG. 13D, shows a Zr-mes-fcu-MOF membrane (−50%). FIG. 13E, shows a Y-tpa-fcu-MOF membrane (−65%). FIG. 13F, shows a Zr-tpa-fcu-MOF membrane (−60%). FIG. 13G, shows a Y-naph-fcu-MOF membrane (−25%). FIG. 13H, shows a Zr-naph-fcu-MOF membrane (−50%). FIG. 13I, shows a Y-aminotpa-fcu-MOF membrane (−40%).

FIGS. 14A-I show chart views of XRD patterns of the resultant discrete membranes when the ligand concentrations are much smaller (−65% to −25%) than the calculated values from the developed formulas. FIG. 14A, shows a Y-fum-fcu-MOF membrane (−40%). FIG. 14B, shows a Zr-fum-fcu-MOF membrane (−35%). FIG. 14C, shows a Y-mes-fcu-MOF membrane (−50%). FIG. 14D, shows a Zr-mes-fcu-MOF membrane (−50%). FIG. 14E, shows a Y-tpa-fcu-MOF membrane (−65%). FIG. 14F, shows a Zr-tpa-fcu-MOF membrane (−60%). FIG. 14G, shows a Y-naph-fcu-MOF membrane (−25%). FIG. 14H, shows a Zr-naph-fcu-MOF membrane (−50%). FIG. 14I, shows a Y-aminotpa-fcu-MOF membrane (−40%).

FIGS. 15A-I show image views of SEM images of the resultant continuous membranes when the ligand concentrations are slightly smaller (−20% to −5%) than the calculated values from the developed formulas. FIG. 15A, shows a Y-fum-fcu-MOF membrane (−15%). FIG. 15B, shows a Zr-fum-fcu-MOF membrane (−20%). FIG. 15C, shows a Y-mes-fcu-MOF membrane (−5%). FIG. 15D, shows a Zr-mes-fcu-MOF membrane (−10%). FIG. 15E, shows a Y-tpa-fcu-MOF membrane (−20%). FIG. 15F, shows a Zr-tpa-fcu-MOF membrane (−15%). FIG. 15G, shows a Y-naph-fcu-MOF membrane (−10%). FIG. 15H, shows a Zr-naph-fcu-MOF membrane (−20%). FIG. 15I, shows a Y-aminotpa-fcu-MOF membrane (−20%).

FIGS. 16A-I show chart views of XRD patterns of the resultant continuous membranes when the ligand concentrations are slightly smaller (−20% to −5%) than the calculated values from the developed formulas. FIG. 16A, shows a Y-fum-fcu-MOF membrane (−15%). FIG. 16B, shows a Zr-fum-fcu-MOF membrane (−20%). FIG. 16C, shows a Y-mes-fcu-MOF membrane (−5%). FIG. 16D, shows a Zr-mes-fcu-MOF membrane (−10%). FIG. 16E, shows a Y-tpa-fcu-MOF membrane (−20%). FIG. 16F, shows a Zr-tpa-fcu-MOF membrane (−15%). FIG. 16G, shows a Y-naph-fcu-MOF membrane (−10%). FIG. 16H, shows a Zr-naph-fcu-MOF membrane (−20%). FIG. 16I, shows a Y-aminotpa-fcu-MOF membrane (−20%).

FIGS. 17A-I show image views of SEM images of the resultant continuous membranes when the ligand concentrations are slightly higher (+5% to +25%) than the calculated values from the developed formulas. FIG. 17A, shows a Y-fum-fcu-MOF membrane (+20%). FIG. 17B, shows a Zr-fum-fcu-MOF membrane (+10%). FIG. 17C, shows a Y-mes-fcu-MOF membrane (+25%). FIG. 17D, shows a Zr-mes-fcu-MOF membrane (+10%). FIG. 17E, shows a Y-tpa-fcu-MOF membrane (+15%). FIG. 17F, shows a Zr-tpa-fcu-MOF membrane (+5%). FIG. 17G, shows a Y-naph-fcu-MOF membrane (+20%). FIG. 17H, shows a Zr-naph-fcu-MOF membrane (+10%). FIG. 17I, shows a Y-aminotpa-fcu-MOF membrane (+10%).

FIGS. 18A-I show chart views of XRD patterns of the resultant continuous membranes when the ligand concentrations are slightly higher (+5% to +25%) than the calculated values from the developed formulas. FIG. 18A, shows a Y-fum-fcu-MOF membrane (+20%). FIG. 18B, shows a Zr-fum-fcu-MOF membrane (+10%). FIG. 18C, shows a Y-mes-fcu-MOF membrane (+25%). FIG. 18D, shows a Zr-mes-fcu-MOF membrane (+10%). FIG. 18E, shows a Y-tpa-fcu-MOF membrane (+15%). FIG. 18F, shows a Zr-tpa-fcu-MOF membrane (+5%). FIG. 18G, shows a Y-naph-fcu-MOF membrane (+20%). FIG. 18H, shows a Zr-naph-fcu-MOF membrane (+10%). FIG. 18I, shows a Y-aminotpa-fcu-MOF membrane (+10%).

FIGS. 19A-I show image views of SEM images of the resultant cracked membranes when the ligand concentrations are much higher (+30% to +95%) than the calculated values from the developed formulas. FIG. 19A, shows a Y-fum-fcu-MOF membrane (+60%). FIG. 19B, shows a Zr-fum-fcu-MOF membrane (+65%). FIG. 19C, shows a Y-mes-fcu-MOF membrane (+95%). FIG. 19D, shows a Zr-mes-fcu-MOF membrane (+50%). FIG. 19E, shows a Y-tpa-fcu-MOF membrane (+55%). FIG. 19F, shows a Zr-tpa-fcu-MOF membrane (+50%). FIG. 19G, shows a Y-naph-fcu-MOF membrane (+45%). FIG. 19H, shows a Zr-naph-fcu-MOF membrane (+60%). FIG. 19I, shows a Y-aminotpa-fcu-MOF membrane (+35%).

FIGS. 20A-I show chart views of XRD patterns of the resultant cracked membranes when the ligand concentrations are much higher (+30% to +95%) than the calculated values from the developed formulas. FIG. 20A, shows a Y-fum-fcu-MOF membrane (+60%). FIG. 20B, shows a Zr-fum-fcu-MOF membrane (+65%). FIG. 20C, shows a Y-mes-fcu-MOF membrane (+95%). FIG. 20D, shows a Zr-mes-fcu-MOF membrane (+50%). FIG. 20E, shows a Y-tpa-fcu-MOF membrane (+55%). FIG. 20F, shows a Zr-tpa-fcu-MOF membrane (+50%). FIG. 20G, shows a Y-naph-fcu-MOF membrane (+45%). FIG. 20H, shows a Zr-naph-fcu-MOF membrane (+60%). FIG. 20I, shows a Y-aminotpa-fcu-MOF membrane (+35%).

FIGS. 21A-I show image views of SEM images of the resultant amorphous membranes when the ligand concentrations are obviously higher (+100% to +200%) than the calculated values from the developed formulas. FIG. 21A, shows a Y-fum-fcu-MOF membrane (+160%). FIG. 21B, shows a Zr-fum-fcu-MOF membrane (+100%). FIG. 21C, shows a Y-mes-fcu-MOF membrane (+200%). FIG. 21D, shows a Zr-mes-fcu-MOF membrane (+150%). FIG. 21E, shows a Y-tpa-fcu-MOF membrane (+130%). FIG. 21F, shows a Zr-tpa-fcu-MOF membrane (+160%). FIG. 21G, shows a Y-naph-fcu-MOF membrane (+170%). FIG. 21H, shows a Zr-naph-fcu-MOF membrane (+170%). FIG. 21I*, shows a Y-aminotpa-fcu-MOF membrane (+120%).

FIGS. 22A-I show chart views of XRD patterns of the resultant amorphous membranes when the ligand concentrations are obviously higher (+100% to +200%) than the calculated values from the developed formulas. FIG. 22A, shows a Y-fum-fcu-MOF membrane (+160%). FIG. 22B, shows a Zr-fum-fcu-MOF membrane (+100%). FIG. 22C, shows a Y-mes-fcu-MOF membrane (+200%). FIG. 22D, shows a Zr-mes-fcu-MOF membrane (+150%). FIG. 22E, shows a Y-tpa-fcu-MOF membrane (+130%). FIG. 22F, shows a Zr-tpa-fcu-MOF membrane (+160%). FIG. 22G, shows a Y-naph-fcu-MOF membrane (+170%). FIG. 22H, shows a Zr-naph-fcu-MOF membrane (+170%). FIG. 22I, shows a Y-aminotpa-fcu-MOF membrane (+120%).

FIGS. 23A-B show graphical views of single-gas permeation results of the Y-fum-fcu-MOF membranes at room temperature. FIG. 23A, shows gas permeances for different probe molecules. FIG. 23B, shows ideal selectivity for different gas pairs. The selectivity from Knudsen diffusion is compared.

FIGS. 24A-B show graphical views of single-gas permeation results of the Zr-fum-fcu-MOF membranes at room temperature. FIG. 24A, shows gas permeances for different probe molecules. FIG. 24B, shows ideal selectivity for different gas pairs. The selectivity from Knudsen diffusion is compared.

FIGS. 25A-B show graphical views of single-gas permeation results of the Y-mes-fcu-MOF membranes at room temperature. FIG. 25A, shows gas permeances for different probe molecules. FIG. 25B, shows ideal selectivity for different gas pairs. The selectivity from Knudsen diffusion is compared.

FIGS. 26A-B show graphical views of single-gas permeation results of the Zr-mes-fcu-MOF membranes at room temperature. FIG. 26A, shows gas permeances for different probe molecules. FIG. 26B, shows ideal selectivity for different gas pairs. The selectivity from Knudsen diffusion is compared.

FIGS. 27A-B show graphical views of single-gas permeation results of the Y-tpa-fcu-MOF membranes at room temperature. FIG. 27A, shows gas permeances for different probe molecules. FIG. 27B, shows ideal selectivity for different gas pairs. The selectivity from Knudsen diffusion is compared.

FIGS. 28A-B show graphical views of single-gas permeation results of the Zr-tpa-fcu-MOF membranes at room temperature. FIG. 28A, shows gas permeances for different probe molecules. FIG. 28B, shows ideal selectivity for different gas pairs. The selectivity from Knudsen diffusion is compared.

FIGS. 29A-B show graphical views of single-gas permeation results of the Y-naph-fcu-MOF membranes at room temperature. FIG. 29A, shows gas permeances for different probe molecules. FIG. 29B, shows ideal selectivity for different gas pairs. The selectivity from Knudsen diffusion is compared.

FIGS. 30A-B show graphical views of single-gas permeation results of the Zr-naph-fcu-MOF membranes at room temperature. FIG. 30A, shows gas permeances for different probe molecules. FIG. 30B, shows ideal selectivity for different gas pairs. The selectivity from Knudsen diffusion is compared.

FIGS. 31A-B show graphical views of single-gas permeation results of the Y-aminotpa-fcu-MOF membranes at room temperature. FIG. 31A, shows gas permeances for different probe molecules. FIG. 31B, shows ideal selectivity for different gas pairs. The selectivity from Knudsen diffusion is compared.

FIG. 32 shows the schematic view of a schematic illustration of the Wicke-Kallenbach technique based set-up used for gas permeation measurements. The module is designed for plate-shape membranes.

FIG. 33 shows a graphical view of the temperature profile during the on-stream activation process. The membrane is first heated from 25° C. to 155° C. with a ramp rate of 0.1° C. min⁻¹, and then is kept at 155° C. for 12 h, after which the membrane is cooled down to 25° C. by 1.4° C. min⁻¹. During the activation, the membrane is fed with CO₂/N₂ equimolar mixture and swept by He.

FIG. 34A-I show image views of SEM images of the fcu-MOF membranes after solvent (methanol) exchange activation. FIG. 34A, shows a Y-fum-fcu-MOF membrane. FIG. 34B, shows a Zr-fum-fcu-MOF membrane. FIG. 34C, shows a Y-mes-fcu-MOF membrane. FIG. 34D, shows a Zr-mes-fcu-MOF membrane. FIG. 34E, shows a Y-tpa-fcu-MOF membrane. FIG. 34F, shows a Zr-tpa-fcu-MOF membrane. FIG. 34G, shows a Y-naph-fcu-MOF membrane. FIG. 34H, shows a Zr-naph-fcu-MOF membrane. FIG. 34I, shows a Y-aminotpa-fcu-MOF membrane. Solvent exchange always leads to the formation of cracks between crystals, so on-stream activation is necessary to prevent the rapid leaving of solvent molecules from the cages thus avoiding the possible damage to the membrane grain boundary structure.

FIGS. 35A-B show graphical views of temperature dependent C₃H₆/C₃H₈ separation performance of the Zr-fum-fcu-MOF membrane. FIG. 35A, shows changes of permeances and separation factors with the temperature. FIG. 35B, shows change percentage of permeances and separation factors with the temperature.

FIG. 36 shows a graphical view of arrhenius temperature dependence C₃H₆ and C₃H₈ permeances for the Zr-fum-fcu-MOF membrane. The temperature dependence of gas permeation can be stated by Arrhenius equation,

$${P}_{i} = {A}_{i} exp ( - \frac{{E}_{act , i}}{R T} ) , ln {P}_{i} = a - \frac{{E}_{act , i}}{R} \cdot \frac{1}{T} ,$$

where Pᵢ is the gas permeance of component i, Aᵢ represents for the pre-exponential factor of component i, E_{act,i} is the apparent activation energy of component i, R is the ideal gas constant (8.314 J mol⁻¹ K⁻¹) and T is the absolute temperature (K). A plot of ln (Pᵢ) versus 1/T gives a straight line, whose slope is used to calculate E_{act,i}. The E_{act,C}_{₃}_{H}_{₆} is about 7.887 kJ mol⁻¹, and E_{act,C}_{₃}_{H}_{₈} is about 19.28 kJ mol⁻¹.

FIGS. 37A-F show graphical views of continuous temperature-swing operation and the corresponding C₃H₆/C₃H₈ separation performance of the Zr-fum-fcu-MOF membrane. FIG. 37A, shows 2^{nd} cycle. FIG. 37B, shows 3^{rd} cycle. FIG. 37C, shows 4^{th} cycle. FIG. 37D, shows 5^{th} cycle. FIG. 37E, shows the stacked pattern of the 1st to 5th cycle, demonstrating the good reproducibility as well as stability. FIG. 37F, shows the temperature profile of an individual temperature-swing measurement. During the measurement, the membrane was maintained for 120 min at each temperature, and the data that recorded at ˜0 min, ˜60^{th} min, and ˜120^{th} min for each temperature period were used for plotting.

FIG. 38 shows a graphical view of changes of the C₃H₆/C₃H₈ separation factor from 1 to 7 atm for three identical Zr-fum-fcu-MOF membranes. All the three membranes show increasing separation factor when the feed pressure increased from 1 to 7 atm.

FIGS. 39A-B show graphical views of high-pressure adsorption isotherms of C₃H₆ and C₃H₈ for Zr-fum-fcu-MOF³. FIG. 39A, shows C₃H₆ at 308K. FIG. 39B, shows C₃H₈ at 308K.

FIGS. 40A-B show graphical views with schematic illustration of the gas permeation process through the nanoporous membranes (FIG. 40A) and a typical adsorption isotherm profile for MOFs (FIG. 40B).

FIGS. 41A-D show image and graphical views of the stability tests of Zr-fum-fcu-MOF membranes. FIG. 41A, shows a SEM image of the Zr-fum-fcu-MOF membrane after H₂S treatment. The grain boundary structure is still intact except the existence of some dirties on the surface. FIG. 41B, shows a XRD pattern of the Zr-fum-fcu-MOF membrane after H₂S treatment compared with simulated. FIG. 41C, shows a C₃H₆/C₃H₈ mixed-gas separation performance before and after H₂S treatment. Permeation data during the H₂S treatment was not collected due to safety reasons, but the maintained separation capability after H₂S treatment is adequate to prove the membrane stability. FIG. 41D, shows a C₃H₆/C₃H₈ mixed-gas separation performance before, during, and after humid feed with 3% water vapor⁴. After switching from the dry feed to humid feed, both the permeance and selectivity decrease, due to Zr-fum-fcu-MOF affinity to water⁵ and subsequent pore system blockage by adsorbed water molecules. After switching back to the dry feed, the separation performance was fully recovered to match the original performance, indicating this membrane is stable under humid atmosphere.

FIGS. 42A-D shows image and graphical views of Zr-fum-fcu-MOF membranes prepared on α-Al₂O₃ supports. FIG. 42A, shows a SEM image from the top view. FIG. 42B, shows a SEM image from the cross-section view. FIG. 42C, shows a XRD pattern. FIG. 42D, shows a C₃H₆/C₃H₈ mixed-gas separation performance under different pressures.

FIGS. 43A-F show image and graphical views of Zr-fum-fcu-MOF membranes prepared on stainless-steel net (SSN) supports. FIG. 43A, shows a SEM image of the bare stainless-steel net. FIG. 43B, shows a SEM image of the stainless-steel nets modified by carbon nanotubes. FIG. 43C, shows a SEM image of the Zr-fum-fcu-MOF membrane from the top view. FIG. 43D, shows a SEM image of the Zr-fum-fcu-MOF membrane from the cross-section view. FIG. 43E, shows a XRD pattern of the synthesized on the SSN compared with the simulated. FIG. 43F, shows a C₃H₆/C₃H₈ mixed-gas separation performance under different pressures. SSN-supported membranes show slightly better separation performance than the membranes prepared on Anodisc and α-Al₂O₃ supports. The improved permeance could be ascribed to the use of macroporous SSN as the support with higher void volume compared with other supports. The increased selectivity could be ascribed to the improved surface roughness by CNT coating, which contributes to a better membrane quality as suggested by Sheng et al.

FIG. 44 shows a graphical view of C₃H₆/C₃H₈ mixed-gas separation performance of Zr-fam-fcu-MOF membranes on three different supports with or without sweep gas. Feed gas: 50/50 C₃H₆/C₃H₈ mixture, 7 atm.

FIGS. 45A-B show a schematic view of the process flow diagram of the single distillation column system. FIG. 45A, shows 7 bar. FIG. 45B, shows 15 bar.

FIGS. 46A-B show a schematic view of the process flow diagram of the hybrid membrane-distillation column system. FIG. 46A, shows 7 bar. FIG. 46B, shows 15 bar.

FIG. 47 shows a graphical view of the effect of the heat integration in the distillation column in the energy consumption for the distillation and membrane-distillation hybrid system at 7 bar for 50% energy saving and 75% energy saving in the column. The heat integration lessens the benefits of the membrane system but, however, is still more competitive than the single distillation system for both cases.

FIG. 48 shows a graphical view of the effect of the membrane lifetime on the membrane breakeven price for the membrane-distillation hybrid system at 7 bar and 15 bar. It is clear the breakeven cost is very sensitive to the membrane lifetime.

FIG. 49 shows a graphical view of the evaluation of the purification cost per ton of propylene in the single and hybrid distillation system at 15 bar separation.

FIGS. 50A-B show graphical views of the effect of the permeance and selectivity changes of membranes on the membrane hybrid system final distillation cost at 7 bar operation. FIG. 50A, shows the effect of permeance when selectivity is fixed at 130. Lower permeance implies higher cost of distillation as the membrane needs to be bigger for the same C₃H₆ flux. However, this effect greatly depends on the membrane price, being more pronounced for expensive membranes. Nevertheless, for permeance above 90 GPU, increasing it barely affects the distillation price. FIG. 50B, shows the effect of selectivity when the permeance is fixed at 90 GPU. Lower selectivity implies higher distillation cost, mostly because the reflux ratio of the column needs to be increased to match the desired C₃H₆ purity. However, this effect is less pronounced than the permeance and even with low selectivity membranes (i.e. 25 separation factor), distillation costs below 20 $ per ton can be achieved with the hybrid membrane system.

FIG. 51 shows a graphical view of the evaluation of the purification cost per ton of isobutane in the membrane system.

FIGS. 52A-C show schematic views of schematic illustrations of pore-aperture editing and shape-mismatch-induced separation based on shape difference. FIG. 52A, shows the molecular configurations of CH₄ and N₂, and structures of fumaric acid and mesaconic acid, respectively. The tetrahedral CH₄ molecule shows a trefoil-shaped side-view profile, while the linear N₂ molecule shows a circular side-view profile. FIG. 52B, shows illustrations of the regular trefoil-shaped pore-aperture of Zr-fum-fcu-MOF and the free diffusions of both CH₄ and N₂ molecules. FIG. 52C, shows illustrations of the irregular entrance of Zr-fum-mes-fcu-MOF created by subtle pore-aperture editing. The tetrahedral CH₄ molecule is excluded due to the shape mismatch with the modified irregular entrance, while the linear N₂ molecule can still freely diffuse. (fum: fumarate; mes: mesaconate)

FIGS. 53A-J show chart and image views of synthetic guide and characterization of pore-aperture-edited Zr-fum₍₁₀₀₋ₓ₎-mesₓ-fcu-MOF membranes. FIG. 53A, shows the prediction of the required concentrations of ligands for continuous MOF membranes as functions of ligand pKa values using an electrochemical approach in an aqueous system. FIG. 53B, shows required concentrations of fumaric acid and mesaconic acid as functions of targeted mes percentages for the preparation of Zr-fum₍₁₀₀₋ₓ₎-mesₓ-fcu-MOF membranes obtained by using an electrochemical approach. FIG. 53C, shows comparison of real mes percentages in resultant membranes with theoretical targets. Error bars represent the standard deviation obtained from three independent measurements (n=3) FIGS. 53D-I, show cross-sectional images of (D) Zr-fum₁₀₀-meso-fcu-MOF supported on Anodisc, (E) Zr-fum₇₉-mes₂₁-fcu-MOF supported on Anodisc, (F) Zr-fum₆₇-mes₃₃-fcu-MOF supported on Anodisc, (G) Zr-fum₆₀-mes₄₀-fcu-MOF supported on Anodisc, (H) Zr-fum₄₁-mes₅₉-fcu-MOF membrane supported on Anodisc, and (I) Zr-fum₆₇-mes₃₃-fcu-MOF membrane supported on stainless-steel nets modified by carbon nanotubes. FIG. 53J, shows 2D ¹³C-¹³C MAS solid-state NMR spectra. Polarization of ¹³C atoms was achieved through direct excitation and a mixing period of 200 ms. Proton-driven spin diffusion using phase-alternated recoupling irradiation schemes was used. The corresponding correlations among atoms from the two ligands are marked. (fum: fumarate; mes: mesaconate)

FIGS. 54A-J show graphical and schematic views of the separation performances of Zr-fum₍₁₀₀₋ₓ₎-mesₓ-fcu-MOF membranes and diffusion energy barriers. FIG. 54A, shows single-gas permeations of Zr-fum₍₁₀₀₋ₓ₎-mesₓ-fcu-MOF membranes as a function of kinetic diameter. FIG. 54B, shows N₂/CH₄ mixed-gas separation performances of Zr-fum₍₁₀₀₋ₓ₎-mesₓ-fcu-MOF membranes. Error bars in panels A-B represent the standard deviation obtained from three independent measurements (n=3). FIG. 54C, shows a schematic illustration of the pseudo-linear profile of ethylene and its permeation through the irregular pore-aperture. FIGS. 54D, F, H, shows schematic illustrations of the diffusion of N₂ and CH₄ through the pore-apertures of the simulated (D) Zr-fum₁₀₀-meso-fcu-MOF, (F) Zr-fum₆₇-mes₃₃-fcu-MOF, and (H) Zr-fum₃₃-mes₆₇-fcu-MOF membranes. FIGS. 54E, G, I, shows minimum energy pathways for the diffusion of N₂ and CH₄ through (E) Zr-fum₁₀₀-meso-fcu-MOF, (G) Zr-fum₆₇-mes₃₃-fcu-MOF, and (I) Zr-fum₃₃-mes₆₇-fcu-MOF membranes. FIG. 54J, shows comparison of the simulated energy barriers for the diffusion barriers of N₂ and CH₄ throughout different MOF frameworks. (fum: fumarate; mes: mesaconate)

FIGS. 55A-L show graphical views of comprehensive evaluations of N₂/CH₄ separation performance of Zr-fum₆₇-mes₃₃-fcu-MOF membranes under practical conditions and techno-economic comparison of distillation system with membrane or hybrid membrane-distillation system. FIG. 55A, shows N₂/CH₄ separation performance comparison between Zr-fum₆₇-mes₃₃-fcu-MOF membranes and other previously reported membranes. The solid and dotted lines are eye guides for polymeric and zeolite membranes, respectively. FIG. 55B, shows high-pressure separation performance of Zr-fum₆₇-mes₃₃-fcu-MOF membranes. The inset box highlights the best-performing zeolite SSZ-13 membranes. FIG. 55C, shows N₂ flux comparison and N₂/CH₄ separation factor comparison between Zr-fum₆₇-mes₃₃-fcu-MOF membranes and other reported membranes. FIG. 55D, shows long-term operational stability of Zr-fum₆₇-mes₃₃-fcu-MOF membranes. After Day 40, the feed pressure was fixed at 10 bar, and the permeate side was kept at atmospheric pressure without sweep gas. FIG. 55E, shows 35% CO₂/15% N₂/50% CH₄ ternary mixed-gas separation performance comparison between Zr-fum₆₇-mes₃₃-fcu-MOF membranes and other reported membranes. FIG. 55F, shows high-pressure separation performance of Zr-fum₆₇-mes₃₃-fcu-MOF membranes when applied to a 35% CO₂/15% N₂/50% CH₄ ternary mixed gas. Error bars in panels A-C and E-F represent the standard deviation obtained from three independent measurements (n=3). FIGS. 55G-I, shows energy and utility consumption for both systems for the following feed compositions: (G) 50% N₂/50% CH₄, (H) 15% N₂/85% CH₄, and (I) 35% CO₂/15% N₂/50% CH₄. FIGS. 55J-L, shows evaluation of purification cost per MMBtu of methane for both systems for the following feed compositions: (J) 50% N₂/50% CH₄, (K) 15% N₂/85% CH₄, and (L) 35% CO₂/15% N₂/50% CH₄. (MMBtu: Metric Million British thermal unit, fum: fumarate; mes: mesaconate)

FIGS. 56A-B show schematic views of a schematic illustration of the design strategy to induce irregularity for CH₄ exclusion. FIG. 56A, shows the synthetic route for the growth of mixed-linker MOF membranes. FIG. 56B, shows a schematic illustration of the irregular aperture shape.

FIGS. 57A-E show graphical views of ¹H NMR spectra of acid-digested Zr-fum-mes-fcu-MOF membranes. FIG. 57A, shows Zr-fum₁₀₀-meso-fcu MOF membrane. FIG. 57B, shows Zr-fum₇₉-mes₂₁-fcu MOF membrane. FIG. 57C, shows Zr-fum₆₇-mes₃₃-fcu MOF membrane. FIG. 57D, shows Zr-fum₆₀-mes₄₀-fcu MOF membrane. FIG. 57E, shows Zr-fum₄₁-mes₅₉-fcu MOF membrane.

FIGS. 58A-F show graphical views of top-view SEM images of Zr-fum-mes-fcu-MOF membranes. FIG. 58A, shows Zr-fum₁₀₀-meso-fcu MOF membrane. FIG. 58B, shows Zr-fum₇₉-mes₂₁-fcu MOF membrane. FIG. 58C, shows Zr-fum₆₇-mes₃₃-fcu MOF membrane. FIG. 58D, shows Zr-fum₆₀-mes₄₀-fcu MOF membrane. FIG. 58E, shows Zr-fum₄₁-mes₅₉-fcu MOF membrane. FIG. 58F, shows Zr-fum₆₇-mes₃₃-fcu MOF membrane that supported on stainless steel nets.

FIG. 59 shows a graphical view of XRD patterns of Zr-fum-mes-fcu-MOF membranes. All the membranes match well with the simulated structure.

FIGS. 60A-E show graphical views of liquid and solid state NMR spectra of the ligands and Zr-fum-mes-fcu-MOF membranes. FIG. 60A, shows ¹H NMR spectra of fumaric acid that dissolved in DMSO-d6. FIG. 60B, shows ¹H NMR spectra of mesaconic acid that dissolved in DMSO-d6. FIG. 60C, shows ¹³C NMR spectra of fumaric acid that dissolved in DMSO-d6. FIG. 60D, shows ¹³C NMR spectra of mesaconic acid that dissolved in DMSO-d6. FIG. 60E, shows two-dimensional (2D)¹H-¹H double-quantum (DQ)/single-quantum (SQ) solid-state NMR spectra of Zr-fum₆₇-mes₃₃-fcu MOF.

FIGS. 61A-F show graphical views of low pressure adsorption of Zr-fum-mes-fcu-MOFs. FIG. 61A, shows Zr-fum₁₀₀-meso-fcu MOF membrane. FIG. 61B, shows Zr-fum₇₉-mes₂₁-fcu MOF membrane. FIG. 61C, shows Zr-fum₆₇-mes₃₃-fcu MOF membrane. FIG. 61D, shows Zr-fum₆₀-mes₄₀-fcu MOF membrane. FIG. 61E, shows Zr-fum₄₁-mes₅₉-fcu MOF membrane. FIG. 61F, shows comparison of the BET surface areas. All the samples are obtained from the corresponding membranes by dissolving the supports.

FIGS. 62A-B show graphical views of single-gas permeation behavior of Zr-fum-mes-fcu-MOF membranes. FIG. 62A, shows ideal selectivities of different Zr-fum-mes-fcu-MOF membranes for different gas pairs. FIG. 62B, shows cut-off mitigation among different Zr-fum-mes-fcu-MOF membranes as a function of mes percentage.

FIGS. 63A-G show chart and schematic views of schematic illustrations of the diffusion pathways and associated energy barriers for both N₂ and CH₄ through Zr-fum-mes-fcu-MOFs. FIG. 63A, shows the top view of the N₂ and CH₄ diffusion pathways through the Zr-fum-mes-fcu-MOFs. FIGS. 63B-D, shows minimum Energy Pathways (MEP) for the diffusion of both CH₄ (black) and N₂ (blue) throughout the Zr-fum₁₀₀-meso-fcu-MOF (B), Zr-fum₆₇-mes₃₃-fcu-MOF (C) and Zr-fum₃₃-mes₆₇-fcu-MOF (D). The transitional states with the minima or maxima energy are marked. FIGS. 63E-G, shows snapshots corresponding to the transitional states for the Zr-fum₁₀₀-meso-fcu-MOF (E), Zr-fum₆₇-mes₃₃-fcu-MOF (F) and Zr-fum₃₃-mes₆₇-fcu-MOF (G) membranes.

FIGS. 64A-B show graphical views of N₂/CH₄ mixed-gas separation behavior of Zr-fum₆₇-mes₃₃-fcu-MOF membranes with varied temperature. FIG. 64A, shows the change of permeances and separation factor with temperature increasing from 25° C. to 150° C. FIG. 64B, shows the arrhenius temperature dependence of N₂ and CH₄ permeances for the Zr-fum₆₇-mes₃₃-fcu-MOF membrane.

The temperature dependence of gas permeation can be stated by Arrhenius equation,

$${P}_{i} = {A}_{i} exp ( - \frac{{E}_{act , i}}{R T} )$$

$$ln {P}_{i} = a - \frac{{E}_{act , i}}{R} \cdot \frac{1}{T}$$

where Pᵢ is the gas permeance of component i, Aᵢ represents for the pre-exponential factor of component i, E_{act,i} is the apparent activation energy of component i, R is the ideal gas constant (8.314 J mol⁻¹ K⁻¹) and T is the absolute temperature (K). A plot of ln (Pᵢ) versus 1/T gives a straight line, whose slope is used to calculate E_{act,i}. The E_{act,N}_{₂} is about 6.773 kJ mol⁻¹, and E_{act,CH}_{₄} is about 4.416 kJ mol⁻¹.

FIGS. 65A-B show graphical views of high pressure adsorption isotherms of the Zr-fum₆₇-mes₃₃-fcu-MOF. FIG. 65A, shows N₂ adsorption and desorption from 0 to 50 bar at 298K. FIG. 65B, shows CH₄ adsorption and desorption from 0 to 50 bar at 298K.

FIG. 66 shows a graphical view of effect of feed pressure on N₂/CH₄ 50/50 mixed-gas separation performance (flux & separation factor vs. pressure) of Zr-fum₆₇-mes₃₃-fcu-MOF membranes. An equimolar N₂/CH₄ mixture at a total flow rate of 2000 mL min⁻¹ was used on the feed side. The permeate side was kept at 1 bar undiluted (i.e., no sweep gas) permeate. The test was conducted at room temperature.

FIGS. 67A-C show graphical views of the stability of Zr-fum₆₇-mes₃₃-fcu-MOF membranes under harsh conditions. FIG. 67A, shows membrane stability under humid feed atmosphere. FIG. 67B, shows membrane stability under H₂S containing atmosphere. FIG. 67C, shows membrane stability under hydrocarbon containing atmosphere. The permeance under water or H₂S decreases because the MOFs show great affinity to water and H₂S, which blocks the pore systems. However, after the feed gas switching back to normal feed, the performance and fully recover, indicating the excellent stability under humid atmosphere.

FIG. 68 shows a graphical view of N₂/CH₄ separation performance of Zr-fum₆₇-mes₃₃-fcu-MOF membranes with different N₂ concentrations as feed gas. A N₂/CH₄ mixture with targeted N₂ concentration at a total flow rate of 2000 mL min⁻¹ was used on the feed side. The feed side was kept at 10 bar and the permeate side was kept at 1 bar undiluted (i.e., no sweep gas) permeate. The test was conducted at room temperature. Both the N₂ permeance and N₂/CH₄ separation factor increase with lower N₂ concentrations in the feed, which is totally different with the conventional zeolite membranes that showed decreased N₂ permeance and N₂/CH₄ separation factor under low N₂ concentrations in the feed.

FIGS. 69A-B show graphical views of the effect of feed pressure on N₂/CH₄15/85 mixed-gas separation performance of Zr-fum₆₇-mes₃₃-fcu-MOF membranes. FIG. 69A, shows permeance & separation factor vs. pressure. FIG. 69B, shows flux & separation factor vs. pressure. A 15/85 N₂/CH₄ mixture at a total flow rate of 2000 mL min⁻¹ was used on the feed side. The permeate side was kept at 1 bar undiluted (i.e., no sweep gas) permeate. The test was conducted at room temperature.

FIG. 70 shows a graphical view of the effect of feed pressure on CO₂/N₂/CH₄ 35/15/50 ternary mixed-gas separation performance of Zr-fum₆₇-mes₃₃-fcu-MOF membranes (flux & separation factor vs. pressure). A 35/15/50 CO₂/N₂/CH₄ ternary mixture at a total flow rate of 2000 mL min⁻¹ was used on the feed side. The permeate side was kept at 1 bar undiluted (i.e., no sweep gas) permeate. The test was conducted at room temperature.

FIGS. 71A-D show graphical views of a comparison of the separation performance of Zr-fum-mes-fcu-MOF membranes with other reported membranes for different gas pairs. FIG. 71A, shows H₂/N₂. FIG. 71B, shows H₂/CH₄. FIG. 71C, shows CO₂/N₂. FIG. 71D, CO₂/CH₄.

FIGS. 72A-B show graphical views of the effect of feed pressure on N₂/CH₄ 50/50 mixed-gas separation performance of Zr-fum₆₇-mes₃₃-fcu-MOF membranes supported on stainless steel nets. FIG. 72A, Permeance & separation factor vs. pressure. FIG. 72B, Flux & separation factor vs. pressure. An equimolar N₂/CH₄ mixture at a total flow rate of 2000 mL min⁻¹ was used on the feed side. The permeate side was kept at 1 bar undiluted (i.e., no sweep gas) permeate. The test was conducted at room temperature.

FIGS. 73A-B show graphical views of the effect of feed pressure on N₂/CH₄ 15/85 mixed-gas separation performance of Zr-fum₆₇-mes₃₃-fcu-MOF membranes supported on stainless steel nets. FIG. 73A, shows permeance & separation factor vs. pressure. FIG. 73B, shows flux & separation factor vs. pressure. A 15/85 N₂/CH₄ mixture at a total flow rate of 2000 mL min⁻¹ was used on the feed side. The permeate side was kept at 1 bar undiluted (i.e., no sweep gas) permeate. The test was conducted at room temperature.

FIG. 74 shows a graphical view of the comparison of CO₂/N₂/CH₄ 35/15/50 ternary mixed-gas separation performance of Zr-fum₆₇-mes₃₃-fcu-MOF membranes supported on stainless steel nets with reported literature. A 35/15/50 CO₂/N₂/CH₄ mixture at a total flow rate of 2000 mL min⁻¹ was used on the feed side. The feed side was kept at 10 bar and the permeate side was kept at 1 bar undiluted (i.e., no sweep gas) permeate. The test was conducted at room temperature.

FIGS. 75A-B show graphical views of the effect of feed pressure on CO₂/N₂/CH₄ 35/15/50 ternary mixed-gas separation performance of Zr-fum₆₇-mes₃₃-fcu-MOF membranes supported on stainless steel nets. FIG. 75A, shows permeance & separation factor vs. pressure. FIG. 75B, shows flux & separation factor vs. pressure. A 35/15/50 CO₂/N₂/CH₄ ternary mixture at a total flow rate of 2000 mL min⁻¹ was used on the feed side. The permeate side was kept at 1 bar undiluted (i.e., no sweep gas) permeate. The test was conducted at room temperature.

FIG. 76 shows a schematic view of the process flow diagram of the single distillation column system for N₂ rejection.

FIG. 77 shows a schematic view of the process flow diagram of the membrane-distillation hybrid system for N₂ rejection from the 50% N₂/50% CH₄ feed.

FIG. 78 shows a graphical view of the distribution of utility costs of the membrane-distillation hybrid system for N₂ rejection from the 50% N₂/50% CH₄ feed.

FIG. 79 shows a schematic view of the process flow diagram of the membrane system for N₂ rejection from the 15% N₂/85% CH₄ feed.

FIG. 80 shows a schematic view of the process flow diagram of the MDEA capture process for CO₂ removal from the 35% CO₂/15% N₂/50% CH₄ feed.

FIG. 81 shows a schematic view of a representation of the Rubotherm gravimetric-densimetric apparatus,

FIG. 82 shows an image view of a SEM image and digital photo of defective Zr-fum-fcu-MOF fillers based MMM.

FIG. 83 shows a graphical view of the CO₂/CH₄ separation performance of MMMs using different types of fillers.

FIG. 84 shows a graphical view of the comparison of CO₂/CH₄ separation at 50 bar by the defective filler based membranes with other membranes.

### DETAILED DESCRIPTION

Hydrocarbons are versatile petrochemicals with wide variety of uses and act as an integral part to the human community. Short-chain olefins such as propylene are essential raw materials for plastic manufacturing and paraffins such as butane and propane comprise the major components of LPG (liquid petroleum gas). In industry, the separation of hydrocarbons, for instance the propylene/propane (C₃H₆/C₃H₈) mixture and butane isomers (n-C₄H₁₀/iso-C₄H₁₀), is crucial but exceedingly energy-intensive, where a total of 232 and 74 trays in the distillation columns are required, respectively. Membrane-based separation is demonstrated to be more energy efficient as a potential alternative. Albeit the challenge continues for the entire replacement of distillation by the currently available membranes, a “membrane-distillation” hybrid approach still holds great promise to reduce the energy intensity. It is estimated that a C₃H₆-selective membrane with the C₃H₆ permeance of ˜100 GPU (gas permeation unit, 1 GPU=3.35×10⁻¹⁰ mol·m⁻²·s⁻¹·pa⁻¹) and the C₃H₆/C₃H₈ selectivity of ˜50 working in the hybrid system enables ˜25% savings in energy requirement for C₃H₆/C₃H₈ separation, which corresponds to ˜100 million USD per year. Such savings can be further improved with better membranes, however, the available effective materials are rather limited.

Metal-organic frameworks (MOFs) with precisely controlled pore systems are emerging as powerful membrane materials. A close inspection over all the ˜350 publications about polycrystalline MOF membranes during the last decade reveals that ˜67.8% of the researches are using zeolitic imidazolate frameworks (ZIF), of which ZIF-8 accounts for ˜72.1%. The diversity of MOFs for polycrystalline membranes is impoverished despite the rich variety of MOF crystals. The situation becomes even worse for hydrocarbons separation, where only ZIF-8 as well as its cobalt analog ZIF-67 membranes show decent C₃H₆/C₃H₈ separation selectivity. Hydrocarbon feedstock in industry often contains trace amount of highly corrosive H₂S, and the utilization of ZIF-8 or ZIF-67 membranes may be problematic due to their structural instability in such an aggressive atmosphere. Moreover, a higher pressure ratio (ratio of feed to permeate pressures) during operation is preferred to increase the gas flux and separation efficiency with smaller membrane area, yet ZIF-8/-67 membranes suffer from severe selectivity degradation at elevated feed pressure attributing to the “gate-opening” effect. Accordingly, more membranes derived from robust and rigid MOFs are needed to address these challenges as well as enrich the polycrystalline membrane repertoire.

Appropriately, H₂S-stable MOFs do exist, such as the family of face-centered cubic (fcu)-MOFs that assembled from hexanuclear metal clusters (rare-earth (RE, III) ions or Zr (IV) ion) and ditopic linkers, encompassing triangular windows. Despite their success as molecular sieving fillers in mixed-matrix membranes, polycrystalline membranes based on such robust fcu-MOFs remain very rare till now, and UiO-66 (Zr-tpa-fcu-MOF, tpa: terephthalate) represents the only reported type. Broadening the scope of fcu-MOF membranes is necessary to debottleneck the hydrocarbons separation since the relatively open window (˜6 Å) of Zr-tpa-fcu-MOF cannot discriminate light hydrocarbons with diameter usually smaller than 5 Å. Furthermore, non-autoclave membrane synthesis is preferable so that lower costs will be required when scaling up the membrane area.

Nevertheless, over 70% of the past work has been done by preparing membranes by the solvothermal method and it is so far the only available fashion for robust fcu-MOF membranes. Methodologies for membrane fabrication under milder conditions are poorly developed given that the majority of non-solvothermal synthesis are only practicable for ZIF membranes.

In this disclosure, an electrical methodology to fabricate various continuous, defect free fcu-MOF membranes is discussed. Additional embodiments discuss unique intrinsic properties of fcu-MOFs i.e. addressing highly challenging separation such as C₃H₆/C₃H₈ and C₄/i-C₄.

This disclosure describes the development of pure fcu-MOF membrane on various substrates ranging from flat to hollow fibers for the separation of C₃H₆/C₃H₈ and butane isomers (nC₄/iC₄) mixtures. The triangular window of fcu-MOFs is the sole entrance to the pore system for guest molecules and determines the ultimate molecular sieving capability, which can be precisely tuned by rationally altering metal clusters as well as organic linkers embedding reasonable length and bulkiness. Principally, ligand length change or functionalization permits ultra-tuning of the window size in angstrom or sub-angstrom scale, respectively, while metal cluster replacement affords unparalleled control of the pore aperture at the level of 0.1-0.2 Å. For example, the window can be about 1 to about 6 Å, about 0.5 to about 5 Å, about 1.5 to about 4 Å, or about less than 5 Å. To process the family of fcu-MOFs into polycrystalline membranes for multipurpose separations, a general guideline for membrane synthesis is needed instead of through trial-and-error procedure for each membrane, considering the enormous bank of ligands and metal ions as well as their diverse combinations.

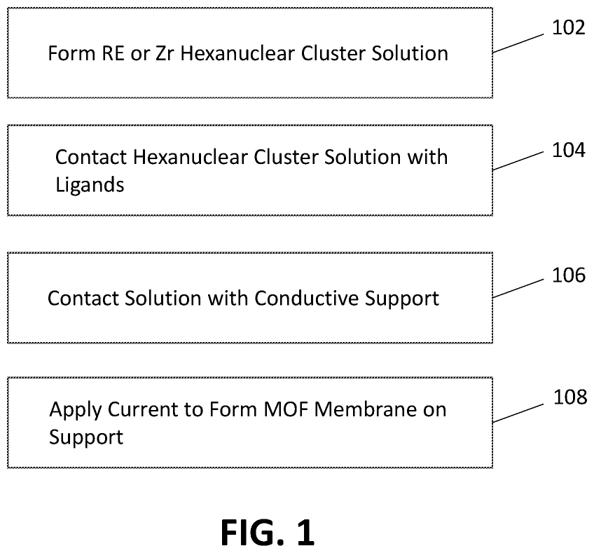

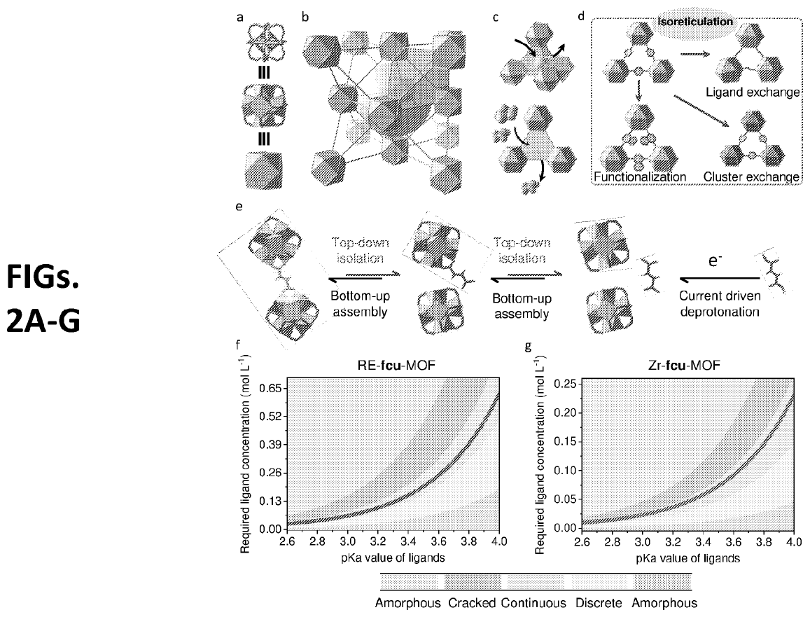

Referring to FIG. 1, electrical synthesis of continuous metal-organic framework membranes is shown, according to one or more embodiments. A rare earth- or zirconium-containing compound, an acid, a solvent, and optionally water are contacted 102, sufficient to form a hexanuclear cluster solution. The hexanuclear cluster solution is contacted 104 with one or more ditopic ligands, sufficient to form a metal-organic framework (MOF) solution. The MOF solution is contacted 106 with a support, and a current is applied 108 to the MOF solution with support, sufficient to provide a continuous metal-organic framework membrane.

The rare earth in the rare-earth containing compound can be one or more of La, Ce, Pr, Nd, Sm, Eu, Gd, Dy, Ho, Er, Tm, Yb, Lu, Tb or Y, for example, terbium (Tb3+) or yttrium (Y3+), for example. The acid can be one or more of 2-flouro benzoic acid, formic acid, acetic acid, and propionic acid, for example. The one or more ditopic ligands are carboxylate or tetrazolate functional groups. Fumaric acid, Mesaconic acid, terephthalic acid, 1,4-naphthalenedicarboxylic acid, 2-aminoterephthalic acid and their mixtures, in some embodiments. The fcu metal-organic framework membrane layer can be one or more of Y-fum-fcu-MOF, Zr-fum-fcu-MOF, Y-mes-fcu-MOF, Zr-mes-fcu-MOF, Y-tpa-fcu-MOF, Zr-tpa-fcu-MOF, Y-naph-fcu-MOF, Zr-naph-fcu-MOF, and Y-aminotpa-fcu-MOF and their mixed ligands, such as Y-fum-mes-fcu-MOF in one example.

The support can be any porous and/or conductive support. Examples includes alumina and stainless steel. The support can include one or more conductive layers, such as Pt, Pd, and Au, for example. The membrane formed may be about 150 nm or less in thickness, about 20 nm to about 150 nm, about 30 nm to about 75 nm, about 30 nm to about 120 nm, less than about 100 nm, less than about 75 nm, or less than about 50 nm, for example.

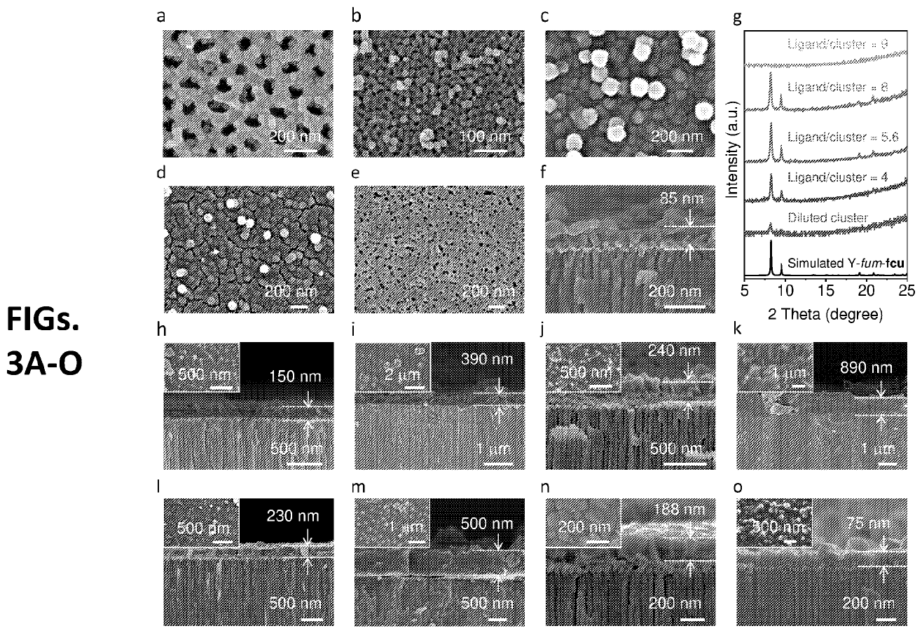

Current-driven synthesis offers a facile electrochemical engineering approach to MOF membrane assembly within a short period at ambient conditions by virtue of the electron-promoted ligand deprotonation. To explore the possibility of the current-driven fabrication of fcu-MOF membranes, the structure of fcu-MOFs is analyzed and isolated at each molecular building block (MBB) by a top-down approach, and reasoned the current-driven reassembly process on the confined surface of the porous support via a bottom-up manner to afford a continuous membrane layer (FIG. 2C). It reveals that in the initial stage, that is t=0, the preformed hexanuclear cluster MBB (RE₆ or Zr₆) is terminated by the modulators, namely 2-fluorobenzoic acid (FBA) or formic acid (FA). Other acidic modulators can be considered. With the addition of organic ligands (HL) into the cluster solution, acid dissociation happens to release protons (H) and deprotonated ligands (L⁻) and reaches equilibrium eventually, which is governed by the dissociation constant (Ka, pKa=−lgKa). H⁺ is reduced by electrons from the porous support promptly while L⁻ reacts with the cluster to replace the modulator moiety, thus further linking the other cluster in the identical fashion to afford interconnected fcu nets (FIG. 2C).

Two correlations are derived to predict the electrical synthesis conditions of the targeted fcu-MOF membranes according to the associated ligand pKa values. For RE-fcu-MOF membranes, the required ligand concentration is calculated by [H₂Lₓ]_{RE-fcu-MOF}=6.262×10^{(pKa-5)} when fixing the hexanuclear cluster concentration at 15 mM and current density at 1.5 mA·cm⁻². For Zr-fcu-MOF membranes, the required ligand concentration is calculated by [H₂Lₓ]_{zr-fcu-MOF}=2.319×10^{(pKa-5)} when fixing the cluster solution at 7.3 mM and current density at 0.26 mA cm⁻². A minor deviation of [−20%, ˜25%] for the calculated concentration is acceptable to maintain the layer continuity whereas significant divergence beyond [−20%, 25%] results in amorphous impurity, cracked layers, or isolated tiny crystals (FIGS. 2D-E).

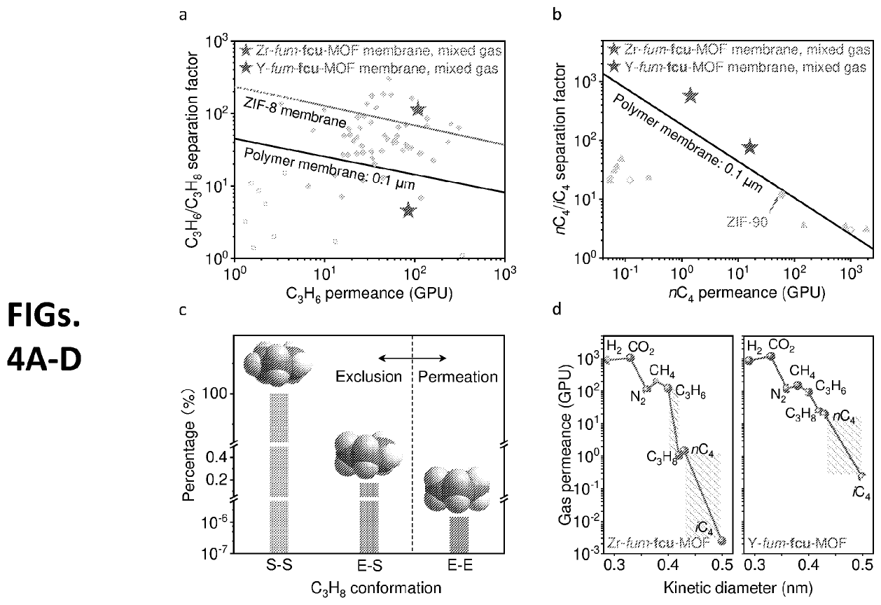

The fcu-MOF is fabricated as a thin film on alumina or stainless-steel net support using the formulas discussed above. Other conductive support materials are contemplated as well. First step is to prepare the hexanuclear cluster solution. In a typical procedure, for [RE₆(μ₃-OH)₈(O₂C—)₁₂] cluster solution, Y(NO₃)₃·6H₂O (572 mg, 1.5 mmol), 2-fluorobenzoic acid (3.33 g, 23.8 mmol), dimethylformamide (DMF, 13.7 mL) and ultrapure water (H₂O, resistivity=18.2 MΩ·cm, 2.3 mL) were combined in a 38 mL scintillation vial, sealed and heated to 115° C. for 60 h and cooled to room temperature. For the [Zr₆O₄(OH)₄(O₂C—)₁₂] cluster solution, ZrOCl₂·8H₂O (230 mg, 0.7 mmol), formic acid (2.7 mL, 71 mmol), DMF (11.3 mL) and H₂O (1.9 mL) were combined in a 38 mL scintillation vial, sealed and left at room temperature for 3 weeks, or heated to 65° C. for 10 h and cooled to room temperature. In the second step, each kind of ligand with pre-calculated mass was added into the Y₆ cluster solution and sonicated for 1 minute to get homogeneous solution. The porous support with conductive coatings (diameter=22 mm) was immersed into the solution and connected with the working electrode of the potentiostat (as cathode). The support can be substantially submerged, partially submerged or immersed, or in electrical contact, for example. The amount of ligands for each Y-fcu-MOF membrane is as follows: Y-naph-fcu-MOF membrane, 1,4-naphthalenedicarboxylic acid (111.1 mg, 0.5138 mmol, 0.032 M, ligand/cluster=2.1:1); Y-fum-fcu-MOF membrane, fumaric acid (164.2 mg, 1.415 mmol, 0.08 M, ligand/cluster=5.6:1); Y-tpa-fcu-MOF membrane, terephthalic acid (513.0 mg, 3.096 mmol, 0.019 M, ligand/cluster=12.9:1); Y-mes-fcu-MOF membrane, mesaconic acid (640.0 mg, 4.910 mmol, 0.31 M, ligand/cluster=20.4:1, 35° C.); Y-aminotpa-fcu-MOF membrane, 2-aminoterephthalic acid (1625 mg. 8.929 mmol, 0.55 M, ligand/cluster=36.6:1). A current density of 1.5 mA/cm² was applied for 2 h at room temperature, after which the as-synthesized membranes were taken out and rinsed slowly with fresh DMF and DMF/methanol solvent for 2 minutes, respectively. The amount of ligands for each Zr-fcu-MOF membrane is as follows: Zr-naph-fcu-MOF membrane, 1,4-naphthalenedicarboxylic acid (41.15 mg, 0.1903 mmol, 0.012 M, ligand/cluster=1.6:1); Zr-fum-fcu-MOF membrane, fumaric acid (60.80 mg, 0.5242 mmol, 0.033 M, ligand/cluster=4.9:1); Zr-tpa-fcu-MOF membrane, terephthalic acid (190.4 mg, 1.146 mmol, 0.072 M, ligand/cluster=9.9:1); Zr-mes-fcu-MOF membrane, mesaconic acid (236.2 mg, 1.817 mmol, 0.11 M, ligand/cluster=15.6:1). A current density of 0.26 mA/cm² was applied for 2 h at room temperature, after which the as-synthesized membranes were taken out and rinsed slowly with fresh DMF and DMF/methanol solvent for 2 minutes, respectively. The SEM images of typical fcu-MOF membrane are depicted (FIG. 3), which shows the continuity of the fcu-MOF membrane closed thin film.

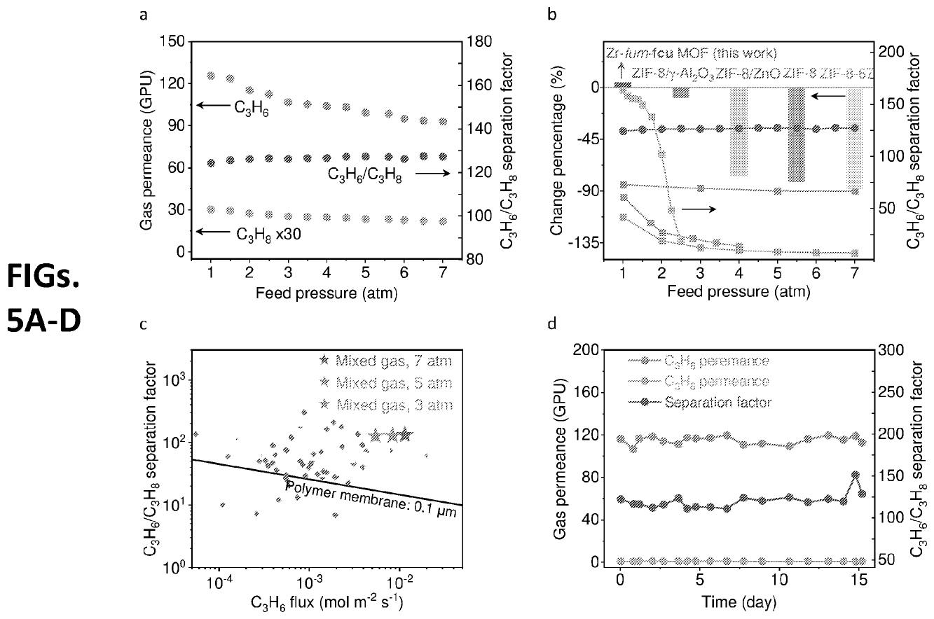

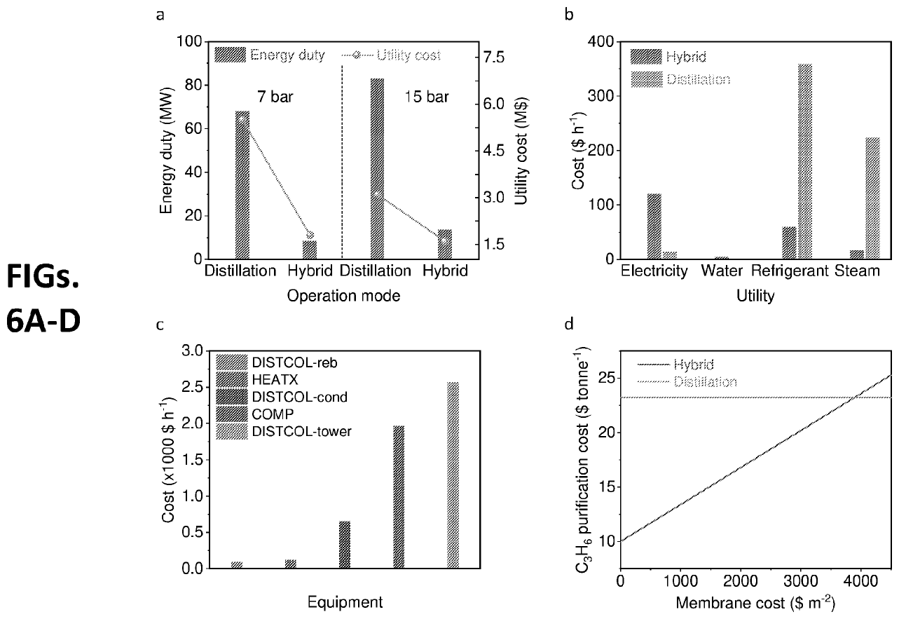

The separation performance of the prepared fcu-MOF membranes was screened by single-gas permeations, which is summarized in FIG. 4. The good selectivities indicate the high quality of the obtained membranes. The fcu-MOF was scaled-up and fabricated as a thin film on polymer and ceramic hollow fiber supports using this newly developed guidance (FIG. 6).

The measured C₃H₆/C₃H₈ and nC₄/iC₄ selectivity for the respective pure fcu-MOF membrane is over 110 and 75 respectively, which is considered as one of the most selective membranes for C₃H₆/C₃H₈ and butane isomers separation. Therefore. the obtained C₃H₆/C₃H₈ and nC₄/iC₄ selectivity in the fabricated fcu-MOF membrane is much higher than the reported polymeric membranes and other MMMs. These MOF membranes featuring easy-fabrication meanwhile high-performance, provide great potential in practical application of C₃H₆/C₃H₈ and butane isomers separation.

The membrane can be grown on various commercialized supports, including alumina, and stainless-steel nets. Additionally this method can be used to scale up the membrane fabrication by applying it on hollow fibers of different materials like polymers, ceramic and metallic. This permits advanced design of membrane modules to maximize the membranes efficiency.

### Directed Fabrication of Isoreticular Fcu-MOF Membranes

The approach for the directed assembly of continuous MOF membranes is based on linking preassembled building blocks in a periodic and controlled manner on a support surface. To this end, two perquisites are met by the elected fcu-MOF platform. The fcu-MOF platform is amenable to isoreticulation (FIGS. 2A-D), and the associated discrete hexanuclear clusters can be prepared, isolated and used for MOF synthesis. We opted to use electrochemistry to control the ligand deprotonation rate and subsequently the concentration of the fully deprotonated ligands in the mixture solution, affording the needed balance between nucleation and crystal growth for the continuous film formation. At t=0, with the addition of ditopic linkers (referred as “H₂L” for simplification) into the cluster solution, the protonated and deprotonated forms are in equilibrium [equation (1)]. The equilibrium can be displaced to the right by reducing the protons (H⁺) to H₂ in a controlled and continuous fashion [equation (2)] and consequently regulate the available deprotonated ligand (L²⁻) amount in the mixture solution. Subsequently, at a given L²⁻ concentration, L²⁻ will displace the capping terminal ligand of the discrete hexanuclear cluster [equation (3) and (4)], promoting the bridging of clusters in the desired fashion/connectivity to afford the formation of fcu-MOF crystallites on the support surface (FIG. 2E). Despite the continuous consumption of protons at the membrane (cathode) side [equation (2)], new protons are generated simultaneously at the anode side through the other half-reaction, oxygen evolution reaction, resulting in the whole system to maintain neutrality.

$${H}_{2} L ⇌ 2 {H}^{+} + {L}^{2 -} \qquad ( 1 )$$

$$2 {H}^{+} + 2 {e}^{-} \to {H}_{2} \qquad ( 2 )$$

$$6 {L}^{2 -} + [ \text{} {{RE}_{6} ( {μ}_{3} - OH )}_{8} {( {O}_{2} C - )}_{12} ] \to [ \text{} {{RE}_{6} ( {μ}_{3} - OH )}_{8} {( L )}_{6} ] + 12 {( {O}_{2} C - )}^{-} \qquad ( 3 )$$

$$6 {L}^{2 -} + [ {Zr}_{6} {{O}_{4} ( OH )}_{4} {( {O}_{2} C - )}_{12} ] \to [ {Zr}_{6} {{O}_{4} ( OH )}_{4} {( L )}_{6} ] + 12 {( {O}_{2} C - )}^{-} \qquad ( 4 )$$

The short linker fum can be utilized as a model system for experimental exploration, and optimal conditions were determined for the current-driven assembly for both Y-fum-fcu-MOF and Zr-fum-fcu-MOF membranes, including current density, cluster and ligand concentrations. The initial attempts using a diluted [Y₆(μ₃-OH)₈(O₂C—)₁₂] solution (5 mM) failed to afford continuous MOF layers despite varying the ligand concentration and current density, as observed from the top-view scanning electron microscope (SEM) image (FIG. 3A). Nevertheless, the X-ray diffraction (XRD) pattern of the deposited nanoparticles affirms the formation of Y-fum-fcu-MOF (FIG. 3G). Presumably, the low concentration of the system is the key factor that limits the ligand exchange kinetics, and prohibits the formation of a continuous film deposit.

The cluster concentration was increased to 15 mM and further tuned the corresponding ligand concentration with the current density fixed at 1.5 mA·cm⁻². The membrane formation is closely dependent on the amount of bridging ligands. When the ligand/cluster concentration ratio is low, such as 4:1, the crystalline Y-fum-fcu-MOF (FIG. 3G) is obtained, but in the form of non-continuous layers (FIG. 3B), plausibly due to the inadequate concentration of deprotonated fumarate linker ([fum²⁻]) and the resulting slow kinetics for MOF formation (see FIGS. 7A-D). Further increase of the ratio to 8:1 and 9:1 afforded a cracked layer or amorphous products, as revealed from the SEM images and XRD patterns (FIGS. 3D-E, 3G), possibly due to the excessively rapid exchange rate and thus incompatible nucleation, crystal growth and intergrowth (FIG. 7C). Appropriately, increasing the ratio to 5.6:1 affords the desired ratio that balances MOF formation rate and intergrowth to form defect-free MOF layers (FIG. 7B), with no visible defects/pinholes on the surface (FIG. 3C). For this system, the range could be expanded to about 4.8:1 to about 6.2:1, for example. The cross-section image revealed the excellent continuity of the resultant ultrathin layer of only 85 nm (around 45 unit cells), anchoring firmly to the support surface without infiltration or delamination (FIG. 3F). The phase purity was confirmed by XRD pattern, matching well with the simulated structure. For the specific [Y₆(μ₃-OH)₈(O₂C—)₁₂] system and the deployed fum linker, an intermediate ligand/cluster ratio of 5.6:1 represents the desired reaction mixture permitting to reach the ideal concentration of fum²⁻ ([fum²⁻]_{ideal}=[L²⁻]_{ideal}) during the dynamic accumulation and consumption.

Similar experimental exploration for the Zr-fum-fcu-MOF membranes resulted in the attainment of defect-free MOF layers of 150 nm in thickness (around 80 unit cells), with the optimal [Zr₆O₄(OH)₄(O₂C—)₁₂] cluster concentration of 7.3 mM and ligand/cluster ratio of 4.9:1 when the current density was fixed at 0.26 mA·cm⁻² (FIG. 3H). The attainment of defect-free Zr-fcu-MOF membranes requires nearly half the concentration of the hexanuclear cluster compared with the Y-fcu-MOF membranes. For this system, a successful range could be expanded from about 4.0:1 to about 5.8:1, for example.

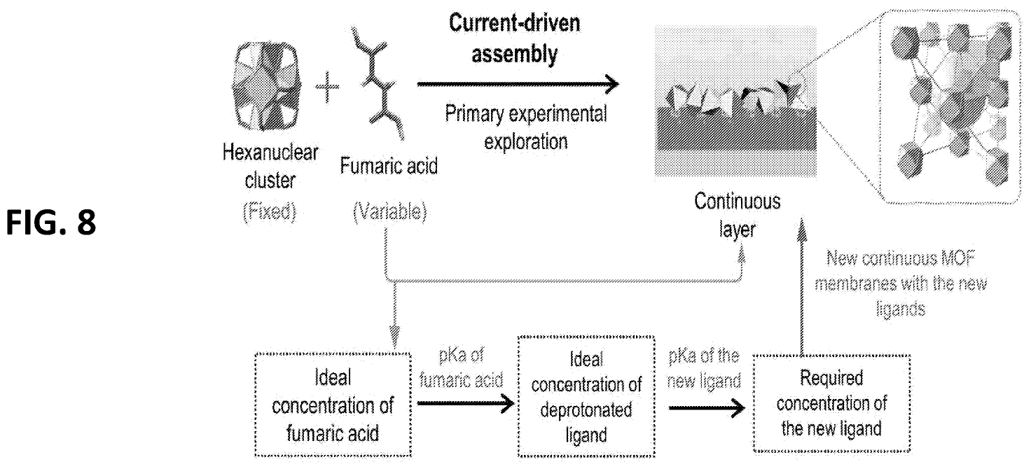

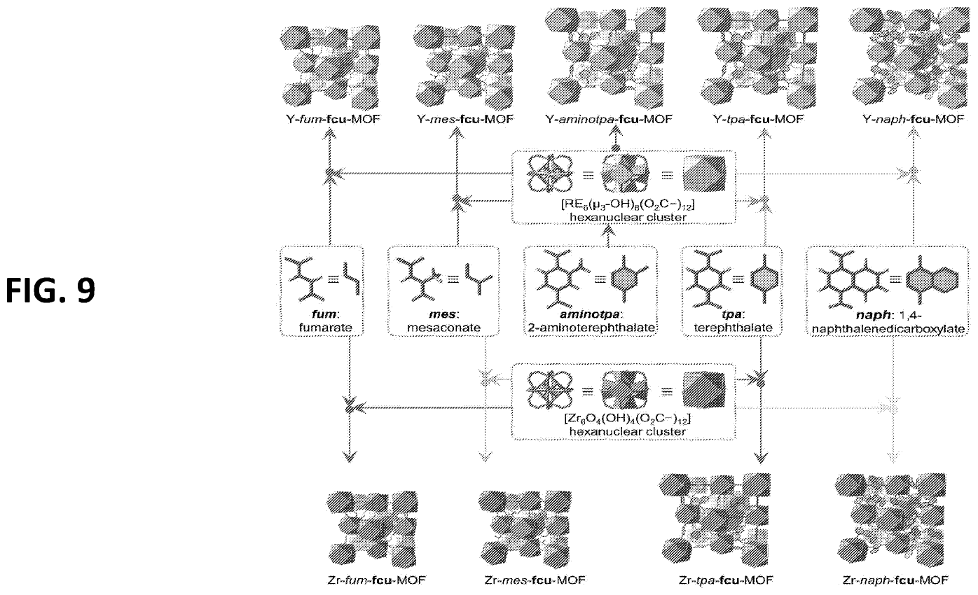

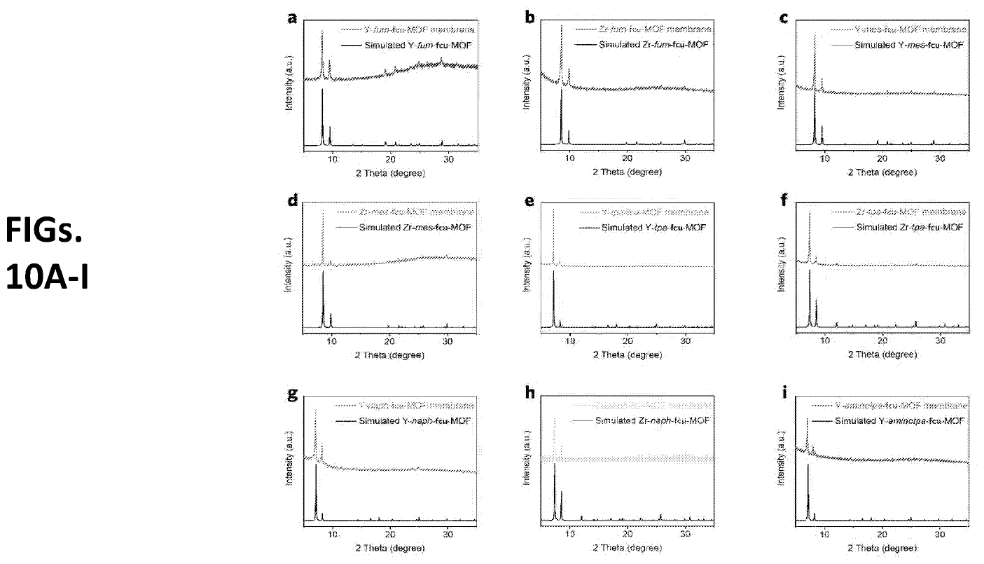

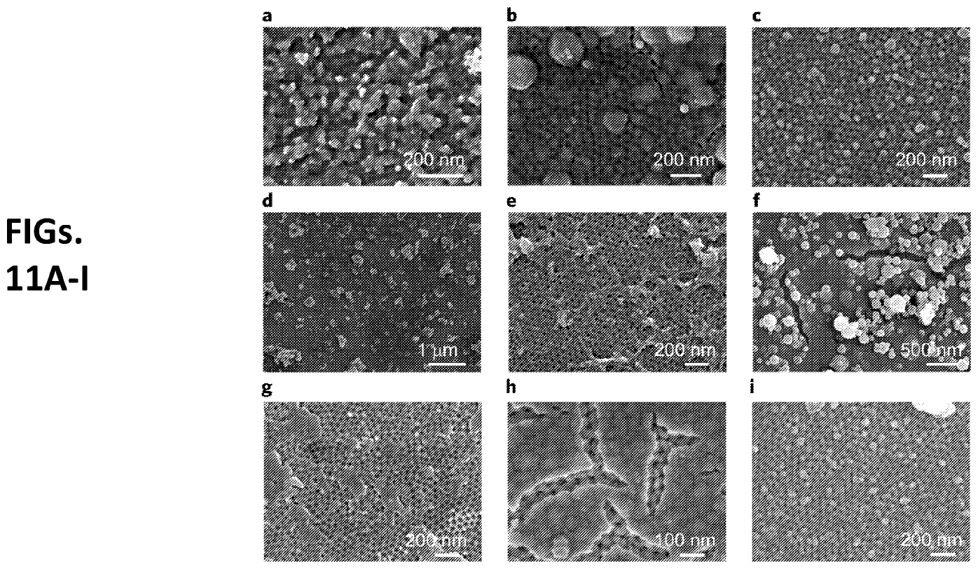

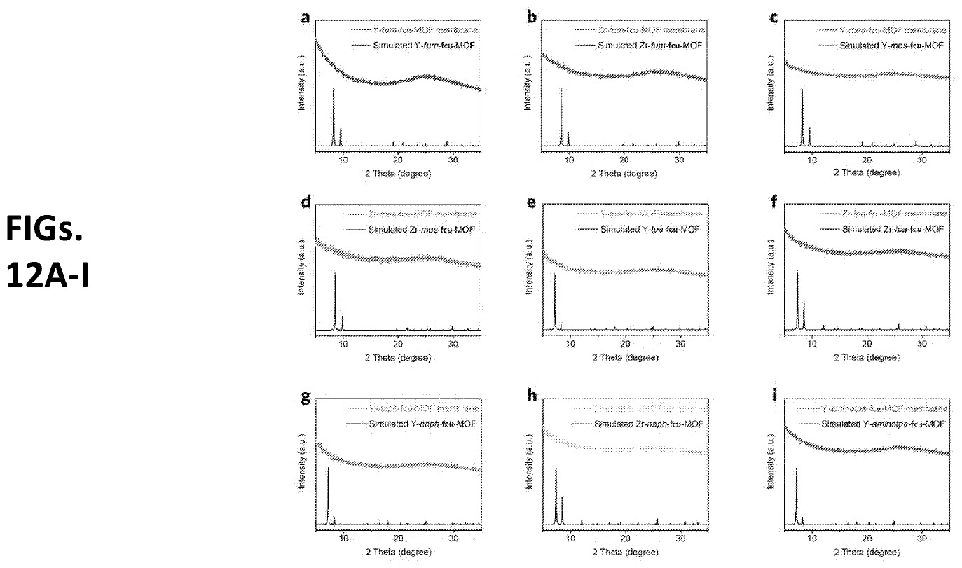

The successful preparation of the two fum-fcu-MOF membranes demonstrated the effectiveness of the electrochemistry approach to regulate the membrane assembly, suggesting its potential practicability for the directed preparation of other defect-free fcu-MOF membranes with different ditopic linkers (H₂Lₓ). Establishing the ideal concentration of the deprotonated ligand ([L²⁻]_{ideal}) depends cooperatively on the initial concentration of deployed ditopic linkers, the equilibrium and the current-driven deprotonation. Accordingly, if the predetermined optimal parameters are maintained, such as the optimized hexanuclear cluster concentration and current density, the primary bridging linker concentration can be tuned based on its pKa value. Two mathematical correlations were derived to correlate the required ligand concentration ([H₂Lₓ]) with its associated pKa value, depending on the deployed cluster system, namely [H₂Lₓ]_{RE-fcu-MOF}=6.262×10^{(pKa-5)} and [H₂Lₓ]_{Zr-fcu-MOF}=2.319×10^{(pKa-5)} (FIGS. 2F-G, FIG. 8). Credibly, these correlations were used as a guide for the fabrication of seven additional fcu-MOF membranes with different ligand length, functionality, and pKa value. The ligand/cluster ratio for the formation of Y-mes-fcu-MOF, Y-tpa-fcu-MOF, Y-naph-fcu-MOF, Y-aminotpa-fcu-MOF is 20.4, 12.9, 2.1, 36.6, respectively, when fixing the hexanuclear cluster concentration at 15 mM and current density at 1.5 mA cm-z. The ligand/cluster ratio for Zr-mes-fcu-MOF, Zr-tpa-fcu-MOF, Zr-naph-fcu-MOF is 15.6, 9.9, 1.6, respectively, when fixing [Zr₆O₄(OH)₄(O₂C—)₁₂] at 7.3 mM and current density at 0.26 mA·cm⁻² (FIG. 9). The preparation of Zr-aminotpa-fcu-MOF membrane was unsuccessful since the solution transformed to gels immediately upon the dissolution of the aminotpa linker.

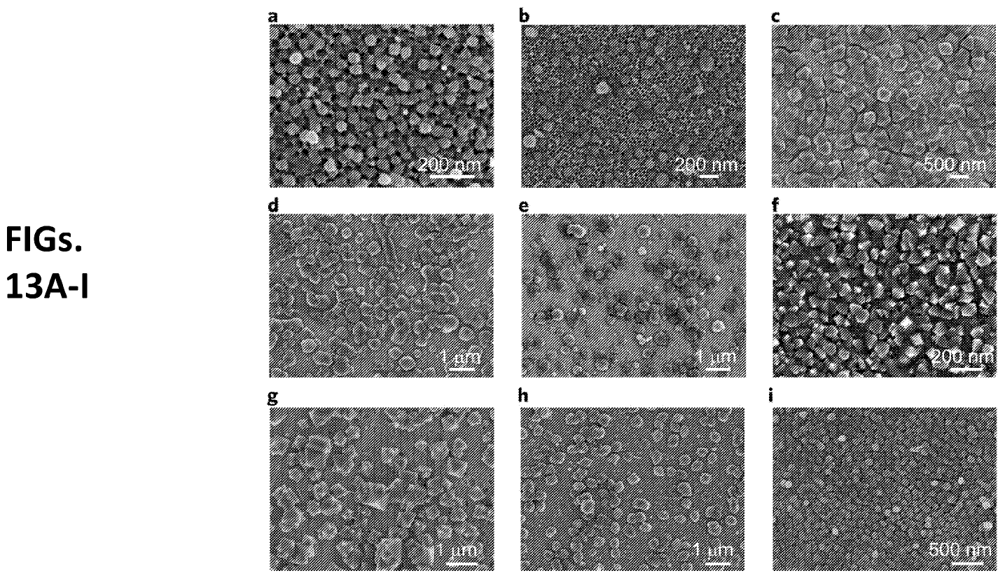

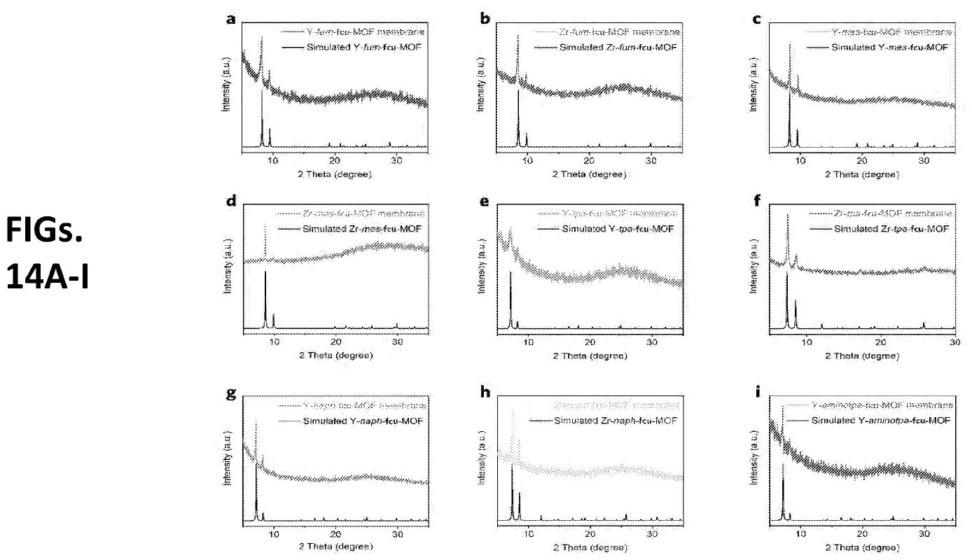

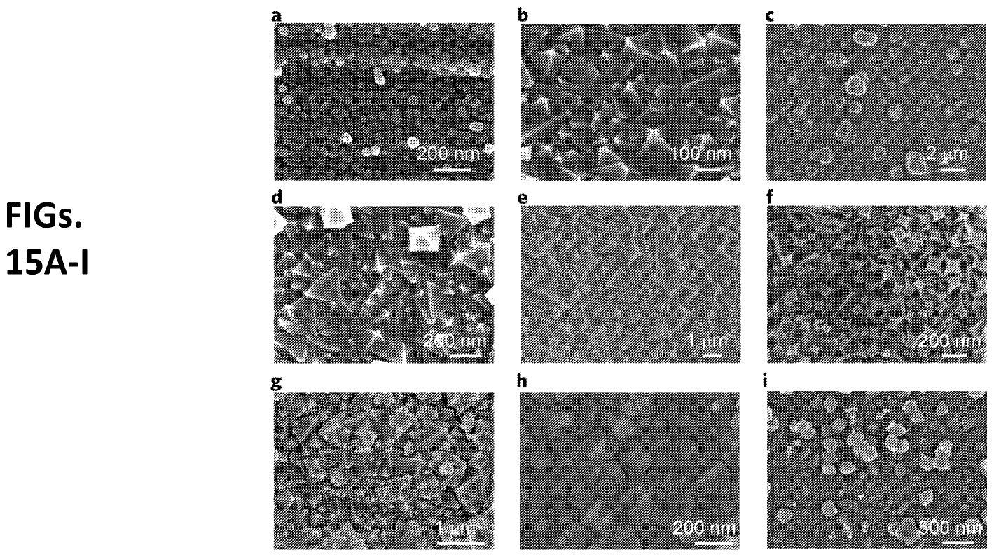

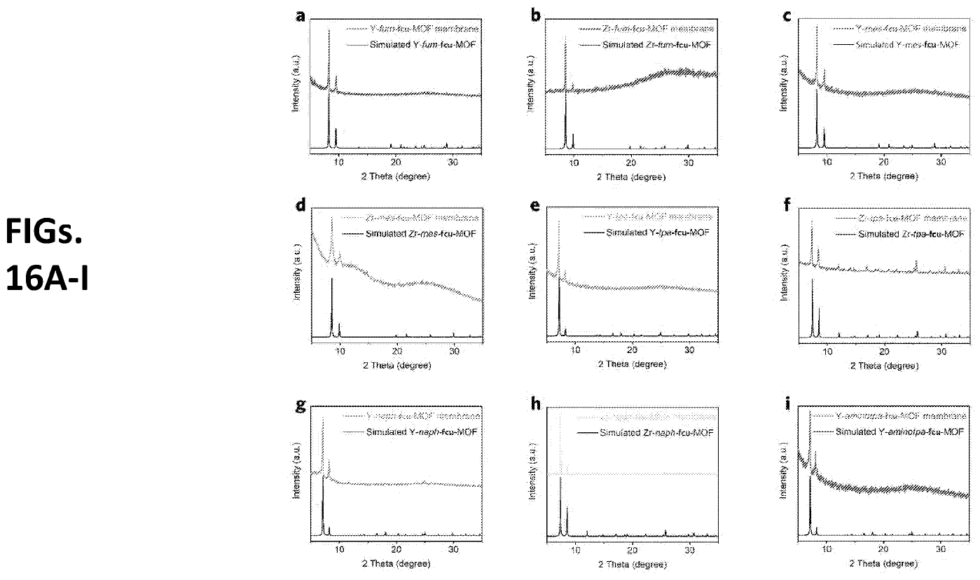

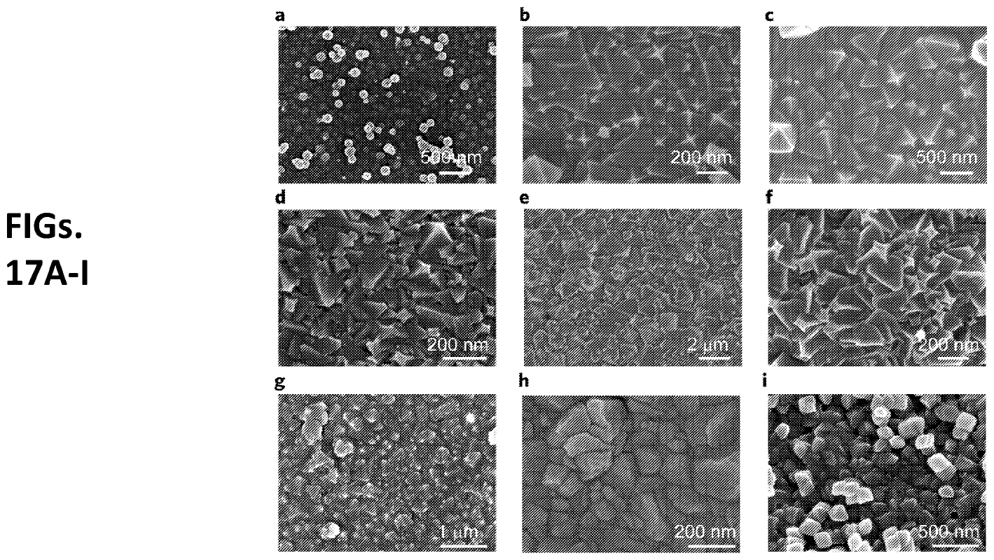

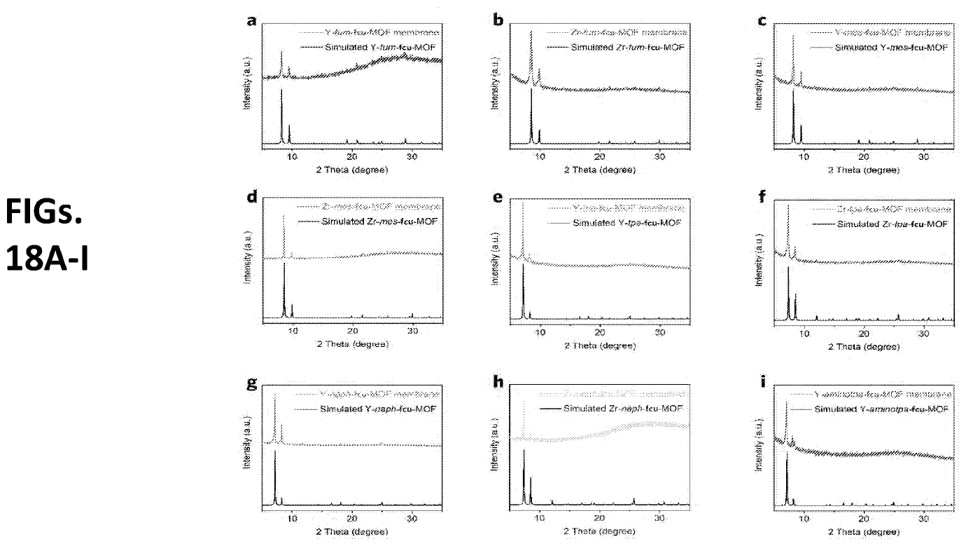

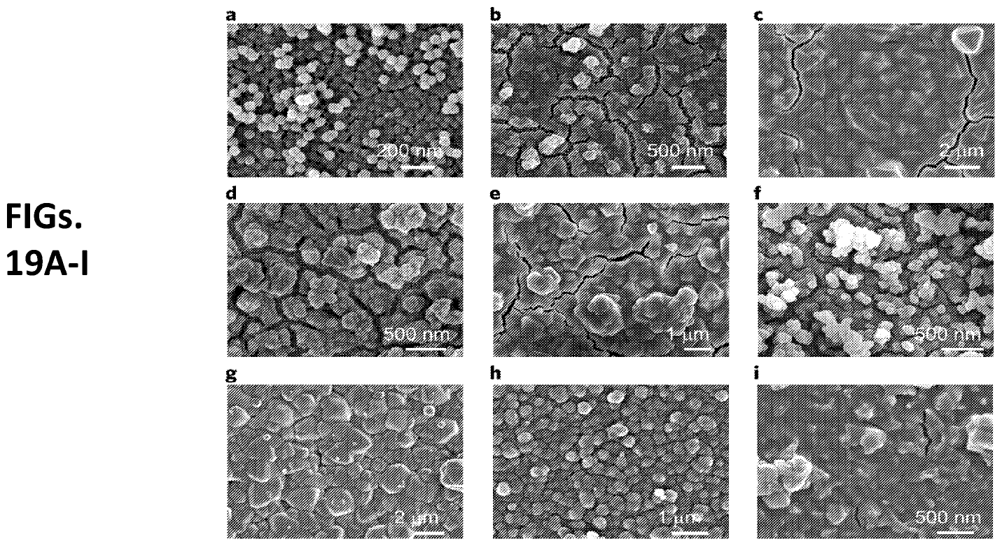

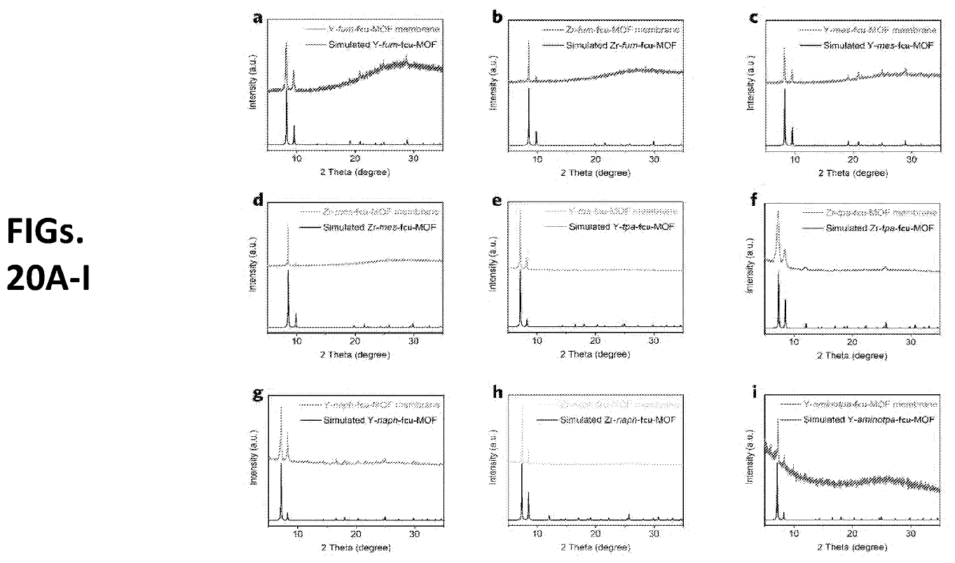

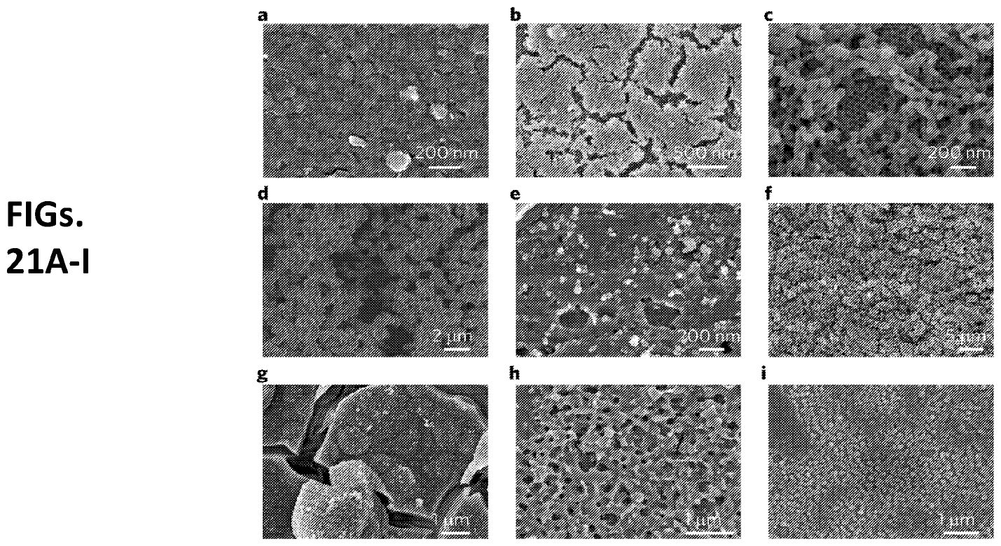

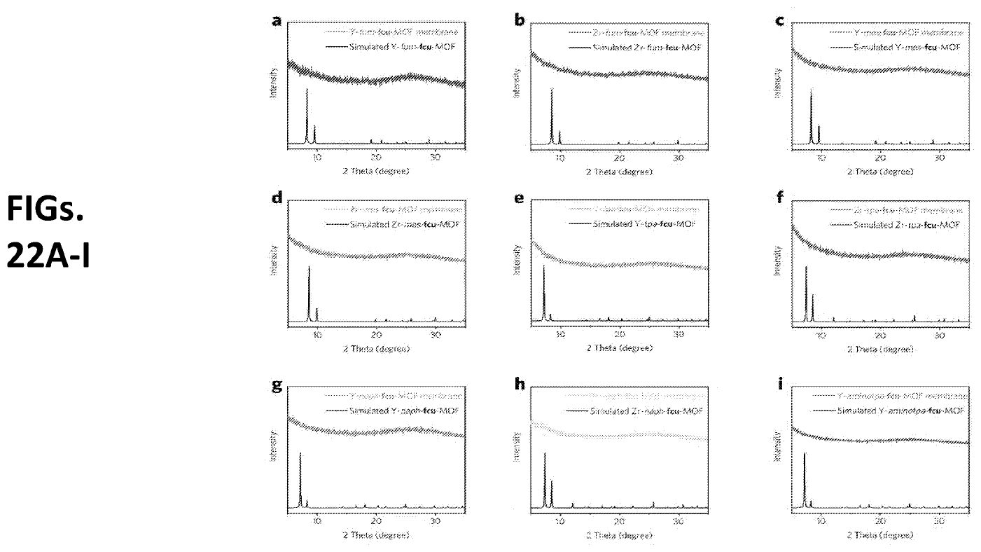

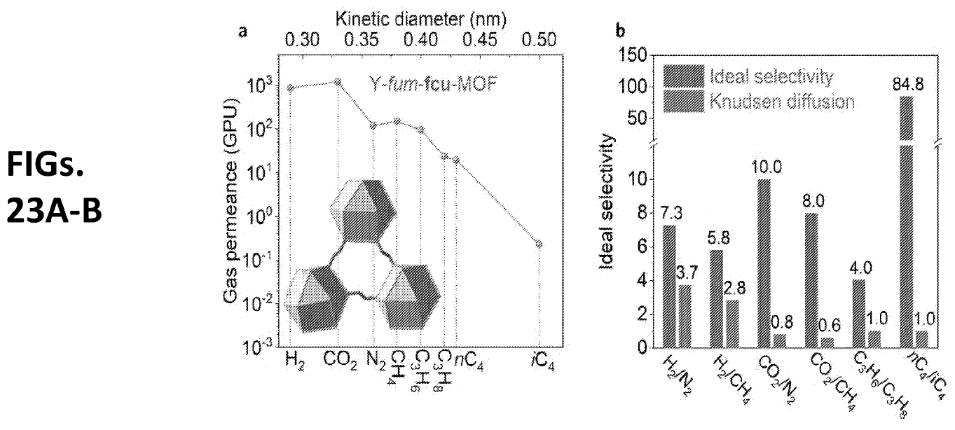

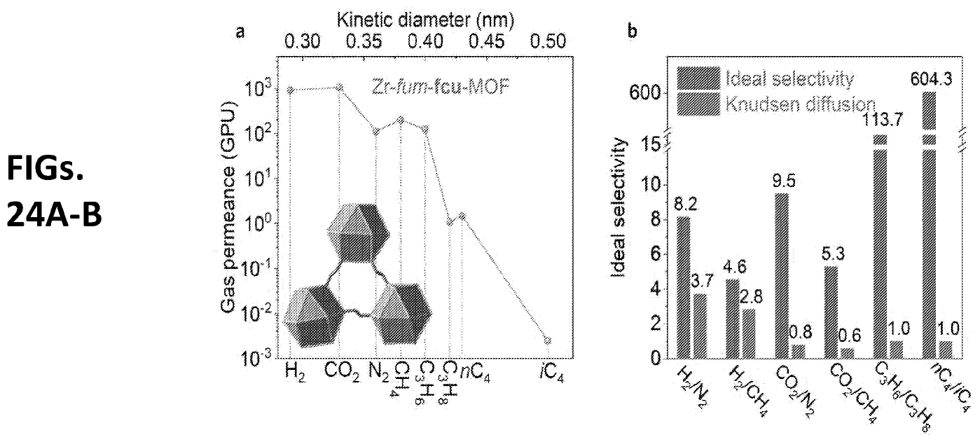

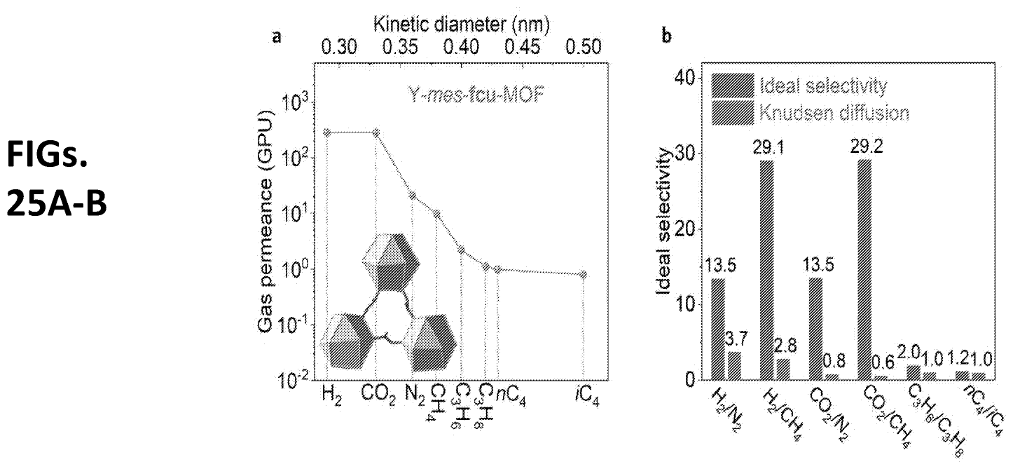

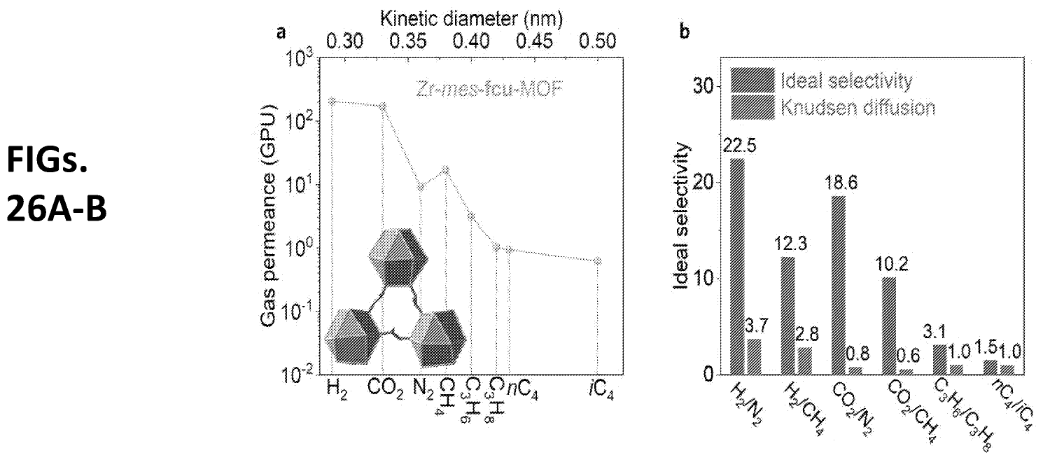

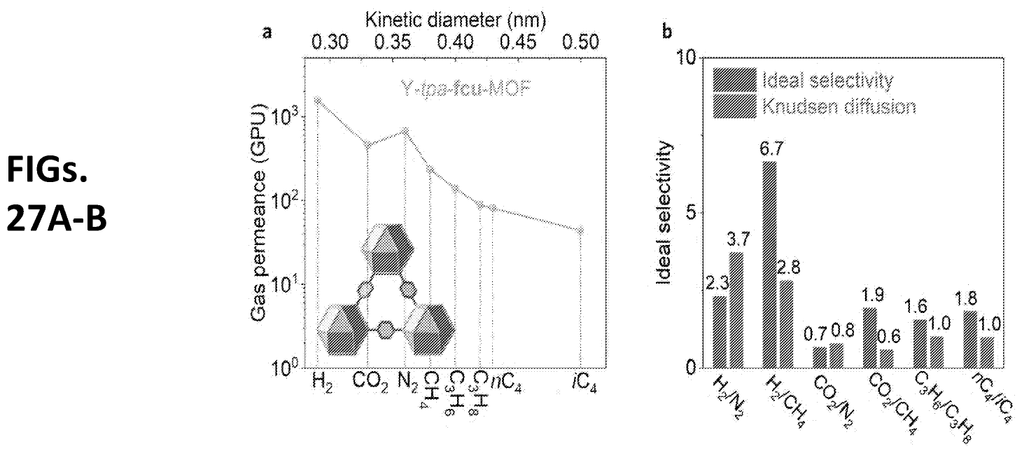

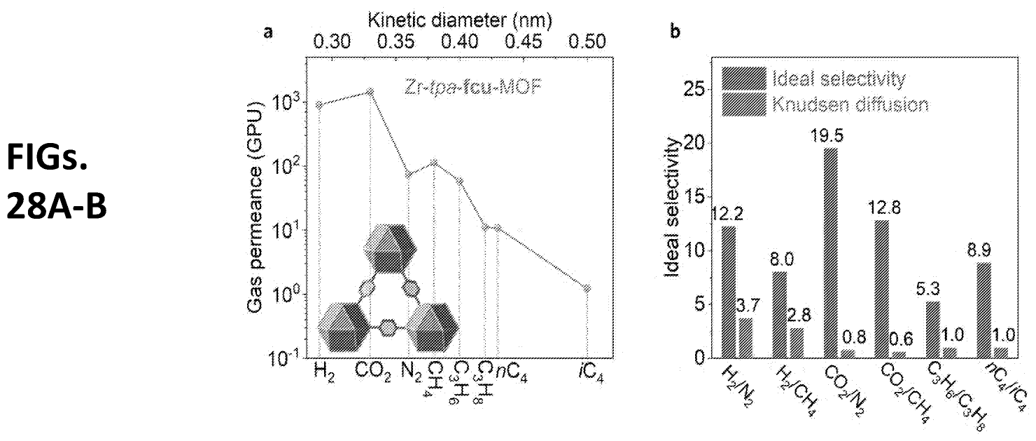

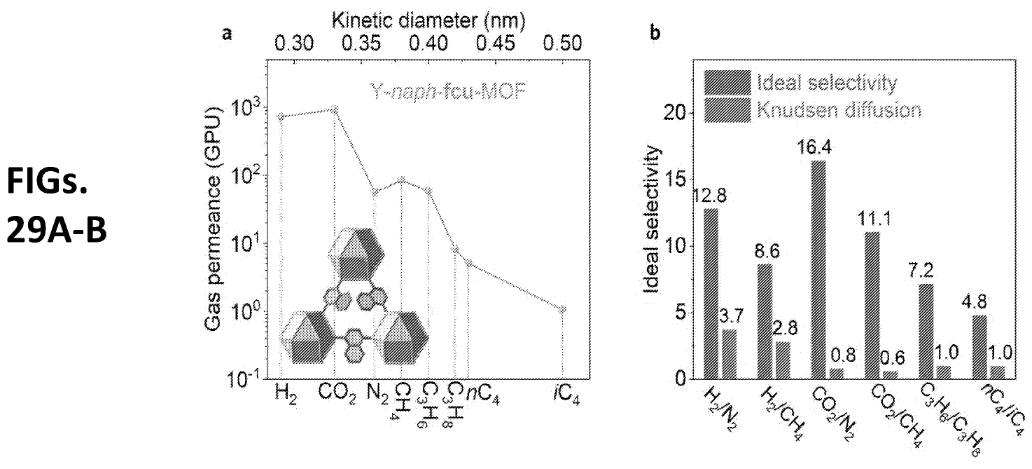

The quality of resulting membranes was characterized by top-view and cross-section SEM images (FIGS. 3I-O). All obtained membranes display continuous and well-intergrown layers with submicron thicknesses, anchoring firmly on the Anodisc support without cracks. The phase purity of the different membranes was confirmed by XRD studies (FIG. 10). It was further experimentally evaluated the adaptability of the prerequisite ligand concentration for each membrane, corroborating that a minor deviation of ˜−20% to ˜+25% from the calculated concentration is adequate to maintain the layer continuity. Whereas significant divergence beyond the interval of [−20%, 25%] resulted in amorphous, cracked layers, or isolated tiny crystals (FIGS. 11-22). The boundary conditions to achieve continuous layers for both RE-fcu-MOF and Zr-fcu-MOF systems are precisely identified for better-guided membrane fabrication (FIGS. 2F-G).

From the obtained parameters, the concentration of ligands (e.g., fumaric acid) in the mother solution would be known. According to the pKa value, the concentration of the deprotonated ligands could be calculated. Based on that, for a new type of fcu-MOF membrane, the concentration of the deprotonated new ligand in the solution would be equal to the previously calculated value, which can be controlled by adjusting the concentration of the new primary ligand according to its pKa value. The calculations and development of the guideline for RE-fcu-MOF membranes are as follows.

In the initial stage (as soon as the ligands are mixed with the cluster solution), equilibrium will be reached, we have,

$${H}_{2} L ⇌ 2 {H}^{+} + {L}^{2 -} , {K}_{a} = \frac{{[ {H}^{+} ]}^{2} {L}^{2 -} ]}{[ {H}_{2} L ]} ,$$

pKa=−IgKa=lg[H₂L]−2lg[H⁺]−lg[L²⁻]

When the ligand is fumaric acid (fum), we then have,

$$fum ⇌ 2 {H}_{solution}^{+} + {fum}^{2 -} ,$$

$$pKa ( fum ) = lg [ fum ] - 2 {lg [ {H}^{+} ]}_{solution} - lg [ {fum}^{2 -} ]$$

Here, [fum²⁻] is the concentration of the deprotonated fumaric acid in the solution. The optimal conditions to get continuous Y-fum-fcu-MOF membranes is shown, so the [fum²⁻] can be considered as the [L²⁻]_{ideal}. To calculate [fum²⁻], the pKa(fum), [fum] and [H⁺]ₛₒₗᵤₜᵢₒₙ in the solution would need to be known. The first two parameters can be found from the literature and the explored experimental conditions, respectively, while the concentration of protons [H⁺]ₛₒₗᵤₜᵢₒₙ in the solution need to be further calculated from two parts. Both the modulators (2-FBA) and ligands could dissociate to contribute protons to the solution, that is,

$${[ {H}^{+} ]}_{solution} = {[ {H}^{+} ]}_{2 - F B A} + {[ {H}^{+} ]}_{f u m} = {[ {H}^{+} ]}_{2 - F B A} + 2 [ {fum}^{2 -} ]$$

Now for [fum²⁻] to be calculated, the proton concentration would need to be known from the modulators [H⁺]_{FBA}. Since the same cluster solution with the fixed contents is utilized, the [H⁺]_{FBA} should be one exact constant value and always the same for different membrane targets. Here the [H⁺]_{FBA} is to be constant A. Then we have,

$${[ {H}^{+} ]}_{solution} = {[ {H}^{+} ]}_{2 - F B A} + {[ {H}^{+} ]}_{fum} = {[ {H}^{+} ]}_{2 - F B A} + 2 [ {fum}^{2 -} ] = A + {2 [ {L}^{2 -} ]}_{i deal}$$

$$Due to , pKa ( fum ) = lg [ fum ] - 2 {lg [ {H}^{+} ]}_{solution} - lg [ {fum}^{2 -} ] = lg [ hum ] - 2 lg ( A + {2 [ {L}^{2 -} ]}_{i deal} ) - {lg [ {L}^{2 -} ]}_{i deal}$$

We have, (A+2[L²⁻]_{ideal})²[L²⁻]_{ideal}=10\hat{ }{lg[fum]−pKa(fum)}
[fum] and pKa(fum) are both known value, it can be further simplified by using the exact numbers,

$${{( A + {[ {L}^{2 -} ]}_{i deal} )}^{2} [ {L}^{2 -} ]}_{i deal} = 6.262 \times 1 {0}^{- 5}$$

Now to consider the fabrication of another new fcu-MOF membrane, whose ligand is named by [H₂Lₓ]. In the initial stage, we have,

$${H}_{2} {L}_{x} ⇌ 2 {H}^{+} + {L}_{x}^{2 -} , {K}_{a} = \frac{{[ {H}^{+} ]}^{2} [ {L}_{x}^{2 -} ]}{[ {H}_{2} {L}_{x} ]} = 1 {0}^{- p K a}$$

$$[ {H}_{2} {L}_{x} ] = {[ {H}^{+} ]}^{2} [ {L}_{x}^{2 -} ] \times 1 {0}^{p K a}$$

To get a membrane layer with good continuity, we need to make [Lₓ²⁻]=·[L²⁻]_{ideal}. As a result, the required concentration of H₂Lₓ can be calculated as,

$$[ {H}_{2} {L}_{x} ] = {[ {H}^{+} ]}^{2} [ {L}_{x}^{2 -} ] \times 1 {0}^{p K a} = {{( {[ {H}^{+} ]}_{2 - F B A} + {[ {H}^{+} ]}_{{H}_{2} {L}_{x}} )}^{2} [ {L}^{2 -} ]}_{i deal} \times {10}^{p K a} = {{( {[ {H}^{+} ]}_{2 - F B A} + 2 [ {L}_{x}^{2 -} ] )}^{2} [ {L}^{2 -} ]}_{i deal} \times {10}^{pKa} = {{( A + {2 [ {L}^{2 -} ]}_{ideal} )}^{2} [ {L}^{2 -} ]}_{ideal} \times {10}^{p K a} = 6.262 \times 1 {0}^{( p K a - 5 )}$$

As a result, the required ligand concentration for different MOF membranes is a function of the ligand's pKa value.

A similar calculation could be applied to the Zr-fcu-MOF membrane family, and the final formula is,

$${[ {H}_{2} {L}_{x} ]}_{Zr - fcu - MOF} = 2.319 \times 1 {0}^{( pKa - 5 )}$$

The defined [L²⁻]_{ideal} only represents one of the successful example. Actually, a slight different the defined value is also possible to make the exchange proceed in a suitable rate, so the obtained values are something between qualitative and quantitative. As a result, the suitable concentration of ligands would be a range, instead of an exact number, which is further demonstrated herein.

### Light-Hydrocarbons Separation Performance

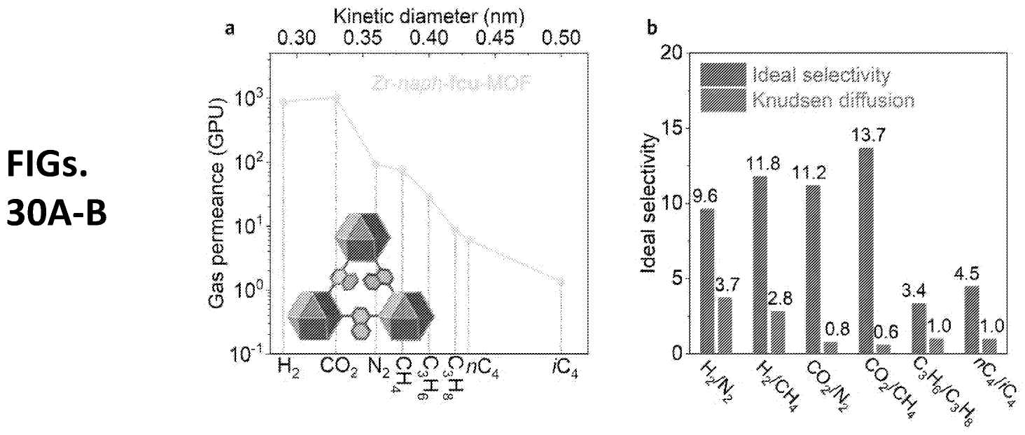

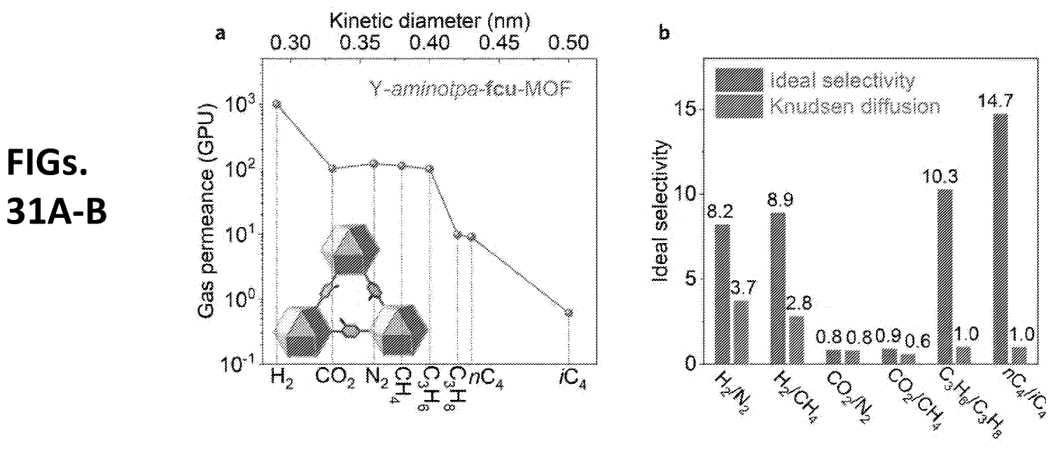

To assess their separation performances, single-gas permeation measurements were performed for all nine fcu-MOF membranes (FIGS. 23-31, Table 1).

TABLE 1
Single-gas permeation results of the 9 fcu-MOF membranes.

| | Permeance (GPU) | | | | | | | |
|---|---|---|---|---|---|---|---|---|
| Membrane | H₂ | CO₂ | N₂ | CH₄ | C₃H₆ | C₃H₈ | nC₄ | iC₄ |
| Y-fum-fcu-MOF | 873.3 | 1201 | 120.1 | 150.4 | 95.03 | 23.59 | 19.50 | 0.2299 |
| Zr-fum- fcu -MOF | 902.9 | 1050 | 110.6 | 197.8 | 121.8 | 1.071 | 1.467 | 0.002430 |
| Y-mes-fcu-MOF | 282.5 | 284.3 | 20.98 | 9.722 | 2.184 | 1.108 | 0.9781 | 0.7944 |
| Zr-mes-fcu-MOF | 205.2 | 169.8 | 9.131 | 16.73 | 3.152 | 1.015 | 0.9298 | 0.6098 |
| Y-tpa-fcu-MOF | 1556 | 453.7 | 669.5 | 233.9 | 138.6 | 88.16 | 80.46 | 44.00 |
| Zr-tpa-fcu-MOF | 901.7 | 1438 | 73.63 | 112.1 | 58.39 | 11.06 | 10.81 | 1.218 |
| Y-naph-fcu-MOF | 723.3 | 928.0 | 56.50 | 83.94 | 58.61 | 8.181 | 5.042 | 1.049 |
| Zr-naph-fcu-MOF | 882.2 | 1024 | 91.45 | 74.69 | 28.78 | 8.572 | 6.088 | 1.359 |
| Y-aminotpa-fcu-MOF | 997.0 | 101.6 | 121.3 | 112.0 | 100.7 | 9.801 | 9.023 | 0.6123 |

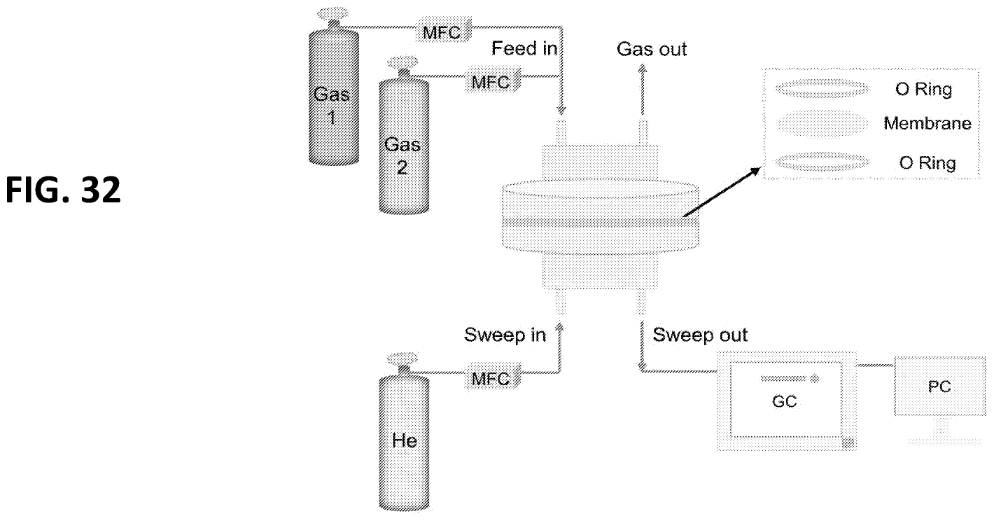

Using Wicke-Kallenbach technique for measurements coupled with a careful on-stream activation process is necessary to remove guest molecules (e.g., water, dimethylformamide) from the cages without damaging the membrane integrity and quality (FIGS. 32-34). The primary single-gas screening revealed that Zr-fum-fcu-MOF and Y-fum-fcu-MOF membranes exhibit anticipated separation properties pertaining to C₃H₆/C₃H₈ and nC₄/iC₄ mixture (FIGS. 23-31, Table 1).

Zr-fum-fcu-MOF membranes displayed a notable C₃H₆/C₃H₈ separation ability with C₃H₆ permeance of ˜10⁸ GPU (3.6×10⁻⁸ mol m⁻² s⁻¹ pa⁻¹, 1 GPU=3.348×10⁻¹⁰ mol m⁻² s⁻¹ pa⁻¹) and a mixture separation factor above 110, beyond the trade-offs of polymers and pure ZIF-8 membranes (FIG. 4A, Table 2).

TABLE 2
C₃H₆/C₃H₈ mixed-gas separation performance of 9 identical
Zr-fum-fcu-MOF membranes (1 atm, 25° C.).

| | Permeance (GPU) | | Separation |
|---|---|---|---|
| Membrane | C₃H₆ | C₃H₈ | factor |
| Zr-fum-fcu-MOF (I) | 96.32 | 0.8634 | 111.6 |
| Zr-fum-fcu-MOF (II) | 118.5 | 1.053 | 112.9 |
| Zr-fum-fcu-MOF (III) | 128.5 | 1.007 | 127.9 |
| Zr-fum-fcu-MOF (IV) | 98.99 | 0.9022 | 109.8 |
| Zr-fum-fcu-MOF (V) | 113.0 | 1.102 | 102.6 |
| Zr-fum-fcu-MOF (VI) | 93.89 | 0.8781 | 107.0 |
| Zr-fum-fcu-MOF (VII) | 95.51 | 0.8904 | 107.3 |
| Zr-fum-fcu-MOF (VIII) | 117.6 | 0.9297 | 126.7 |
| Zr-fum-fcu-MOF (IX) | 116.1 | 0.9512 | 122.2 |
| Average | 108.7 | 0.9530 | 114.2 |
| Standard deviation | 11.94 | 0.07878 | 8.604 |

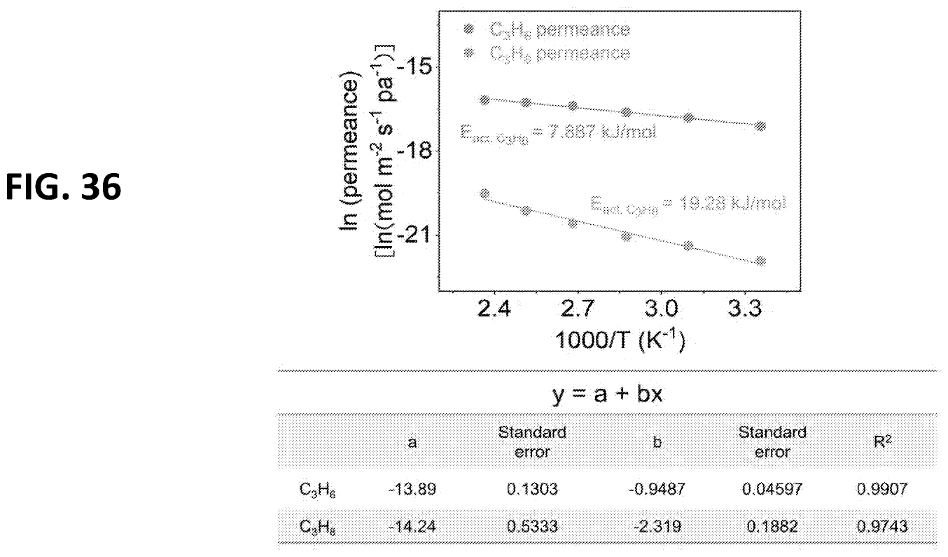

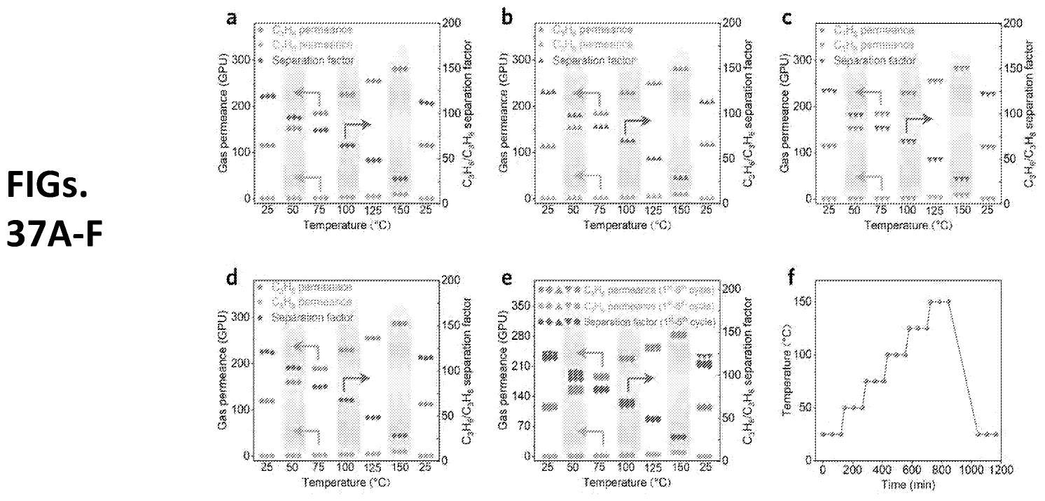

These results agree with the conformation-controlled sieving effect enabled by contracted triangular pore-apertures of Zr-fum-fcu-MOF. C₃H₆ molecules and double-eclipsed conformers of C₃H₈ (with lowest equilibrium distribution and highest rotation energy barrier) can pass through with less hindrance, while the majority of C₃H₈ molecules (with staggered conformation) are fully excluded (FIG. 4C). The effect of temperature on the mixture separation performance was assessed. Increasing the temperature from 25° C. to 150° C. afforded both the C₃H₆ and C₃H₈ to exhibit progressive enhancement in permeance, but the latter increases faster, leading to a gradually reduced separation factor (FIGS. 35A-B). Higher temperatures not only accelerate the dynamic diffusion of gas molecules thus expressing enhanced permeances, but also favor the transformation of staggered C₃H₈ into double-eclipsed conformation to allow more C₃H₈ to permeate, resulting in a decreased separation factor. Fitting the gas permeances at different temperatures to Arrhenius equation discloses the apparent activation energies for the permeation of C₃H₆ and C₃H₈ are 7.9 and 19.3 kJ mol¹, respectively (FIG. 36). The separation performance can recover completely upon cooling to 25° C. and remains consistent after five temperature-swing cycles (FIG. 37), attesting to the excellent thermal stability and robustness of Zr-fum-fcu-MOF membranes.

Such a unique sieving effect disappears when the window aperture slightly widens (even if only by ˜0.1 Å) via slightly changing the hexanuclear MBB from [Zr₆O₄(OH)₄(O₂C—)₁₂] to [Y₆(μ₃-OH)₈(O₂C—)₁₂]. All the conformers of C₃H₈ can readily pass through the resultant Y-fum-fcu-MOF membranes, leading to nearly a complete loss of the sieving capability for the C₃H₆/C₃H₈ mixture (FIG. 4A, Table 3). Evidently, the separation selectivity is predominantly governed by the difference in diffusion rather than adsorption affinity.

TABLE 3
C₃H₆/C₃H₈ mixed-gas separation performance of 5 identical
Y-fum-fcu-MOF membranes (1 atm, 25° C.).

| | Permeance (GPU) | | Separation |
|---|---|---|---|
| Membrane | C₃H₆ | C₃H₈ | factor |
| Y-fum-fcu-MOF (I) | 82.52 | 21.08 | 3.933 |
| Y-fum-fcu-MOF (II) | 77.28 | 14.69 | 5.285 |
| Y-fum-fcu-MOF (III) | 89.69 | 18.35 | 4.893 |
| Y-fum-fcu-MOF (IV) | 81.43 | 17.05 | 4.779 |
| Y-fum-fcu-MOF (V) | 93.29 | 23.28 | 4.011 |
| Average | 84.84 | 18.89 | 4.580 |
| Standard deviation | 5.814 | 3.011 | 0.5247 |

On the other hand, a shift to discriminate larger molecular pairs shows that Y-fum-fcu-MOF membranes are indeed more efficient for nC₄/iC₄ separation (FIG. 4B). Although Zr-fum-fcu-MOF membranes exhibit unprecedented nC₄/iC₄ separation factor of ˜600, the narrow aperture that imposing excessive transport resistance results in extremely low nC₄ permeance (˜1.5 GPU, Table 4) and the space for improvement is very limited given that the membrane thickness is already as thin as 150 nm.

TABLE 4
nC₄/iC₄ mixed-gas separation performance of 9 identical
Zr-fum-fcu-MOF membranes (1 atm, 25° C.).

| | Permeance (GPU) | | Separation |
|---|---|---|---|
| Membrane | nC₄ | iC₄ | factor |
| Zr-fum-fcu-MOF (I) | 1.536 | 0.002877 | 534.0 |
| Zr-fum-fcu-MOF (II) | 1.982 | 0.003237 | 612.4 |
| Zr-fum-fcu-MOF (III) | 1.168 | 0.002071 | 563.7 |
| Zr-fum-fcu-MOF (IV) | 1.093 | 0.002158 | 506.5 |
| Zr-fum-fcu-MOF (V) | 1.669 | 0.003237 | 515.6 |
| Zr-fum-fcu-MOF (VI) | 1.174 | 0.001904 | 616.6 |
| Zr-fum-fcu-MOF (VII) | 1.380 | 0.001904 | 724. |
| Zr-fum-fcu-MOF (VIII) | 1.467 | 0.002158 | 681.3 |
| Zr-fum-fcu-MOF (IX) | 1.435 | 0.003237 | 443.2 |
| Average | 1.434 | 0.002531 | 577.6 |
| Standard deviation | 0.2636 | 0.0005666 | 84.44 |

On the contrary, Y-fum-fcu-MOF membranes with a slightly larger pore-aperture size offer ten times higher nC₄ permeance (˜16 GPU) and an appreciable nC₄/iC₄ separation factor of ˜75, far beyond the current limit in polymer and MOF/polymer hybrid membranes (FIG. 4B, Table 5).

TABLE 5
nC₄/iC₄ mixed-gas separation performance of 5 identical
Y-fum-fcu-MOF membranes (1 atm, 25° C.).

| | Permeance (GPU) | | Separation |
|---|---|---|---|
| Membrane | nC₄ | iC₄ | factor |
| Y-fum-fcu-MOF (I) | 16.71 | 0.2501 | 66.90 |
| Y-fum-fcu-MOF (II) | 14.40 | 0.1919 | 75.15 |
| Y-fum-fcu-MOF (III) | 16.93 | 0.2009 | 84.30 |
| Y-fum-fcu-MOF (IV) | 14.83 | 0.2038 | 72.82 |
| Y-fum-fcu-MOF (V) | 18.14 | 0.2258 | 80.35 |
| Average | 16.20 | 0.2145 | 75.90 |
| Standard deviation | 1.389 | 0.02101 | 6.022 |

Compared with Y-fum-fcu-MOF based MMMs, the polycrystalline membranes enables a notable improvement on both permeance and selectivity. Prominently, comparisons of single-gas permeation results for the two fum-fcu-MOF membranes disclose that two size cut-off areas exist for Zr-fum-fcu-MOF membranes corresponding to C₃H₆/C₃H₈ and nC₄/iC₄, respectively, while only one cut-off for nC₄/iC₄ can be identified for Y-fum-fcu-MOF membranes (FIG. 4D).

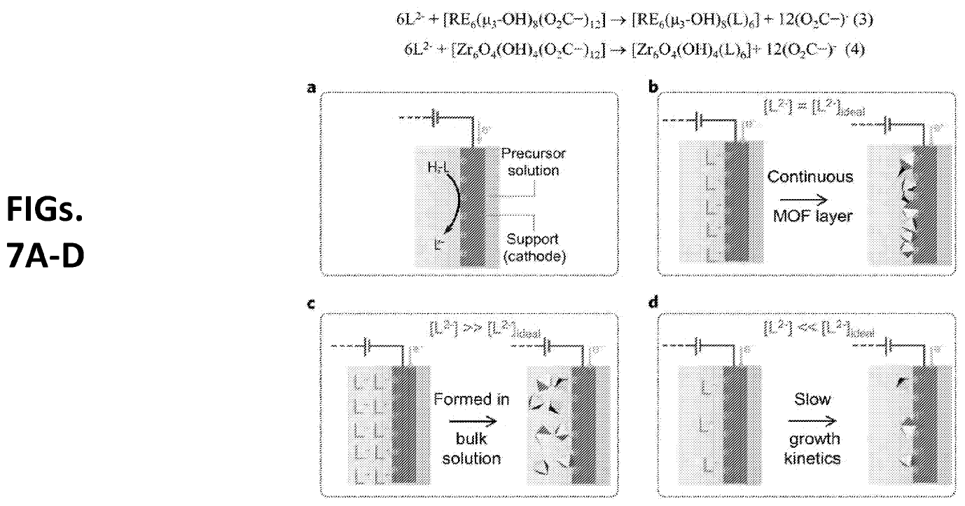

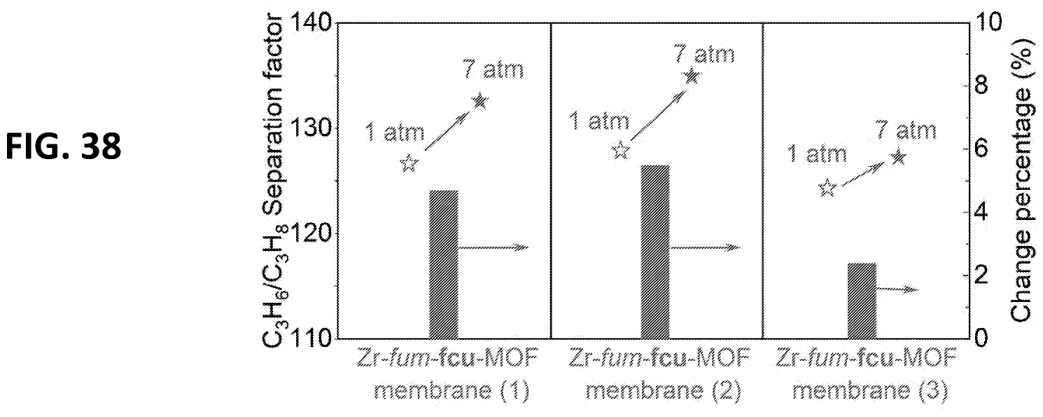

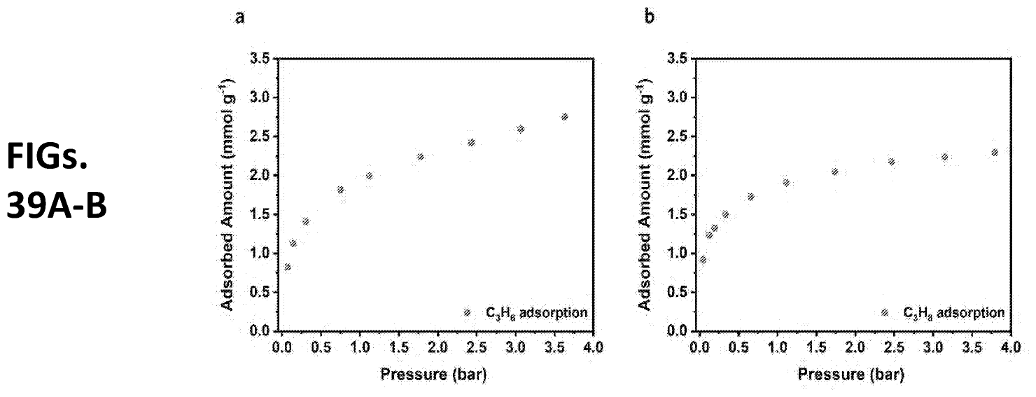

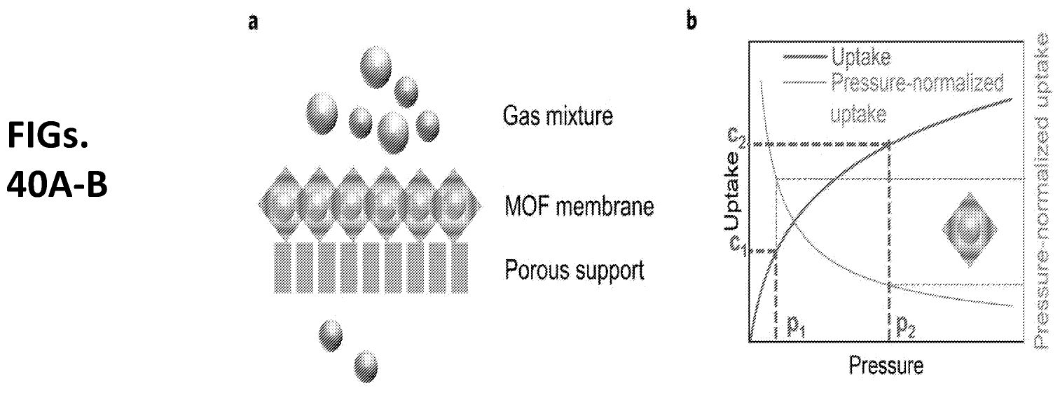

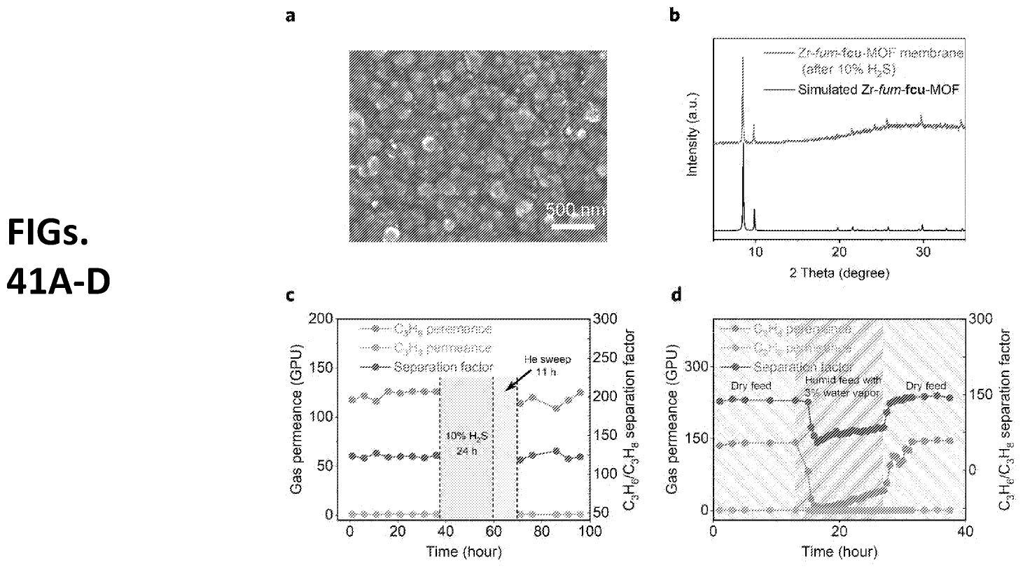

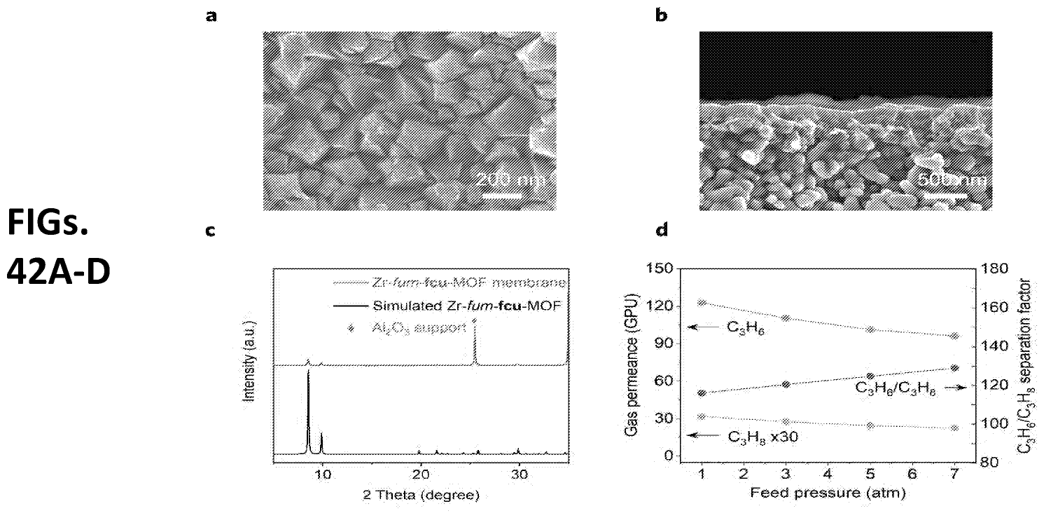

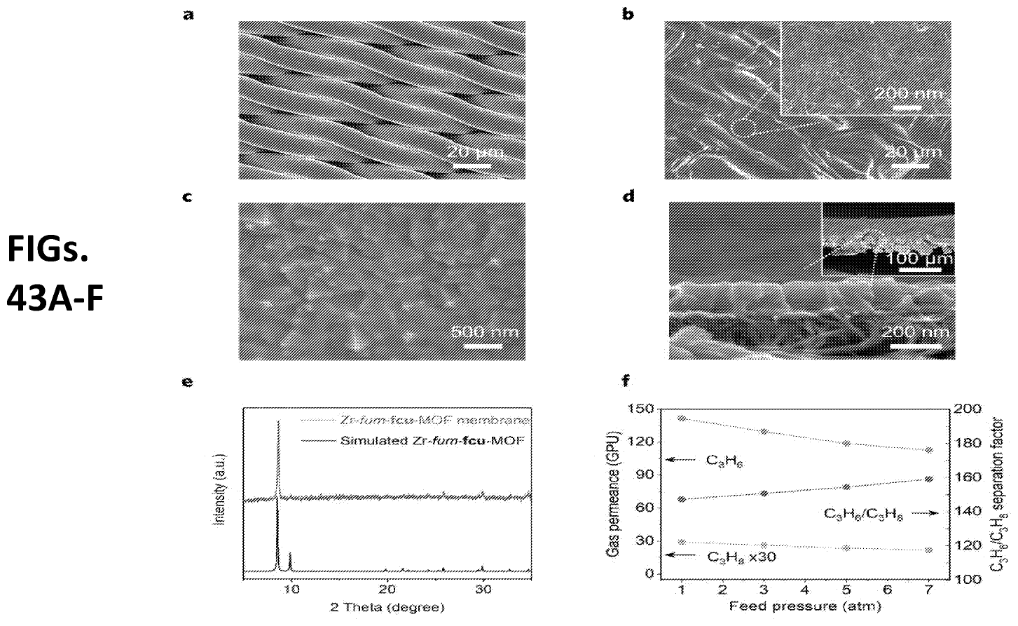

In order to explore the prospective deployment of Zr-fum-fcu-MOF membrane for practical C₃H₆/C₃H₈ separation, where high pressure ratio is more appropriate, the resultant membranes pressure-resistance capacity was evaluated. No selectivity degradation was observed with elevated feed pressure from 1 to 7 atm, instead a slight increase in the separation factor from 124 to 127 is observed (FIG. 5A). Reproducibility measurements on another two identical Zr-fum-fcu-MOF membranes showed the same trend with separation factors increasing from 126, 127 to 132, 134, respectively, affording an average increase of ˜+4.1% (FIG. 38). Such a positive response towards high feed pressures is rarely reported among polycrystalline MOF membranes, differentiating the current membrane from those state-of-the-art C₃H₆-selective ZIF-8/ZIF-67 membranes. Due to their linker rotation behavior, ZIF-8/ZIF-67 suffer from the “gate-opening” effect under high feed pressures, leading to apparent selectivity reduction and hindering their plausible deployment under practical conditions (FIG. 5B). Efforts to suppress the linker mobility by polymer coatings s afforded a decrease in permeance. On the contrary, the deliberately designed triangular pore-aperture of Zr-fum-fcu-MOF, constrained by fumarates with non-rotating C═C double bonds, provides the requisite intrinsic rigidity that prohibits plausible deformation under high pressures and subsequently preserving the molecular-sieving ability.

Both the permeances of C₃H₆ and C₃H₈ decrease with elevated feed pressure, and the C₃H₆ permeance at 7 atm is ˜26% lower than that at 1 atm (FIG. 5A). According to Fick's first law, the diffusive flux is proportional to the concentration gradient over the membrane³⁸, which is exactly the concentration of the guest molecules dissolved in the membrane layer due to the existence of sweep gas in the permeate side. High-pressure adsorption isotherms for Zr-fum-fcu-MOF revealed the uptake for C₃H₆ or C₃H₈ follows approximately a logarithmic increase with pressure instead of a linear relationship (FIG. 39), attesting that the pressure-normalized concentration of guest molecules at high pressures is lower than that at low pressure. The pressure-normalized flux, namely permeance, follows the same decreasing trend with increased pressure (FIG. 40). According to Fick's first law, J=−D·gradc. J is the flux, D is the diffusion coefficient and gradc represents the concentration gradient over the membrane. For the same membrane, the flux should be proportional to the negative concentration gradient, namely “−(cₚₑᵣₘₑₐₜₑ−c_{bulk membrane})”. In the membrane case, the concentration of the probe gas molecules in the permeate side can be considered to be zero because the sweep gas will remove the permeate gases immediately. As a result, the flux is proportional to the concentration of gas in the bulk membrane. The maximum gas concentration actually is determined by the gas uptake value of the membrane material, which follows a logarithmic shape curve (FIG. 40B). Assuming that at low pressure (p=p₁), the uptake is c₁, the flux can be presented as J₁=D·c₁. At higher pressure, such as p=p₂, the uptake can increase to c₂, so the flux can be presented to be J₂=D·c₂. According to the logarithmic model, the increase percentage of the gas uptake should be smaller than that of the pressure, so we have, c₂/c₁<p₂/p₁, (c₂/c₁)/(p₂/p₁)<1. The permeance is the pressure normalized flux, as a result, at low pressure (p=p₁), the permeance is P₁=D·c₁/p₁, while at higher pressure (p=p₂), the permeance is P₂=D·c₂/p₂. As a result, P₂/P₁=(D·c₂/p₂)/(D·c₁/p₁)=(c₂/c₁)/(p₂/p₁)<1. In other words, P₂<P₁. This rationalizes the lower permeance at high feed pressure.

Nonetheless, the total flux indeed increases significantly and the combination of the real C₃H₆ flux with the excellent C₃H₆/C₃H₈ separation factor at 7 atm feed pressure enables Zr-fum-fcu-MOF membrane to be placed among the best performing membranes, competing as a potential efficient and economical candidate for membrane-distillation hybrid processes (FIG. 5C).

Zr-fum-fcu-MOF membrane exhibits an exceptional stability during the long-term continuous operation and its intrinsic superior C₃H₆/C₃H₈ separation performance can be maintained for at least 15 days (FIG. 5D). Moreover, the Zr-fum-fcu-MOF membrane is able to survive under conditions akin to industry-relevant hard streams, such as humid or H₂S-containing corrosive atmospheres. The membrane layer remains intact and no structural changes were observed after 10% H₂S treatment, as supported by the SEM image and XRD patterns (FIG. 41). The C₃H₆/C₃H₈ separation performances before and after 10% H₂S or humid feed stream treatment are also compared, affirming the preservation of the excellent separation capability and again the inherent robust nature of fcu-MOF family (FIG. 41). The evaluation of these membranes upon exposure to H₂S in presence of water vapor is essential, and will be explored when the required intricate setup is accessible for these studies.

To be more realistic and further lower the fabrication costs, we prepared Zr-fum-fcu-MOF membranes using electrochemical approach on ceramic α-Al₂O₃ supports and commercialized cheap stainless-steel nets (SSN) supports, which showed identical layer continuity, cross-section thickness and lattice structure compared with the membranes supported on Anodisc (FIGS. 42-43). Delightfully, the C₃H₆/C₃H₈ mixed-gas separation performance did not decrease, with average C₃H₆ permeance of 117.7 and 129.1 GPU, and average C₃H₆/C₃H₈ mixed-gas separation factor of 115.4 and 145.5, respectively for the membranes supported on α-Al₂O₃ and SSN (Tables 6-7).

TABLE 6
C₃H₆/C₃H₈ mixed-gas separation performance of 4 identical
Zr-fum-fcu-MOF membranes on traditional ceramic supports (α-
Al₂O₃, 1 atm, 25° C.).

| | Permeance (GPU) | | Separation |
|---|---|---|---|
| Membrane | C₃H₆ | C₃H₈ | factor |
| Zr-fum-fcu-MOF (X) | 113.7 | 1.088 | 104.6 |
| Zr-fum-fcu-MOF (XI) | 115.3 | 0.9860 | 117.0 |
| Zr-fum-fcu-MOF (XII) | 119.0 | 0.9616 | 123.9 |
| Zr-fum-fcu-MOF (XIII) | 122.7 | 1.059 | 116.0 |
| Average | 117.7 | 1.024 | 115.4 |
| Standard deviation | 3.480 | 0.05162 | 6.925 |

TABLE 7
C₃H₆/C₃H₈ mixed-gas separation performance of 4 identical
Zr-fum-fcu-MOF membranes on porous stainless-steel net supports (1 atm,
25° C.). SSN-supported membranes show slightly better separation
performance than the membranes prepared on Anodisc and α-Al₂O₃
supports. The improved permeance could be ascribed to the use of
macroporous SSN as the support with higher void volume compared
with other supports as suggested by Huang et al.⁶ and Zhou et al.⁷.
The increased selectivity could be ascribed to the improved surface
roughness by CNT coating, which contributes to a better membrane
quality as suggested by Sheng et al.⁸.

| | Permeance (GPU) | | Separation |
|---|---|---|---|
| Membrane | C₃H₆ | C₃H₈ | factor |
| Zr-fum-fcu-MOF (XIV) | 112.6 | 0.7883 | 143.4 |
| Zr-fum-fcu-MOF (XV) | 126.7 | 0.8231 | 154.6 |
| Zr-fum-fcu-MOF (XVI) | 141.5 | 0.9658 | 147.2 |
| Zr-fum-fcu-MOF (XVII) | 135.6 | 0.9953 | 136.9 |
| Average | 129.1 | 0.8931 | 145.5 |
| Standard deviation | 10.89 | 0.08890 | 6.404 |

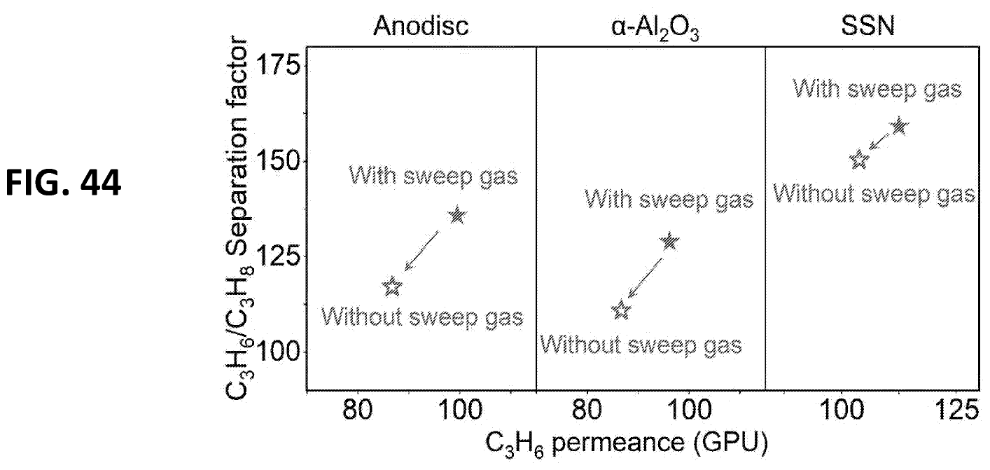

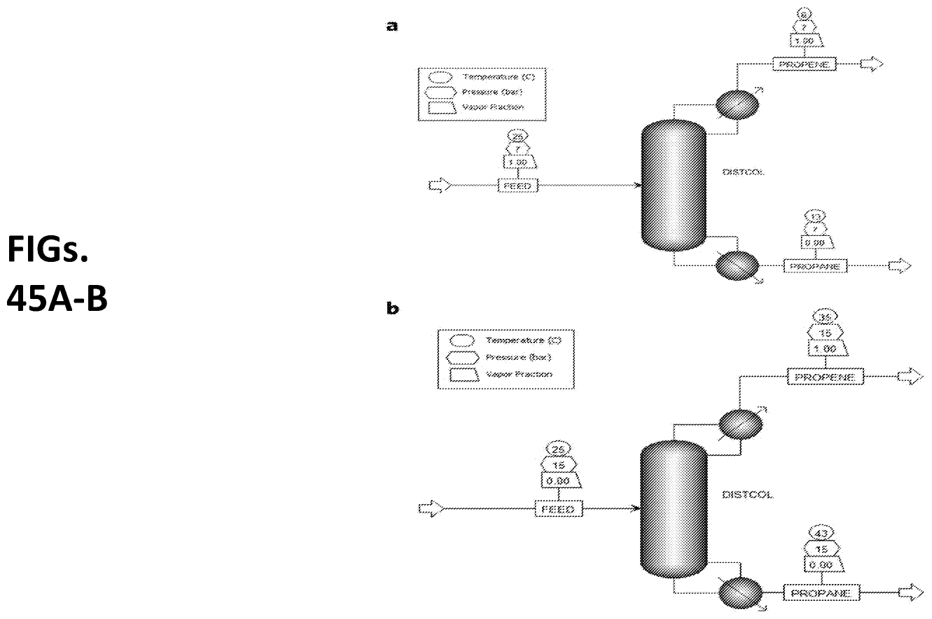

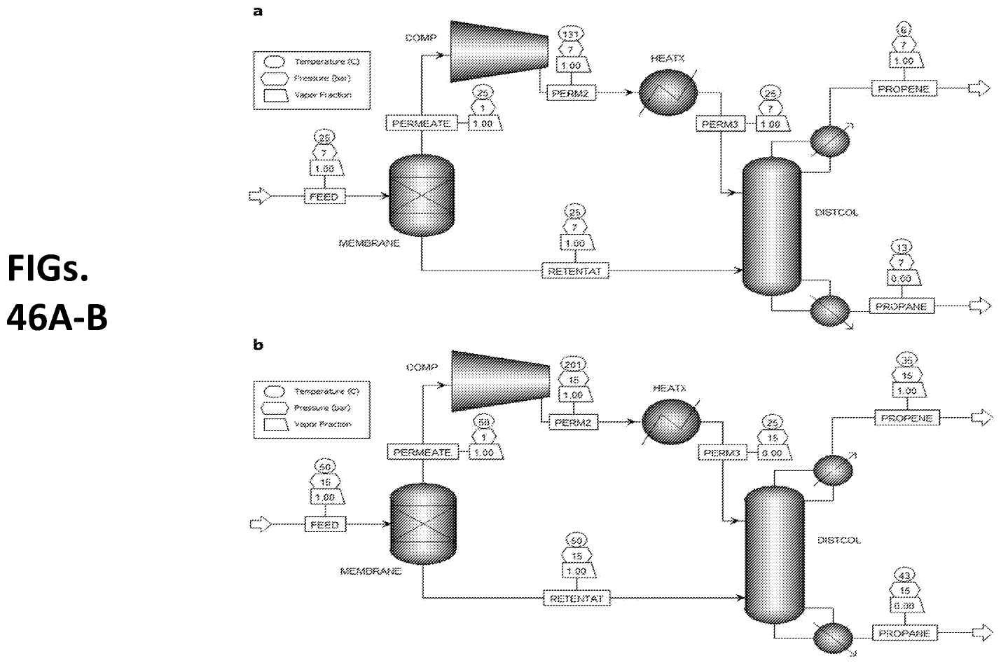

Moreover, both present a unique steady increase of C₃H₆/C₃H₈ separation factor with pressure, despite a slight decrease in C₃H₆ permeance (FIGS. 42-43). To better mimic the practical operations in industry, we further measured the C₃H₆/C₃H₈ mixed-gas separation performance when no sweep gas is applied and with a feed stream maintained at 7 atm for Zr-fum-fcu-MOF membranes grown on all the 3 different supports. Due to the reduced driven force for transport, both C₃H₆ permeance and C₃H₆/C₃H₈ separation factor decrease to some extent (FIG. 44, Table 8). The final separation performances are among the best with great potential for industrial processes, especially for the best-performing SSN-supported membrane with a C₃H₆ permeance of 103 GPU and C₃H₆/C₃H₈ separation factor of 150 (FIG. 44, Table 8). This inclusive evaluation corroborates the potential of Zr-fum-fcu-MOF membrane as a qualified high-flux, highly selective candidate for a practical energy-efficient, cost-effective and lasting C₃H₆/C₃H₈ separation.

TABLE 8
C₃H₆/C₃H₈ mixed-gas separation performance of Zr-fum-
fcu-MOF membranes at 7 atm feed stream on 3 different
supports with and without sweep gas.

| | | Sweep | Permeance (GPU) | | Separation |
|---|---|---|---|---|---|
| Membrane | Support | gas | C₃H₆ | C₃H₈ | factor |
| Zr-fum-fcu-MOF | Anodisc | He | 99.52 | 0.7364 | 135.8 |
| (XVIII) | | \ | 86.86 | 0.5346 | 117.1 |
| Zr-fum-fcu-MOF | α-Al₂O₃ | He | 96.17 | 0.7488 | 128.9 |
| (XIII) | | \ | 86.71 | 0.5635 | 110.9 |
| Zr-fum-fcu-MOF | Stainless- | He | 112.5 | 0.7270 | 159.1 |
| (XVI) | steel nets | \ | 103.9 | 0.5048 | 150.3 |

### Energy-Saving Estimation for Membrane-Based Separation Process

Conventionally, high purity propylene with polymer grade (99.5%) is obtained using distillation, an extremely energy-intensive process. The distillation columns are 90-100 meters tall and comprise over 200 trays. Accordingly as a reference, this configuration was modelled for an industrially relevant production unit (FIG. 45, Table 9), indicating a high reflux ratio of 15 with a condenser duty of 40 MW and a reboiler duty of 43 MW are needed to achieve an annual productivity target of 265000 tonnes polymer-grade C₃H₆. These results agree well with previous literature studies.

TABLE 9
Stream composition for the single distillation system.

| Stream | FEED | PROPANE | PROPENE | FEED | PROPANE | PROPENE |
|---|---|---|---|---|---|---|
| Mole Flow (kmol h⁻¹) | | | | | | |
| PROPANE | 720.00 | 717.01 | 2.99 | 720.00 | 716.74 | 3.26 |
| PROPENE | 720.00 | 2.99 | 717.01 | 720.00 | 3.26 | 716.74 |
| Mole Frac | | | | | | |
| PROPANE | 0.50 | 1.00 | 0.00 | 0.50 | 1.00 | 0.00 |
| PROPENE | 0.50 | 0.00 | 1.00 | 0.50 | 0.00 | 1.00 |
| Temperature (° C.) | 25.00 | 13.09 | 6.05 | 25.00 | 43.34 | 35.49 |
| Pressure (bar) | 7 | 7 | 7 | 15 | 15 | 15 |
| Vapor Frac | 1 | 0 | 1 | 0 | 0 | 1 |
| Liquid Frac | 0 | 1 | 0 | 1 | 1 | 0 |

One conceivable path to reduce this impeding energy penalty is to deploy a membrane-distillation hybrid process, permitting the introduction of a C₃H₆-selective membrane, as a pre-separator, in order to enrich the concentration of C₃H₆ in the feed stream prior to entering the distillation column (FIG. 46, Table 10).

TABLE 10
Stream composition for the hybrid membrane distillation system.

| Stream | FEED | PERM2 | PERM3 | PERMEATE | RETENTAT | PROPANE | PROPENE |
|---|---|---|---|---|---|---|---|
| Mole Flow (kmol h⁻¹) | | | | | | | |
| PROPANE | 720.00 | 0.00 | 0.00 | 0.00 | 720.00 | 716.44 | 3.56 |
| PROPENE | 720.00 | 714.46 | 714.46 | 714.46 | 5.54 | 3.56 | 716.44 |
| Mole Frac | | | | | | | |
| PROPANE | 0.500 | 0.000 | 0.000 | 0.000 | 0.992 | 0.995 | 0.005 |
| PROPENE | 0.500 | 1.000 | 1.000 | 1.000 | 0.008 | 0.005 | 0.995 |
| Temperature (° C.) | 25.00 | 130.52 | 25.00 | 25.00 | 25.00 | 13.09 | 6.05 |
| Pressure (bar) | 7 | 7 | 7 | 1 | 7 | 7 | 7 |
| Vapor Frac | 1 | 1 | 1 | 1 | 1 | 0 | 1 |
| Liquid Frac | 0 | 0 | 0 | 0 | 0 | 1 | 0 |
| Mole Flow (kmol h⁻¹) | | | | | | | |
| PROPANE | 720.00 | 0.00 | 0.00 | 720.00 | 0.00 | 716.42 | 3.58 |
| PROPENE | 720.00 | 714.46 | 714.46 | 5.54 | 714.46 | 3.58 | 716.42 |
| Mole Frac | | | | | | | |
| PROPANE | 0.500 | 0.000 | 0.000 | 0.992 | 0.000 | 0.995 | 0.005 |
| PROPENE | 0.500 | 1.000 | 1.000 | 0.008 | 1.000 | 0.005 | 0.995 |
| Temperature (° C.) | 50.00 | 201.29 | 25.00 | 50.00 | 50.00 | 43.34 | 35.49 |
| Pressure (bar) | 15 | 15 | 15 | 15 | 1 | 15 | 15 |
| Vapor Frac | 1 | 1 | 0 | 1 | 1 | 0 | 1 |
| Liquid Frac | 0 | 0 | 1 | 0 | 0 | 1 | 0 |

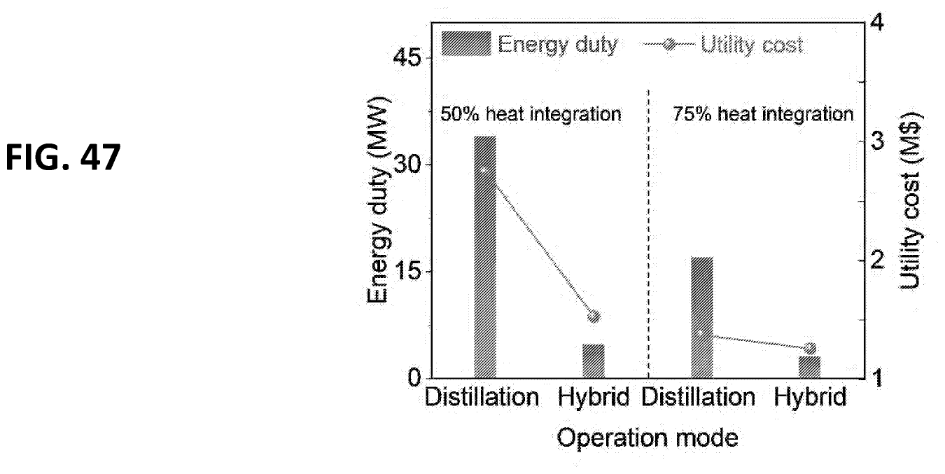

The evaluation based on the Zr-fum-fcu-MOF membrane, selectivity of 130, suggests that the membrane will perform most of the separation (99.23% C₃H₆ in the permeate side) and subsequently reduce the workload on the distillation column. The permeate comes out of the membrane at 1 atm and will be further compressed to either 7 or 15 bar in an isotropic compressor. The techno-economic analysis shows that at 7 bar with the suggested hybrid system, up to 89% of the total energy duty originally required for the original distillation column (condenser and reboiler duty, FIG. 6A) could be saved, which can be translated to a 67% utility cost saving. Utility saving is lower than the column energy saving due to the high electricity cost of the compressor (FIG. 6B). When employing 15 bar feed pressure, 87% saving for the total energy and 44% saving for the utility costs are reachable (FIG. 6A). The utility cost saving at 7 bar is about 52% higher than that at 15 bar due to the lower permeate compression and the higher cost of the condenser refrigerant for the distillation column. Furthermore, the case of heat-integrated distillation systems that can reduce the column energy duty from ˜50 to 75% and lessen the benefits of membranes was considered, but the membrane-distillation hybrid is still more competitive than the single-distillation system (FIG. 47).

The estimated single-distillation column equipment cost is about 6.5 M$, while for the hybrid system is about 8.5 M$ due to the extra compressor (FIG. 6C). However, considering a membrane lifetime of 10 years, thanks to the vast utility operational savings of 3.45 M$ (7 bar) or 1.25 M$ (15 bar) per year, it is projected a membrane breakeven cost of 3800 or 1500 $ m⁻² respectively for our membrane with ˜9,000 m² to match the same purification cost of the single-distillation column. These values are significantly above estimated membrane costs of 75-273 $ m² (Table 11).

TABLE 11
Chemicals and support used for the Zr-fum-fcu-MOF
membrane synthesis and the related cost estimation.

| | | |
|---|---|---|
| Metal | ZrOCl₂ | 230 mg |
| Ligand | Fumeric Acid | 60.80 mg |
| Support | Anodisc/Alumina disk/ | 2.2 cm diameter |
| | Stainless steel nets | (equal to 1.95 cm length) |

A cost estimation was conducted with two plausible scenarios, optimistic and pessimistic, to identify the manufacturing cost per m² of the Zr-fum-fcu-MOF membrane. The estimation was based on two factors: the cost of the standalone MOF synthesis and the cost of the porous support. The cost of the porous support was based on existing membrane literature and it is estimated to be around 220$ per m² if a low cost ceramic support is used or 58$ per m² if a polymeric support is used. For α-Al₂O₃ supports, the cost is between 500-1000 $ m⁻². For the commercial stainless-steel net supports, the price ordered is 45 $ m⁻² (SungYoung Chemical Tech Co., Ltd). The average weight of carbon nanotubes used for modification is 0.5 g m⁻², which is equal to 1.54 $ m⁻² (XFNANO Materials Tech Co., Ltd). As a result, the total cost of stainless-steel net supports is less than 50 $ m⁻². While none of these approaches is directly comparable to the electrochemical synthesis used herein, in contrast with the general belief, electrochemical synthesis tends to be more economical than the solvothermal approach with the vast majority of the costs coming from the raw materials. For instance, in the electrochemical synthesis of Aminoanthraquinone, 70% of the costs of a plant of 3300 tons per year will come from the raw materials. In the same line, in the MOF synthesis, solvent costs account for circa 80% of the total manufacturing costs.

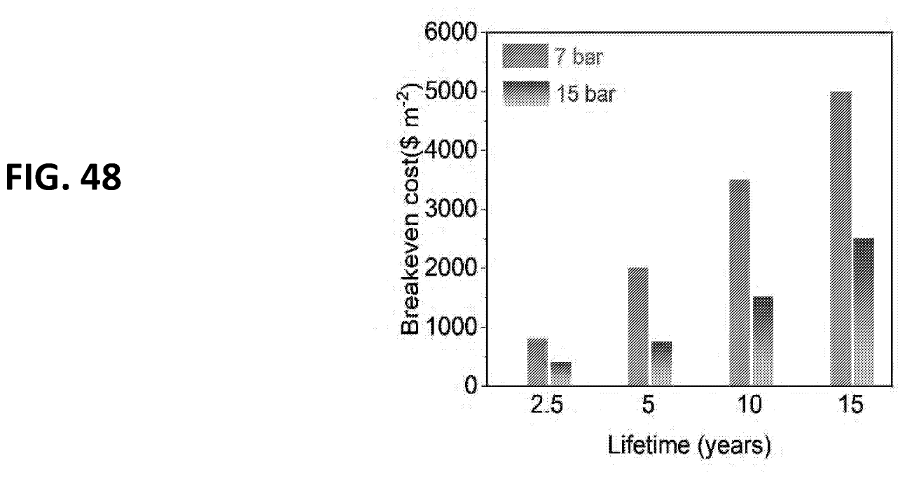

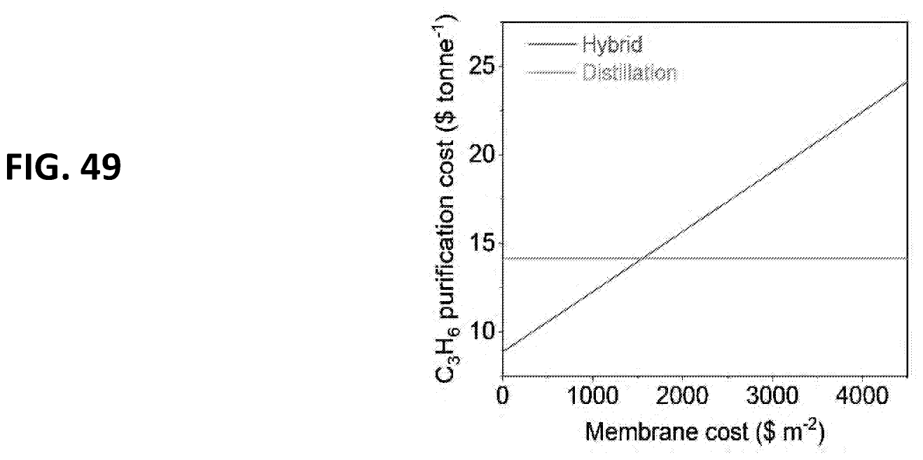

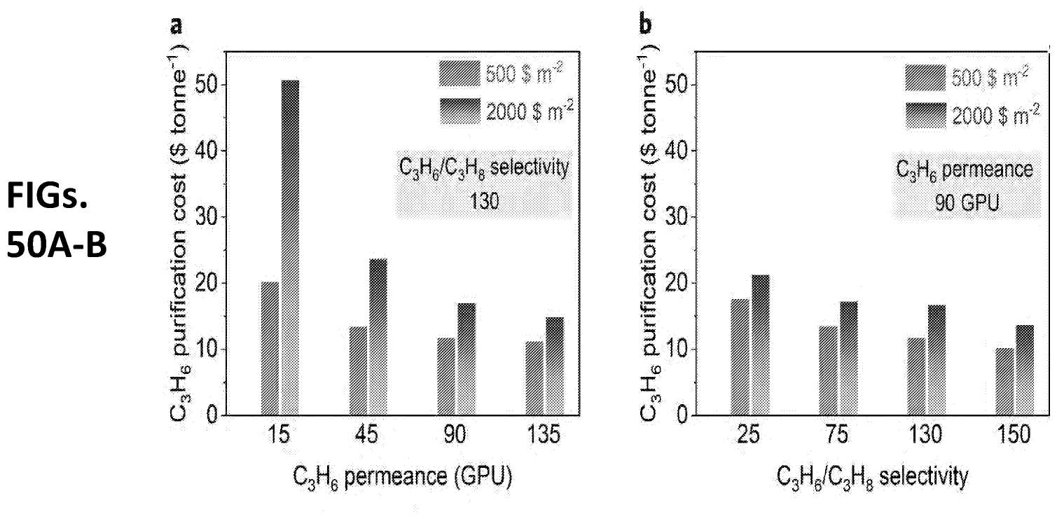

Nevertheless, these values are very dependent on the membrane lifetime (FIG. 48). The C₃H₆ purification cost was analyzed for both system (20 years amortization time for all equipment and membrane lifetime of 10 years, FIG. 6D, Supplementary FIG. 49), pinpointing the pronounced cost reduction of the hybrid system versus the conventional one-stage distillation system. The membranes are proved still efficient under practical conditions for industrial processes, where no sweep gas is applied in the permeate side, strongly supporting the benefits and practicability of our membranes (Table 8).

The effect of membrane permeance and selectivity on C₃H₆ purification cost was analysed. With a fixed selectivity of 130, lower permeance suggests a higher C₃H₆ purification cost as a larger membrane is needed for the same C₃H₆ flux (FIG. 50). However, this effect greatly depends on the membrane price, being more pronounced for expensive membranes. With a fixed permeance at 90 GPU, lower selectivity means higher operating costs as higher reflux ratio of the column is needed to achieve the desired C₃H₆ purity.

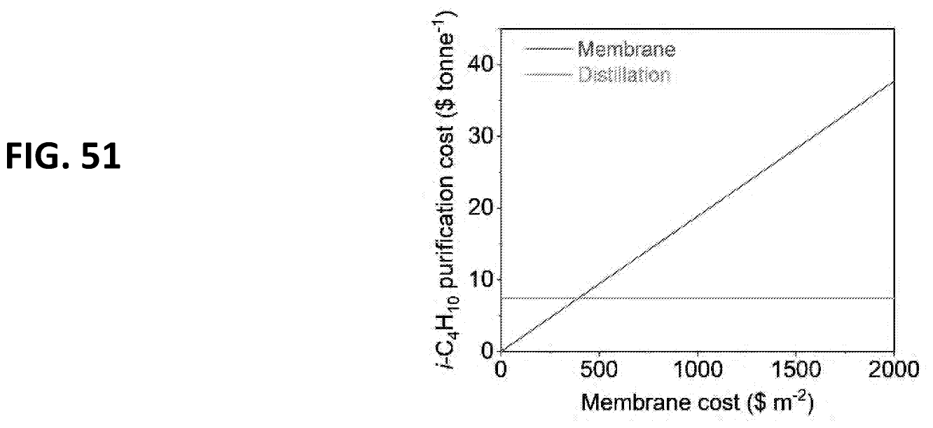

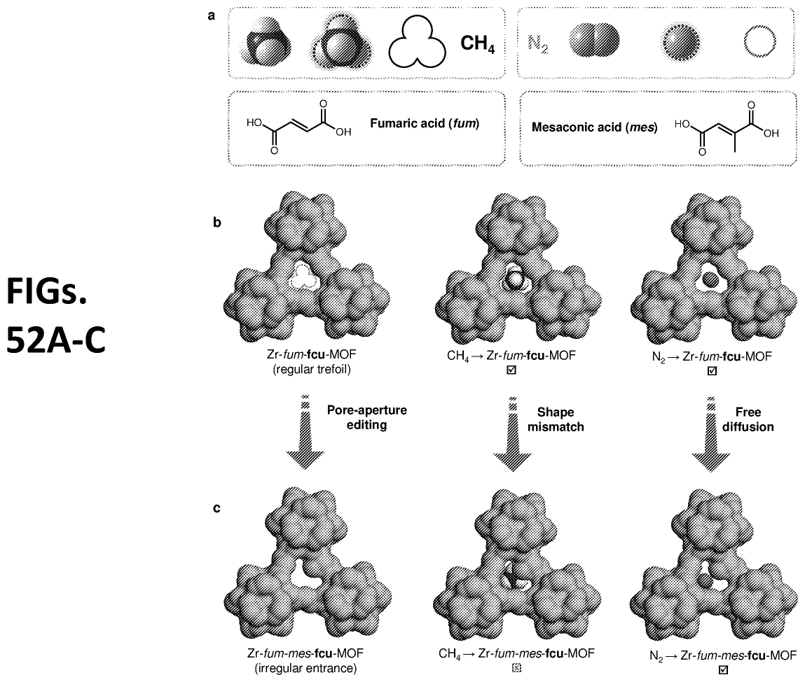

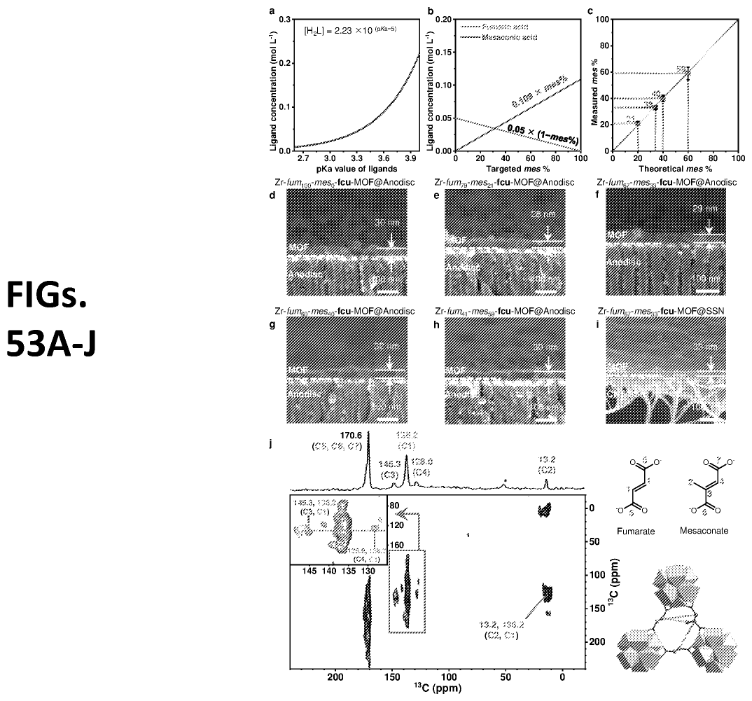

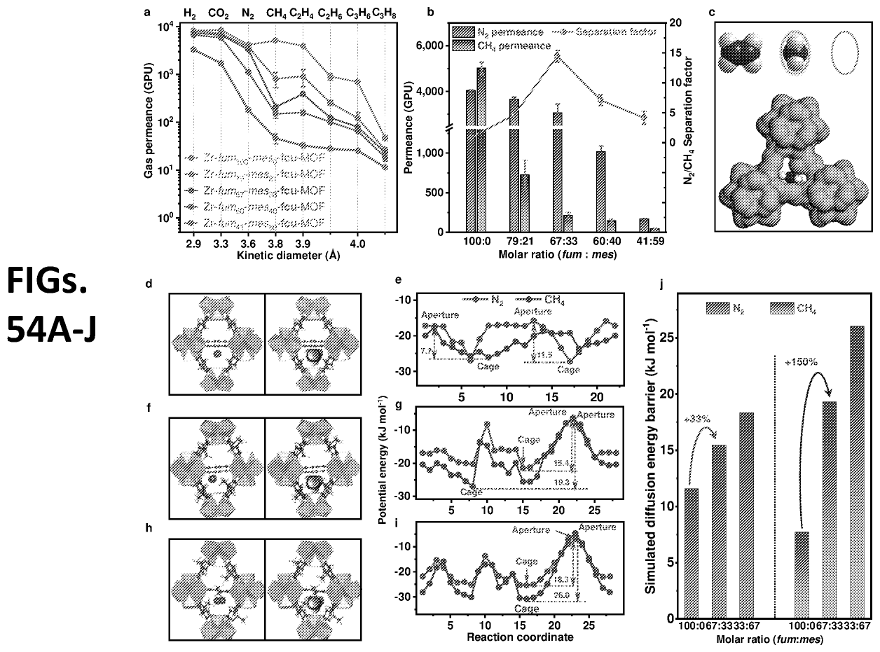

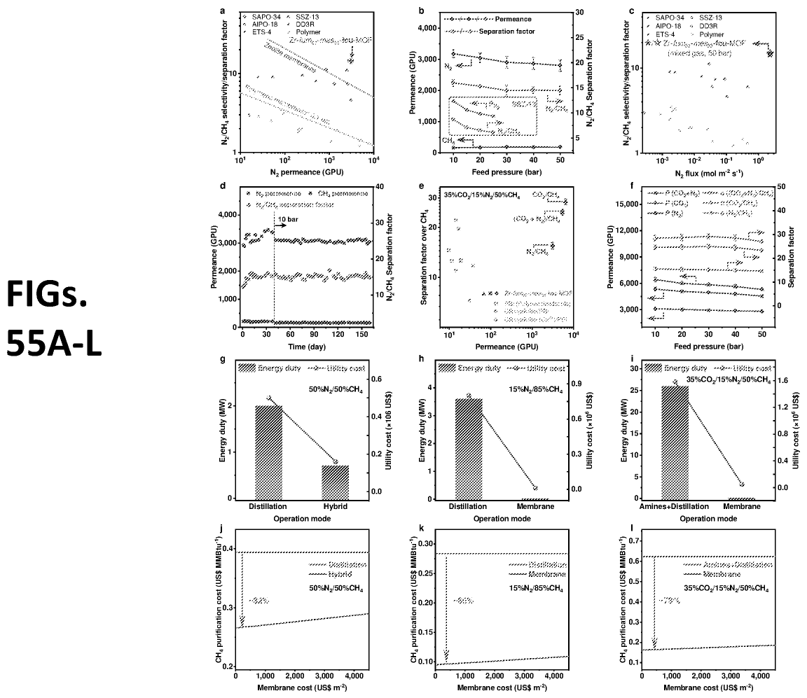

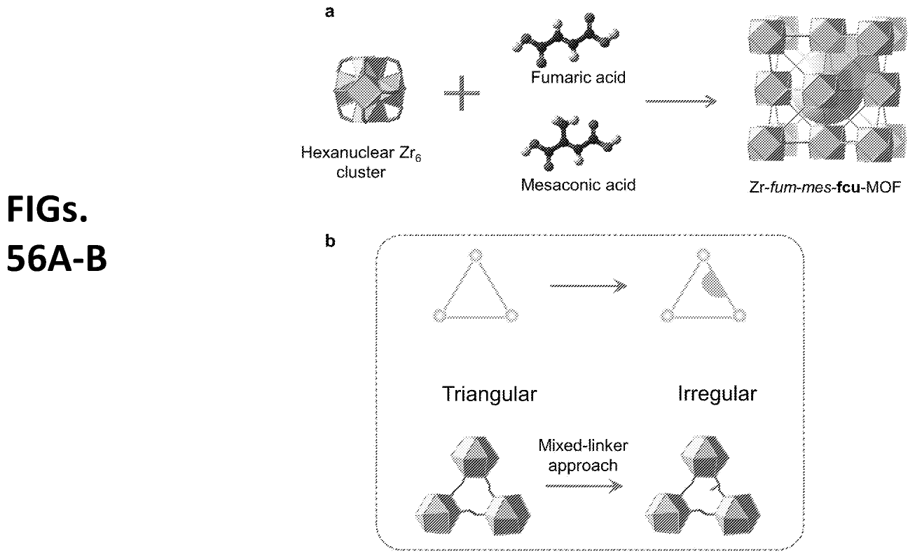

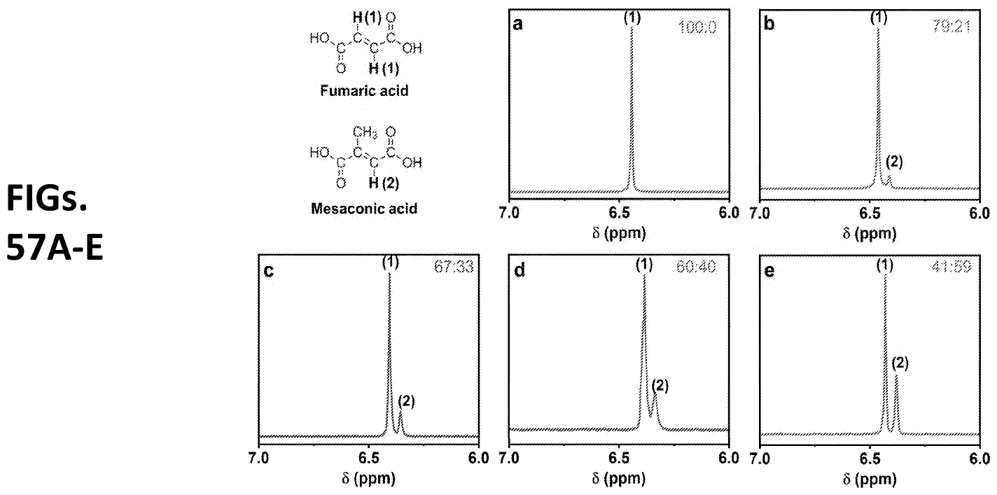

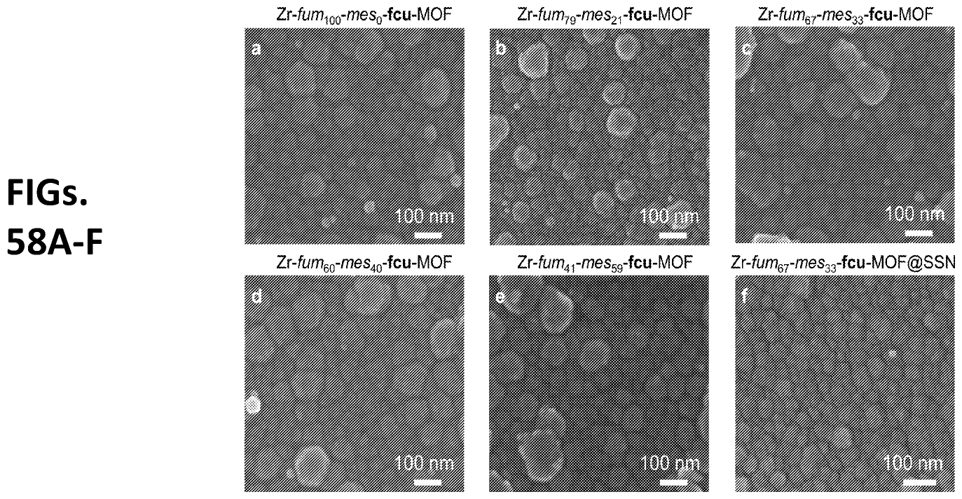

Receptively, the nC₄/iC₄ separation performance of the membrane was analyzed. Y-fum-fcu-MOF membrane offers the prospect to completely replace the typical nC₄/iC₄ distillation column (deisobutanizer), as these systems require only circa 95% isobutane purity for its use in the alkylation process, below the 98.6% isobutane purity of the membrane (for ˜75 selectivity). In order to achieve the desired separation by conventional distillation, a reflux ratio of 6.25 with a condenser duty of 22 MW and a reboiler duty of 27 MW is needed, equivalent to a deisobutanizer equipment cost of 2.8 M$ and utility cost of 1.7 M$ per year. If replaced by Y-fum-fcu-MOF membranes, all these incurring expenses could be saved; no hybrid system is required since the membrane alone provides the desired purity. The purification cost of isobutane using Y-fum-fcu-MOF membranes could be greatly reduced with a membrane breakeven cost of 395 $ m⁻² (FIG. 51). Slightly higher breakeven costs (˜500 $ m⁻²) were reported previously for MFI membranes, highlighting the benefit of the MOF-based membranes.

To address the challenging separation of light-hydrocarbons, the rational combination of reticular chemistry with an electrochemical synthetic approach was successfully demonstrated by constructing continuous/defect-free fcu-MOF membranes with maintained intrinsic molecular-sieving properties. According to the techno-economic analysis, the deployment of the membranes in a hybrid distillation system offers a potential ˜90% savings of energy and 67% savings of costs for the C₃H₆/C₃H₈ separation. The facile and mild membrane fabrication procedure, by virtue of the current-driven assembly, combined with the selected robust fcu-MOFs and the utilized inexpensive supports, offers the prospect for large-scale production, bringing MOF membranes a step closer to practical applications and plausibly contributing to a sustainable energy future.

Preparation of hexanuclear cluster solutions. For [RE₆(μ₃-OH)₈(O₂C—)₁₂] cluster solution: Y(NO₃)₃·6H₂O (572 mg, 1.5 mmol), 2-fluorobenzoic acid (3.33 g, 23.8 mmol), dimethylformamide (DMF, 13.7 mL) and ultrapure water (H₂O, resistivity=18.2 MΩ·cm, 2.3 mL) were combined in a 38 mL scintillation vial, sealed and heated to 115° C. for 60 h and cooled to room temperature. For the [Zr₆O₄(OH)₄(O₂C—)₁₂] cluster solution: ZrOCl₂·8H₂O (230 mg, 0.7 mmol), formic acid (2.7 mL, 71 mmol), DMF (11.3 mL) and H₂O (1.9 mL) were combined in a 38 mL scintillation vial, sealed and left at room temperature for 3 weeks, or heated to 65° C. for 10 h and cooled to room temperature.

Preparation of fcu-MOF membranes by current-driven assembly. Normally two steps are involved during the membrane preparation. The first step is to mix the ligands with the cluster solution to get the mother solution. The second step is to immerge the support into the mother solution and give the external current to promote the growth of crystals on the support surface. The detailed procedures for two systems are described here.

For Y-fcu-MOF membranes: Each kind of ligand with pre-calculated mass was added into the Y₆ cluster solution and sonicated for 1 minute to get homogeneous solution. The porous support with conductive coatings (diameter=22 mm) was immerged into the solution and connected with the working electrode of the potentiostat (as cathode). A current density of 1.5 mA/cm² was applied for 2 h at room temperature, after which the as-synthesized membranes were taken out and rinsed slowly with fresh DMF and DMF/methanol solvent for 2 minutes, respectively. The exact amount of ligands for each Y-fcu-MOF membrane is as follows: Y-naph-fcu-MOF membrane, 1,4-naphthalenedicarboxylic acid (111.1 mg, 0.5138 mmol, 0.032 M, ligand/cluster=2.1:1); Y-fum-fcu-MOF membrane, fumaric acid (164.2 mg, 1.415 mmol, 0.08 M, ligand/cluster=5.6:1); Y-tpa-fcu-MOF membrane, terephthalic acid (513.0 mg, 3.096 mmol, 0.019 M, ligand/cluster=12.9:1); Y-mes-fcu-MOF membrane, mesaconic acid (640.0 mg, 4.910 mmol, 0.31 M, ligand/cluster=20.4:1, 35° C.); Y-aminotpa-fcu-MOF membrane, 2-aminoterephthalic acid (1625 mg. 8.929 mmol, 0.55 M, ligand/cluster=36.6:1).

For Zr-fcu-MOF membranes: Each kind of ligand with pre-calculated mass was added into the Zr₆ cluster solution and sonicated for 1 minute to get homogeneous solution. The porous support with conductive coatings (diameter=22 mm) was immerged into the solution and connected with the working electrode of the potentiostat (as cathode). A current density of 0.26 mA/cm² was applied for 2 h at room temperature, after which the as-synthesized membranes were taken out and rinsed slowly with fresh DMF and DMF/methanol solvent for 2 minutes, respectively. The exact amount of ligands for each Zr-fcu-MOF membrane is as follows: Zr-naph-fcu-MOF membrane, 1,4-naphthalenedicarboxylic acid (41.15 mg, 0.1903 mmol, 0.012 M, ligand/cluster=1.6:1); Zr-fum-fcu-MOF membrane, fumaric acid (60.80 mg, 0.5242 mmol, 0.033 M, ligand/cluster=4.9:1); Zr-tpa-fcu-MOF membrane, terephthalic acid (190.4 mg, 1.146 mmol, 0.072 M, ligand/cluster=9.9:1); Zr-mes-fcu-MOF membrane, mesaconic acid (236.2 mg, 1.817 mmol, 0.11 M, ligand/cluster=15.6:1).

Modification of stainless-steel nets (SSN) by carbon nanotubes (CNT) to narrow the surface pore size. A piece of SSN was dipped in 10% PDMS (Polydimethylsiloxane)/hexane solution to make the surface become hydrophobic. A certain volume of CNT aqueous dispersion (0.1 mg mL⁻¹) was dropped on the top of SSN (˜0.5 mL cm⁻²) and allowed to evaporate in an oven preheated to 65° C. overnight to form the continuous CNT film on the top of SSN. The surface pore size of the modified SSN is around 10 nm. The C₃H₆ permeance is 8435 GPU (2.82×10⁻⁶ mol m⁻² s⁻¹ pa⁻¹) and C₃H₆/C₃H₈ selectivity is 0.9. This means the CNT modified SSN shows no selectivity and extremely low resistance for transportation.

Characterization. PXRD measurements were carried out at room temperature on a PANalytical X'Pert PRO diffractometer or Bruker D8 advance fitted with a solid-state X'celerator detector (45 kV, 40 mA) using Cu Kα (λ=1.5418 Å) radiation. The scan speed and step size of the measurements were 1.0° min⁻¹ and 0.02° in 2θ, respectively. SEM imaged are produced by Zeiss Merlin.

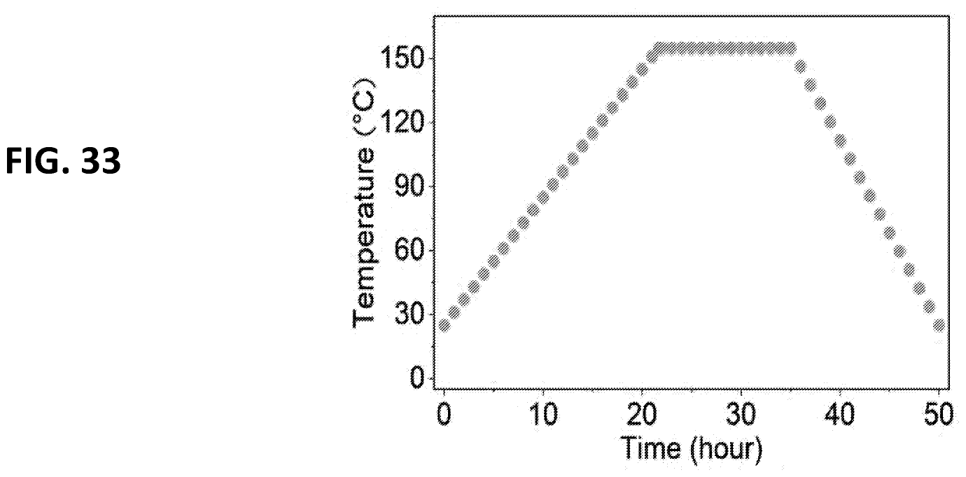

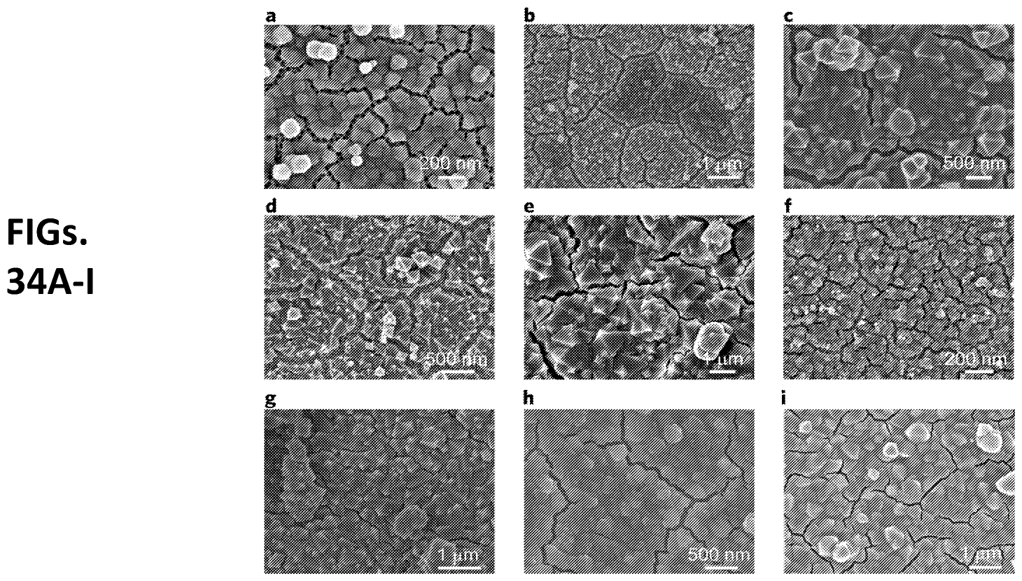

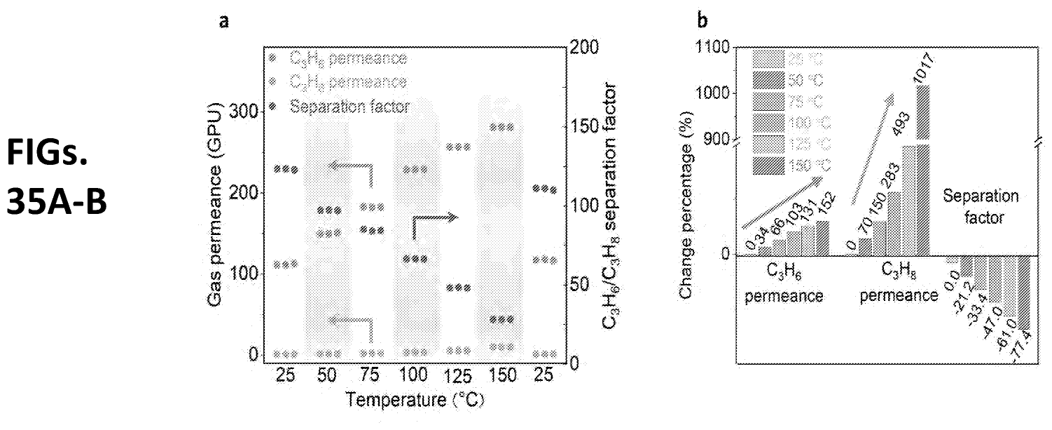

Gas permeation measurement. Wicke-Kallenbach technique was adopted to study the gas permeation properties of the membranes (FIG. 32). Before measurement, each membrane was very carefully activated by on-stream activation process, following the temperature profile shown in FIG. 33. For a single-gas permeation measurement, the prepared MOF membrane was fixed in a module sealed with O-rings. A volumetric flow rate of 50 mL min⁻¹ gas was applied to the feed side of the membrane, and the permeate gas was removed from the permeate side by the sweep gas (Helium, 50 mL min⁻¹). The volumetric flow rates of all the gases were calibrated by ADM flow meter (Agilent). Pressures at the feed side varied from 1 atm to 7 atm and permeate side pressure was maintained at 1 atm. A calibrated gas chromatograph (Varian GC-450) was used to measure the concentration of each gas on the permeate side. Two kinds of columns and detectors are used for gas detection. In general, the column “Select Permanent Gases/CO₂” (Agilent) is used together with the TCD detector for the detection of H₂, CO₂, N₂, and CH₄. The column “CP-Al₂O₃/Na₂SO₄” (Agilent) is used together with the FID detector for the detection of C₃H₆, C₃H₈, nC₄, and iC₄. The membrane permeance, Pᵢ (mol m⁻² s⁻¹ pa⁻¹), is defined as equation (5):

$${P}_{i} = \frac{{N}_{i}}{Δ {P}_{i} \cdot {A}_{i}} \qquad ( 5 )$$

where Nᵢ (mol s⁻¹) is the molar flow rate of component i, ΔPᵢ (Pa) is the transmembrane pressure difference of component i, and A (m²) is the effective membrane area for testing. The ideal selectivity, S_{i/j}, is calculated from the relation between the permeance of component i and component j (equation (6)).

$${S}_{i / j} = \frac{{P}_{i}}{{P}_{j}} \qquad ( 6 )$$

For the mixed gas permeation measurement, the prepared MOF membrane was fixed in a module sealed with O-rings. A 1:1 mixture of gas was applied to the feed side of the membrane, and the permeate gas was removed from the permeate side by the sweep gas (Helium). The feed flow rate was kept constant with a total volumetric flow rate of 50 mL·min⁻¹ (each gas, 25 mL·min⁻¹). Pressures at the feed side varied from 1 atm to 7 atm and permeate side pressure was maintained at 1 atm. A calibrated gas chromatograph (Varian GC-450) was used to measure the concentration of each gas on the permeate side. The separation factor, α_{i,j}, of the gas pairs is defined as the quotient of the molar ratios of the components (i, j) in the permeate side, divided by the quotient of the molar ratios of the components (i, j) in the feed side (equation (7)).

$${α}_{i / j} = \frac{{X}_{i , perm} / {X}_{j , perm}}{{X}_{i , feed} / {X}_{j , feed}} \qquad ( 7 )$$

### Simulation Methodology

Process distillation simulations were carried out with steady-state simulation models developed in Aspen Plus® V8.8 software. The selected property method was Redlich-Kwong-Soave. The distillation column was simulated was simulated using RadFrac model.

For the propylene/propane separation, the number of trays in the column was fixed at 250 with constant pressure. In the stand-alone distillation system (FIG. 45) the feed was introduced to the column in the stage 175. The feed composition is 50% propylene and 50% propane with a total feed rate of 400 mol s⁻¹ and a temperature of 25° C. Feed pressure was set to either 7 or 15 bar. The annual productivity target of the system is 265000 tons year⁻¹ of 99.5% propylene (polymer grade). The reflux rate was optimized to meet these specifications. Condenser and reboiler temperatures were set at 35° C. and 43° C. respectively for the 15 bar feed case study and 6° C. and 17° C. for the 7 bar feed. As a result, water was used as a cooling utility agent in the 15 bar condenser and a mild refrigerant (liquid propane) in the 7 bar condenser.

In the hybrid membrane system (FIG. 46), we introduced before the distillation column a membrane modeled as a standard component separator. The separation was based on the selectivity of the membrane and it was set to 130 (99.23% Propylene in the permeate). The permeate comes out of the membrane at 1 bar and is further compressed to either 7 or 15 bar in an isotropic compressor. Afterwards, compressed permeate is cooled down to 25° C. Retentate comes out at the feed pressure and is fed directly to the column. The number of trays in the column was kept at 250. The permeate was fed to the column in stage 155 and the retentate in stage 232. The reflux rate was optimized again to meet the above productivity specifications. Condenser and reboiler temperatures were kept unchanged. Indeed when working at 15 bar, the feed is in liquid state while for the membrane we need to preheat to 50° C. in order to reach vapor state. The energy requirements to heat this feed from 25 to 50° C. were considered as well in the energy calculations.

For the n-butane/isobutane separation, the number of trays in the column was fixed at 75 with a constant pressure. The feed was introduced to the column in the stage 35. The feed composition is 50% n-butane and 50% isobutane with a total feed rate of 400 mol s⁻¹ and a temperature of 25° C. Feed pressure was set to 7 bar. The annual productivity target of the system is 265000 tonnes year⁻¹ of 95% isobutane. The reflux rate was optimized to meet these specifications and set to 6.25. Condenser and reboiler temperatures were set at 51° C. and 63° C., respectively with water as a cooling agent.

Economic analysis was carried out with the Economics Solver extension of Aspen Plus. The distillation columns were mapped with trays of 0.4-meter height per tray. Cooling water cost was estimated in 2.12×10⁻⁷ $ per Joule, steam in 1.9×10⁻⁶ $ per Joule, refrigerant in 2.74×10⁻⁶ $ per Joule and electricity in 0.075 $ per KW. These values are the standard ones provided by Aspen Plus. The calculation of equipment cost estimation consists of the sum of the installed distillation column, compressor and heat exchanger costs. The calculation of utility cost consists of a sum of electricity, steam, water and refrigerant costs. The calculation of total energy duty for the distillation column consists of the sum of the condenser, reboiler and heat exchanger duties (in the hybrid system). For the calculation of the propylene/isobutane purification costs the annual plant costs were estimated as the sum of the plant operating costs (labor plus maintenance and utilities costs) and the annualized CAPEX, considering a total plant lifetime of 20 years and a straight-line depreciation method (equation (8)). Labor and maintenance costs were estimated with the Economics Solver extension of Aspen Plus using the US system database. In the hybrid system the membrane cost was varied between 5 and 5000 $ per m² and added to the CAPEX with a 10 years lifetime as base scenario (equation (9)). All replacement, disposal and construction costs related to the membrane were considered to be included in the final membrane cost. The total annual plant cost was then divided by the total propylene/isobutane production to estimate the respective purification costs.

$${AnnualCost}_{singlesystem} = Labor + Maintenance + Utilities + \frac{C A P E X}{20} \qquad ( 8 )$$

$${AnnualCost}_{hybridsystem} = Labor + Maintenance + Utilities + \frac{C A P E X}{20} + \frac{Membrane}{10} \qquad ( 9 )$$

Natural gas contributes to at least a quarter of the global energy supply, and this proportion is expected to exceed that of coal by ˜2032. This growth presents challenges to conventional technologies for natural gas purification, because natural gas reservoirs are contaminated with N₂ and CO₂. Indeed, approximately 50% of the world's volume of natural gas reserves, known as sub-quality reservoirs, exceed the maximum 4% N₂ pipeline specification, necessitating the exploration of energy- and cost-efficient technologies for N₂/CH₄ separation.

In contrast to the diverse routes for CO₂ capture, e.g., liquid-based absorbers, solid-state adsorbents and membranes, for N₂ removal at the plant scale, cryogenic distillation is currently the only available technology. Despite either N₂-selective membranes or CH₄-selective membranes can discriminate N₂ from CH₄, N₂-selective membranes are preferred because CH₄ is rejected to the retentate at high pressures, saving the significant cost of recompression. However, due to the minor size difference, ideal N₂/CH₄ selectivities, even for state-of-the-art polymeric membranes, remain below 3. Zeolite membranes with narrow pore-apertures (˜3.8 Å), e.g. SSZ-13, SAPO-34, AlPO-18, and ETS-4, could perform better with some N₂/CH₄ selectivities above 10⁸. This however comes at the price of low productivities due to the small pore-apertures, and a trade-off behavior between the permeance and selectivity also exists.

By contrast, the molecular shape disparity between N₂ and CH₄ is more significant because N₂ is linear, while CH₄ is tetrahedral (FIG. 52A). Side views of these two molecules reveal a trefoil-shaped profile for CH₄ and circular circumference for N₂ (FIG. 52A). Metal-organic frameworks (MOFs) present a highly tunable platform for structural design, allowing the precise editing of pore-aperture shape and size. Among MOFs, Zr-fum-fcu-MOF, which is assembled from a hexanuclear cluster [Zr₆O₄(OH)₄(O₂C—)₁₂] and a ditopic linker fumarate (fum) with face-centered cubic (fcu) topology, presents the desired narrow pore-apertures with the special trefoil shape (FIG. 52B). Typically, a CH₄ tetrahedron is expected to penetrate by aligning its edges parallel to the triangular entrance borders in order to precisely fit well with the trefoil-shaped pore-apertures (FIG. 52B). In principle, such a penetration of CH₄ could be blocked by altering the pore apertures so as to disrupt the original match for tetrahedral CH₄. The remaining space would be still wide enough for linear N₂ to diffuse (FIG. 52C).

The shape-irregularity is induced by partially substituting the fumarate edge of the triangular windows with 2-methylfumarate, namely mesaconate (mes) encompassing protruding methyl groups (FIGS. 56A-B). Our experimental explorations reveal the optimal molar ratio of fum to mes for N₂/CH₄ separation is 2:1, e.g. Zr-fum₆₇-mes₃₃-fcu-MOF, corresponding to two fumarates and one mesaconate encompassing circumference of the triangular window.

### Membrane Fabrication

The electrochemical synthesis of MOF membranes using water as a solvent is disclosed, where external current is applied to deprotonate the ligands. The optimal conditions for pure fumarate Zr-fum-fcu-MOF membranes was examined, and a defect-free layer of 30-nm thickness was obtained after 2 hours with a current density of 0.05 mA·cm⁻², using a preformed [Zr₆O₄(OH)₄(O₂C—)₁₂] cluster concentration of ˜8.5 mM and fumaric acid concentration of ˜50 mM. This successful practice implies the achievement of an ideal concentration of the deprotonated ligand ([L²⁻]_{ideal}) during the reaction, which is critical to the formation of continuous MOF layers. The required ligand concentration ([H₂L]) correlated with its pKa during the fabrication of fcu-MOF membranes (FIG. 53A): [H₂L]_{Zr-fcu-MOF,a.q.}=2.23×10^{(pKa-5)}. However, to construct mixed-linker Zr-fum₍₁₀₀₋ₓ₎-mesₓ-fcu-MOF membranes (x is mes molar percentage), two prerequisites should be considered: the maintenance of a total concentration of [L²⁻]_{ideal} for the deprotonated ligands and controllable ligand incorporation percentages. Hence, the input concentration of each ligand can be calculated based on its targeted molar percentage: [H₂fum]_{mixed}=(100−x) %×0.05; [H₂mes]_{mixed}=x %×0.109 (FIG. 53B).

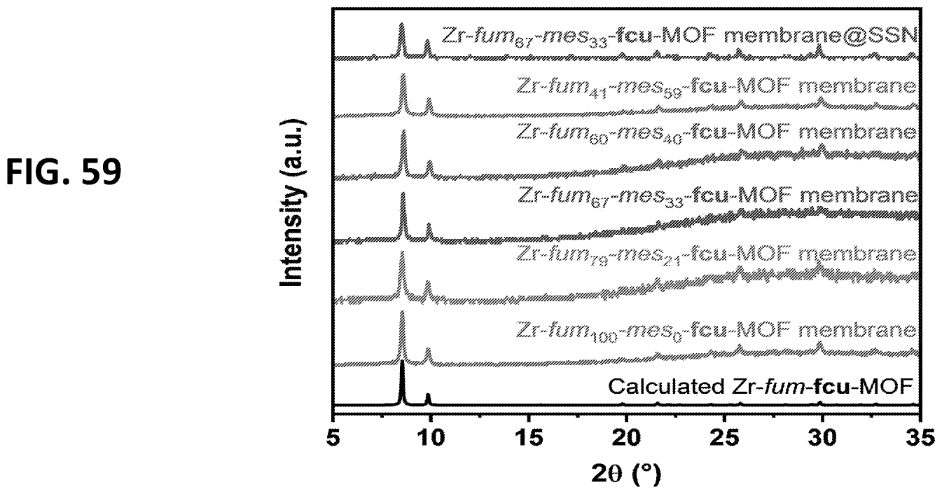

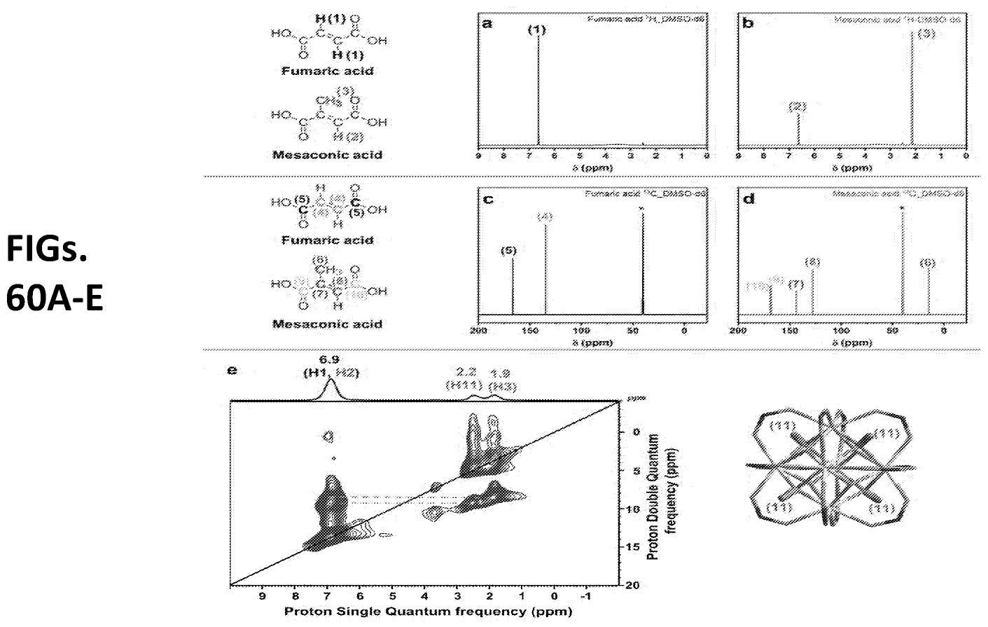

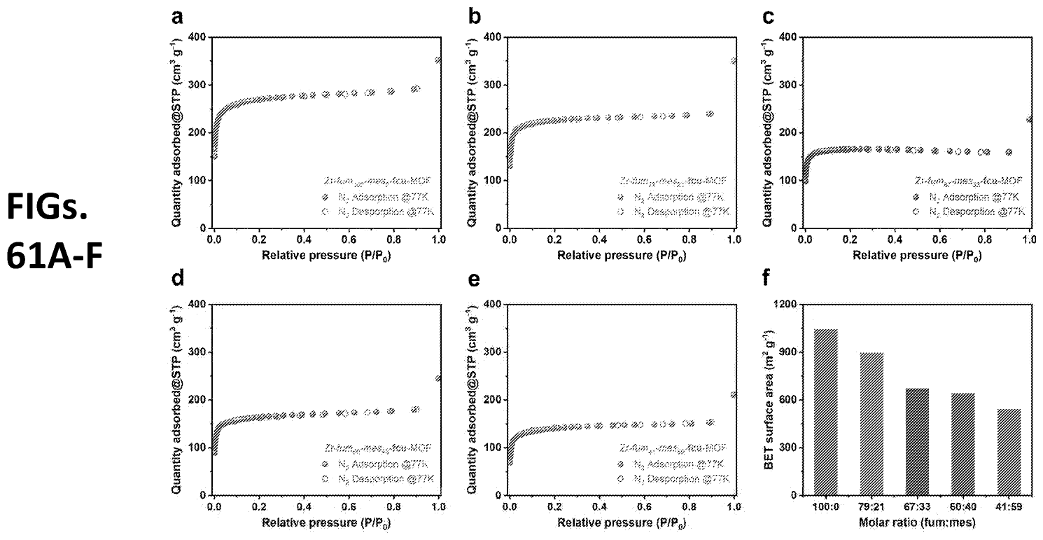

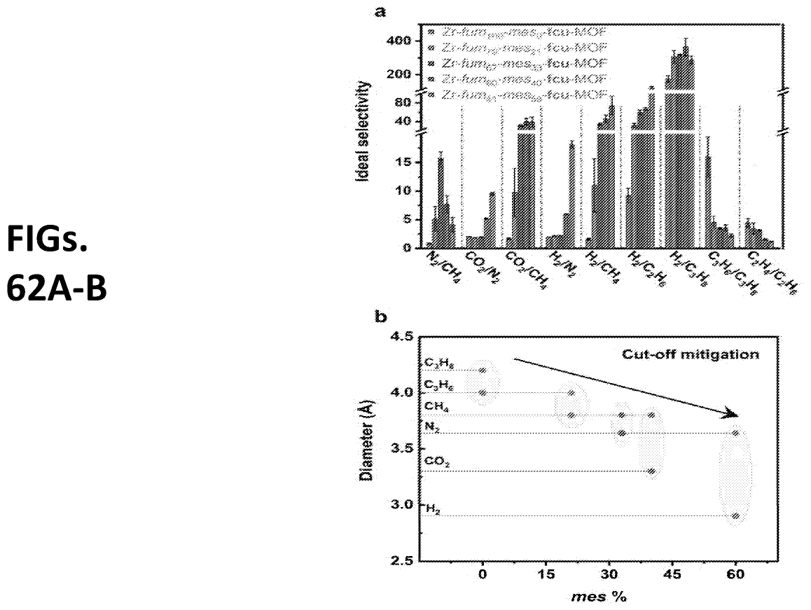

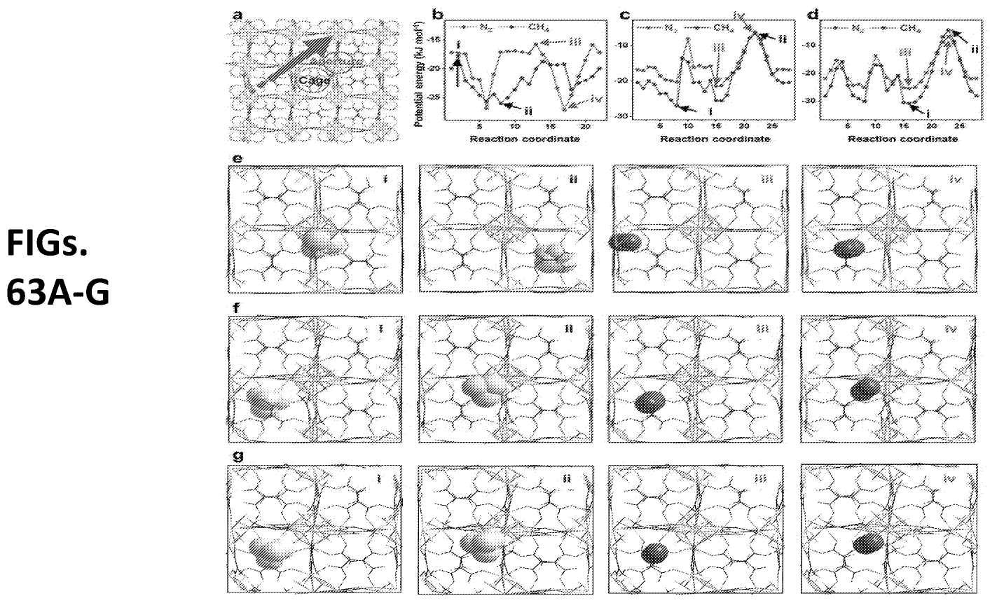

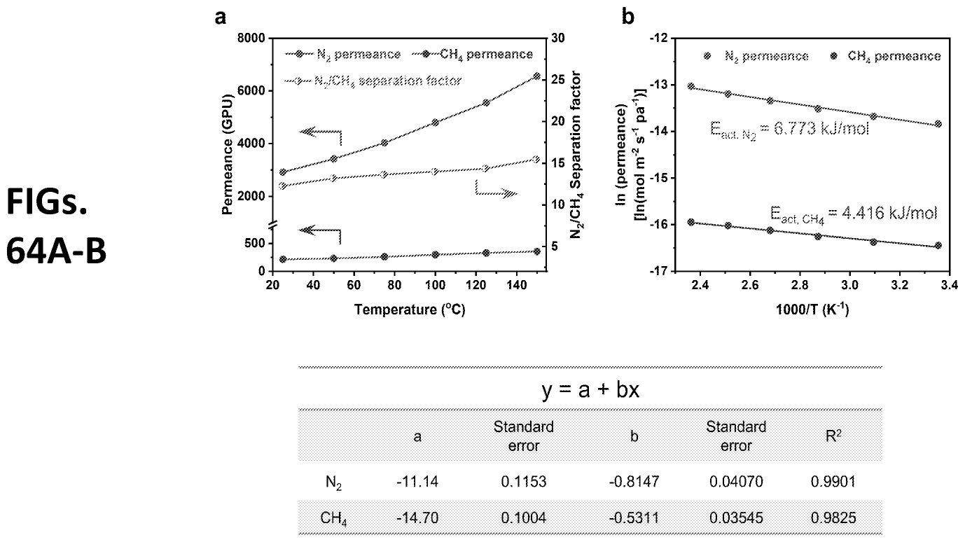

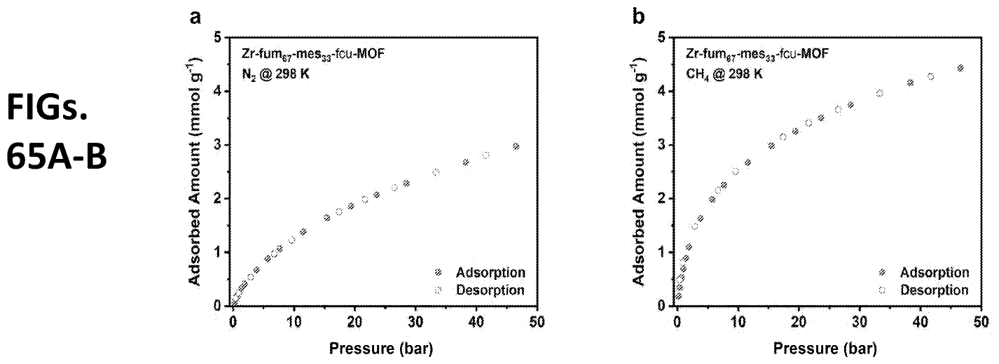

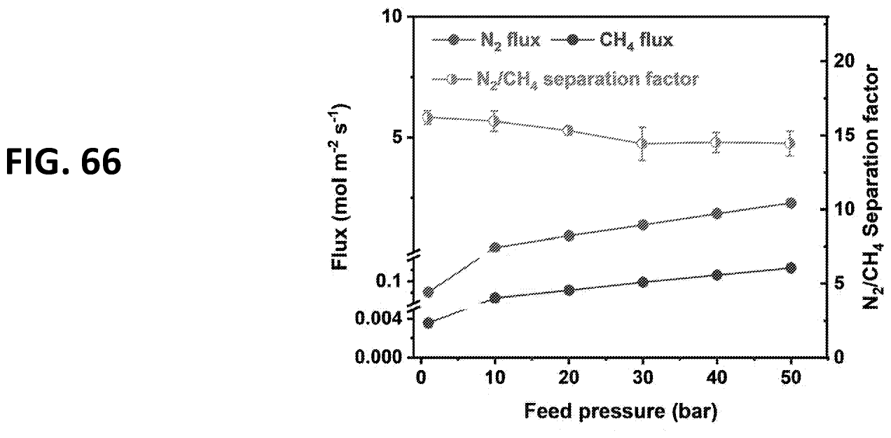

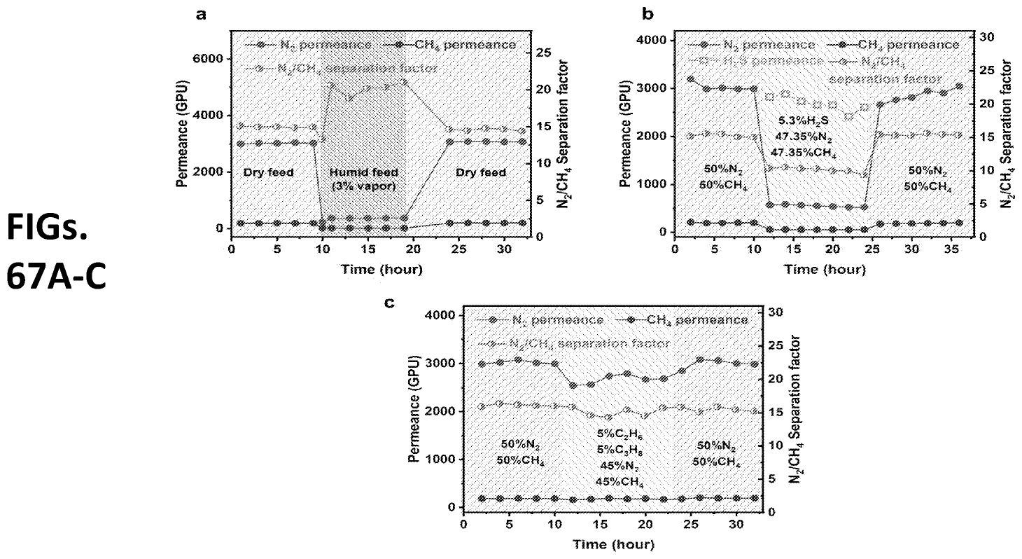

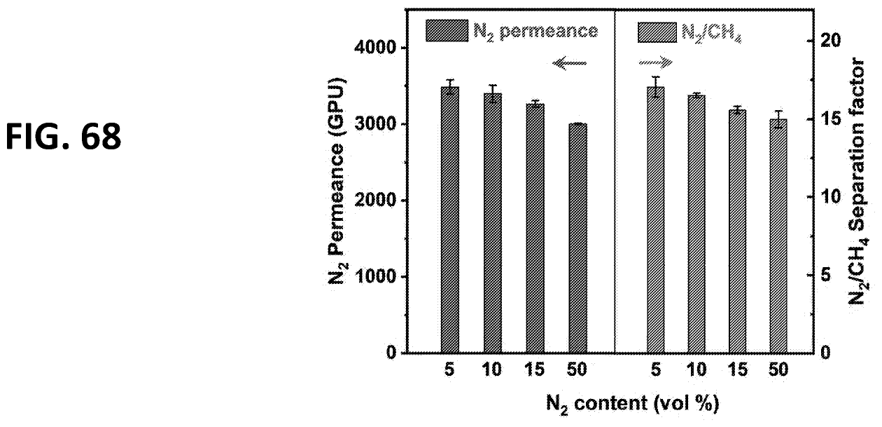

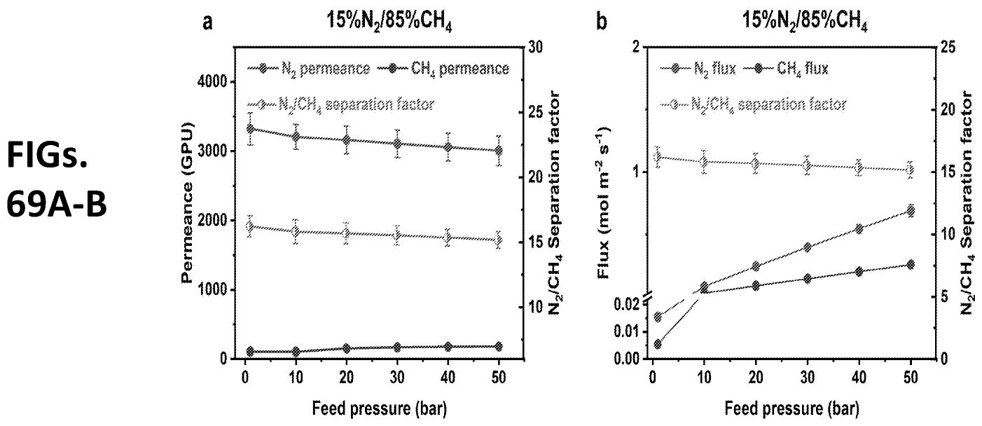

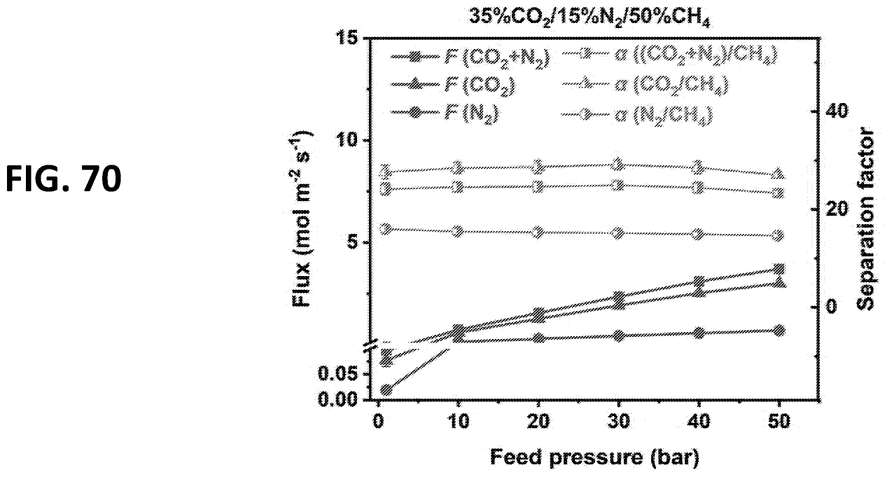

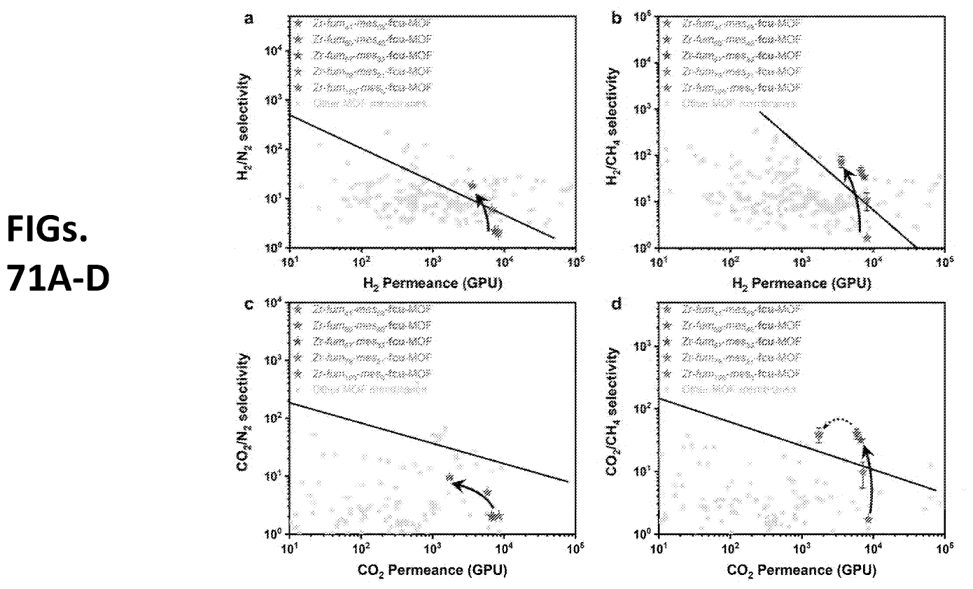

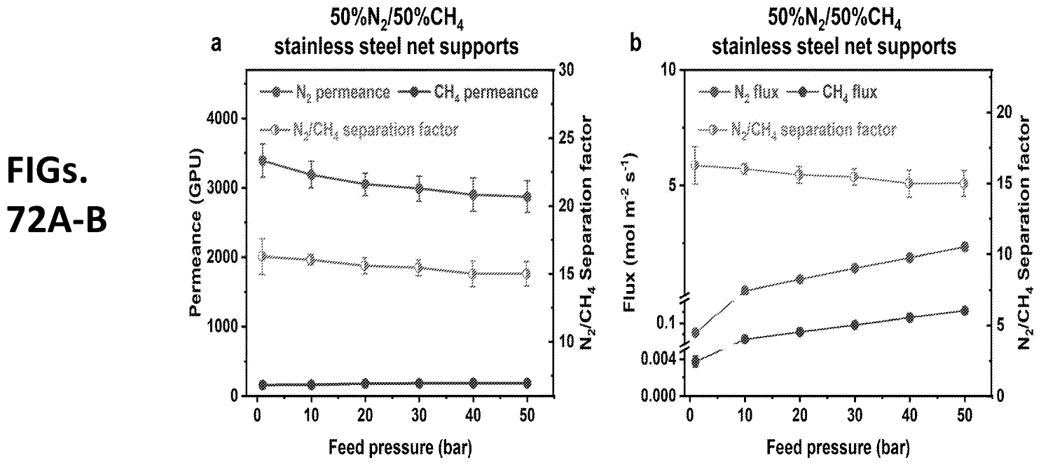

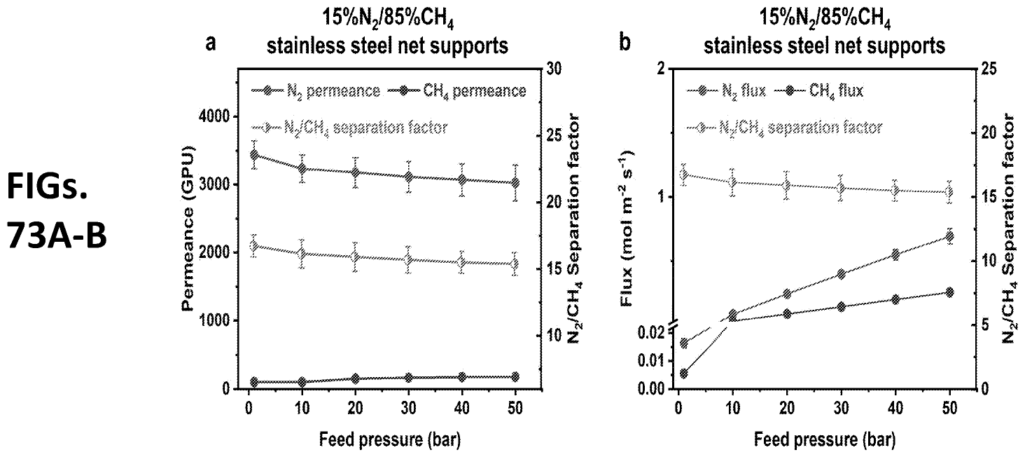

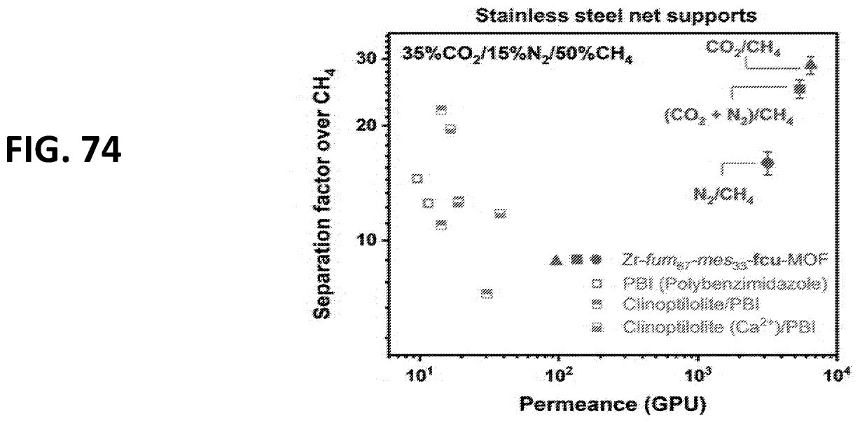

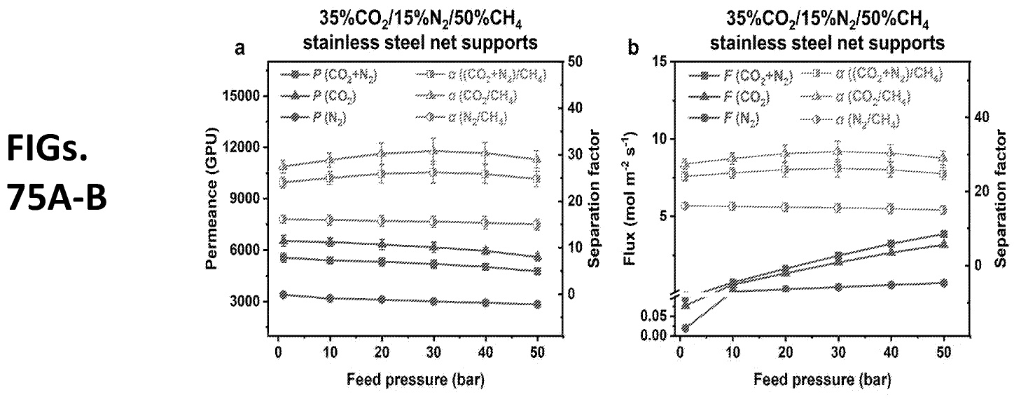

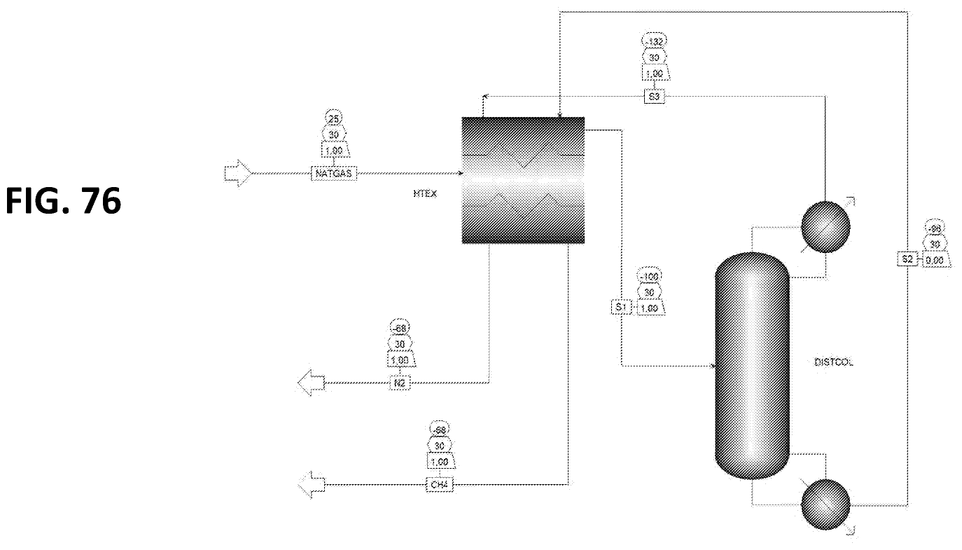

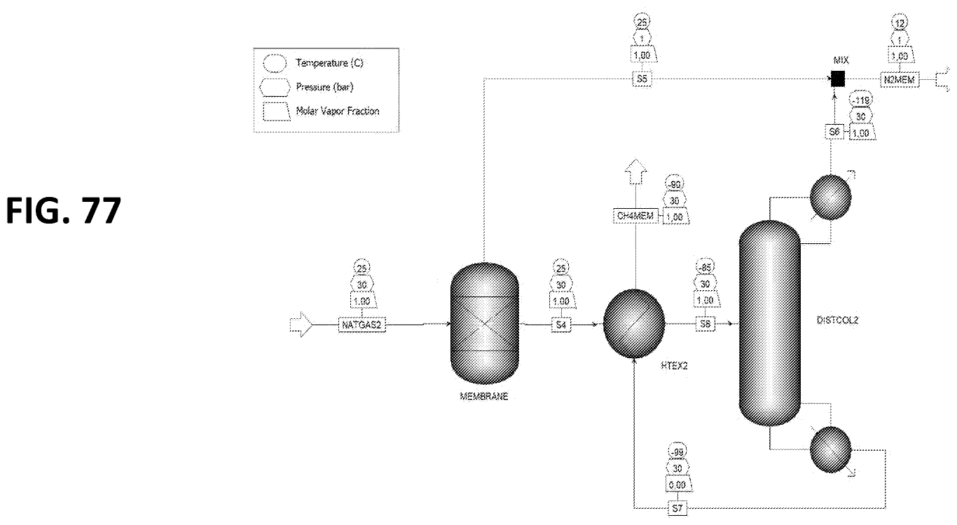

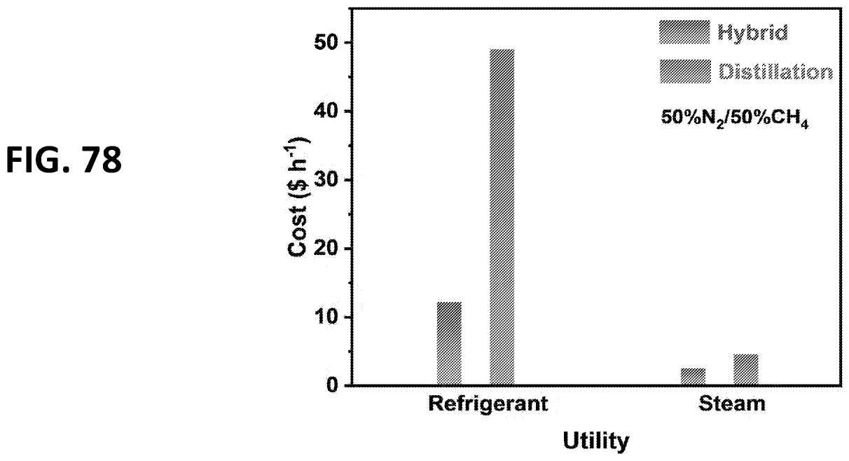

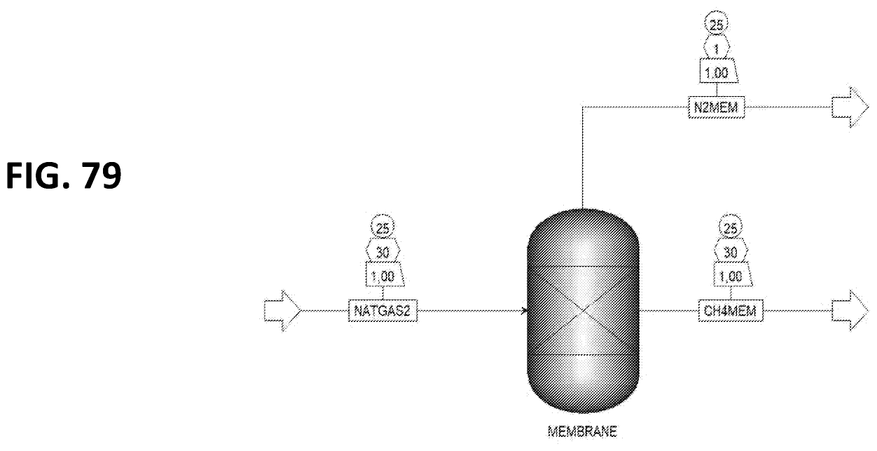

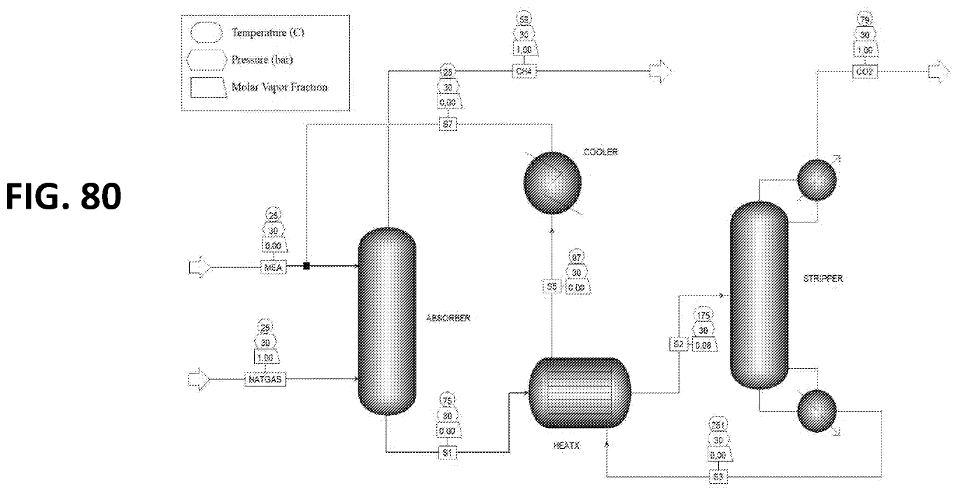

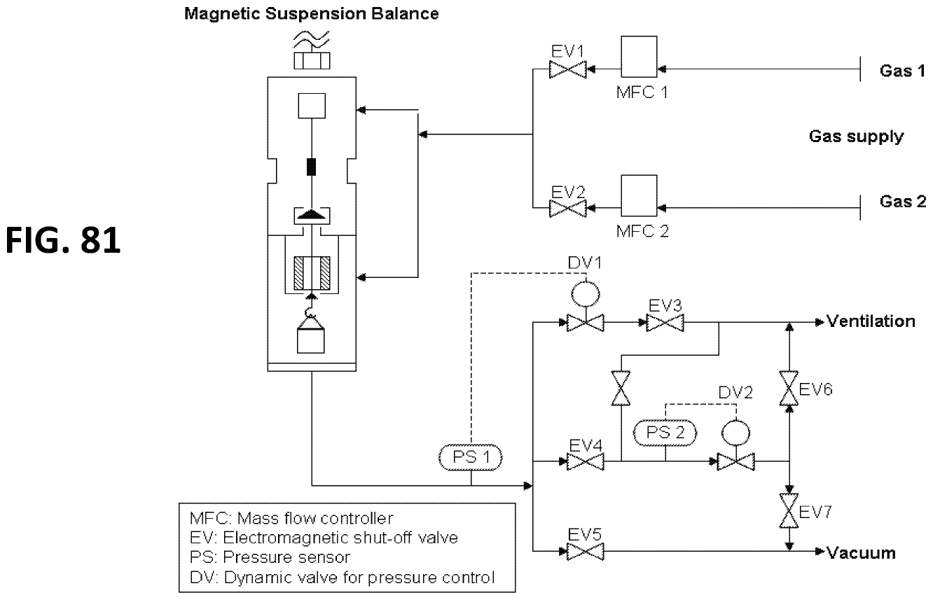

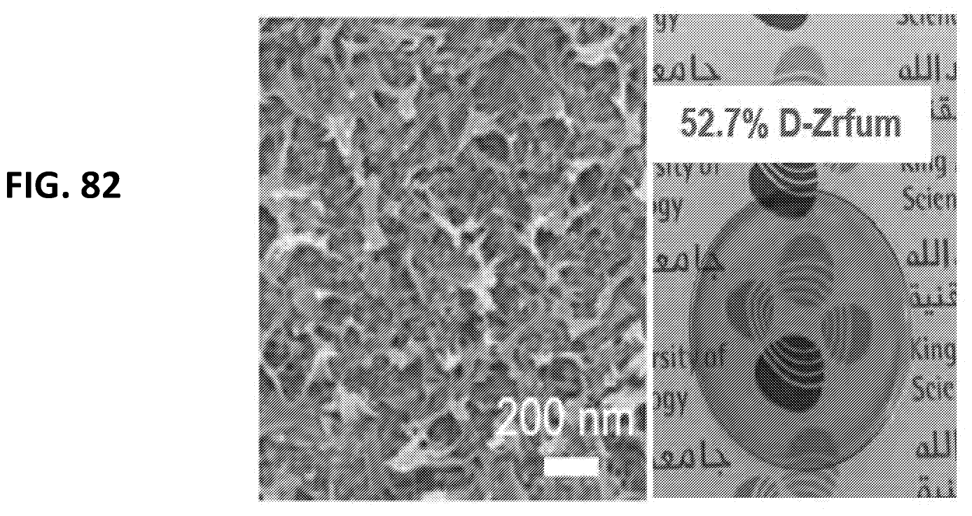

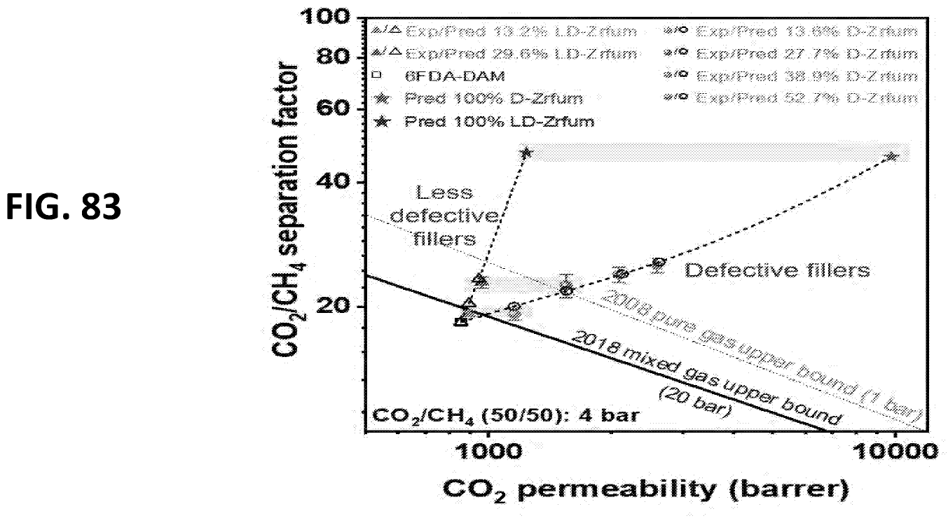

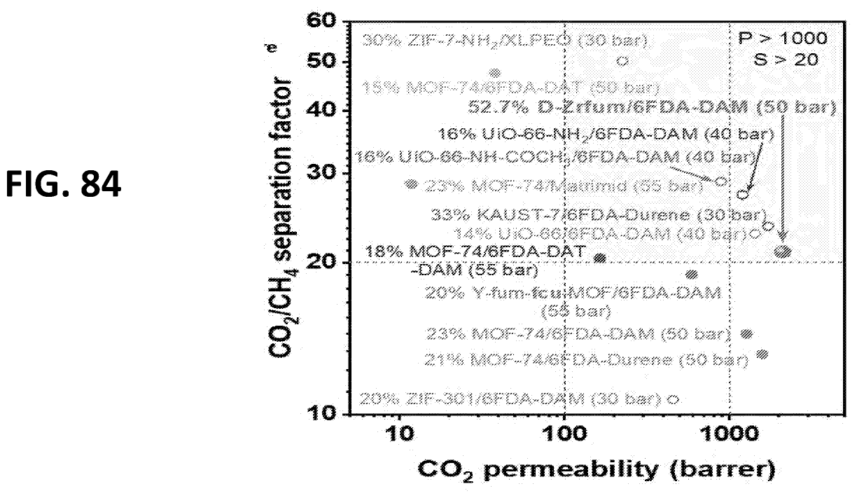

Four different mes percentages were targeted, namely 20%, 33%, 40%, and 60%, and prepared the corresponding membranes. As determined by ¹H nuclear magnetic resonance (NMR) of acid-digested samples, the targeted mes percentages agree well with experimental results of 21%, 33%, 40% and 59% (FIG. 53C, FIGS. 57A-E). All membranes supported on Anodisc display well-intergrown layers, similar crystal morphology, and ultrathin thickness of ˜30 nm (only ˜17 unit cells; FIGS. 52D-H; FIGS. 58A-F). The phase purity, confirmed by X-ray diffraction (XRD), matches well with the parent fcu-MOF structures (FIG. 59). Some floating particles might deposit loosely on the top of continuous layers or inside Anodisc channels. Nevertheless, those particles can be easily cleaned by using compressed air flow, indicating they cannot contribute to separation. The ultrathin selective layer is proved quite homogeneous by the large-area cross-section images and element distributions. The XRD patterns of membranes after removing the floating particles still match with those of simulated structures (FIGS. 60-64). Additionally, as a proof-of-concept to reduce membrane cost, the same synthesis of Zr-fum₆₇-mes₃₃-fcu-MOF membranes on inexpensive support of stainless steel nets (SSN) modified by carbon nanotubes was performed, exhibiting a similar layer thickness and intactness (FIG. 53I; FIGS. 58A-F, 59).

The ligand distribution in the resulting mixed-linker structure is critical for realizing the targeted pore-aperture editing, since the fumarate and mesaconate linkers are required to co-locate in exactly one triangular window so as to transform the trefoil-shaped pore aperture into desired irregular entrance. Two-dimensional (2D) magic-angle spinning solid-state NMR (ssNMR) measurements were applied to the Zr-fum₆₇-mes₃₃-fcu-MOF, because the atoms from the two linkers are expected to provide correlation signals when they are co-located within a single window (FIG. 65). The 2D ¹³C-¹³C correlation spectra using proton-driven spin diffusion was acquired by phase-alternated recoupling irradiation schemes (FIG. 53J). The correlation between the 13.2 and 136.2 ppm peaks can be clearly observed; these peaks originate from the carbon atom of the methyl group in mesaconate and the double-bond carbon atoms in fumarate, respectively (FIG. 53J). The strong correlation indicates the two linkers are in close physical proximity, namely co-locating within one window. Moreover, the double-bond carbon atoms from both linkers also gave detectable correlations at (128.0 ppm, 136.2 ppm) and (145.3 ppm, 136.2 ppm), again indicating that pore-aperture editing was indeed realized. Ultimately, because the molar ratio of fum/mes for Zr-fum₆₇-mes₃₃-fcu-MOF membranes is 2:1, the obtained triangular windows are circumscribed by one mesaconate and two fumarate edges (FIG. 53J).

### N₂ Removal and Natural Gas Purification

The single-gas permeation of membranes with different mes loadings was measured. All the gas permeances decreased as the mes loading increased, owing to the associated narrowed pore-aperture sizes and thus increased transport resistance (FIG. 54A; FIG. 66, Table 12).

Table 12. Single-gas permeances of the Zr-fum₍₁₀₀₋ₓ₎-mesₓ-fcu-MOF membranes. At least three independent membranes for each percentage are prepared and tested.

TABLE 12
Single-gas permeances of the Zr-fum₍₁₀₀₋ₓ₎-mesₓ-fcu-MOF membranes. At least
three independent membranes for each percentage are prepared and tested.

| | | Permeance (GPU) | | | | | | | |
|---|---|---|---|---|---|---|---|---|---|
| Membrane | Number | H₂ | CO₂ | N₂ | CH₄ | C₂H₄ | C₂H₆ | C₃H₆ | C₃H₈ |
| Zr-fum₁₀₀- | M1 | 8352 | 8628 | 4235 | 4746 | 3683 | 858.3 | 711.9 | 45.35 |
| mes₀-fcu- | M2 | 7955 | 8369 | 4026 | 5422 | 4123 | 781.3 | 683.9 | 42.69 |
| MOF | M3 | 8259 | 8539 | 4192 | 5081 | 4038 | 1059 | 837.1 | 54.12 |
| | Average | 8189 | 8512 | 4151 | 5083 | 3948 | 899.6 | 697.9 | 47.39 |
| | Standard | 207.7 | 131.7 | 110.2 | 338.0 | 233.3 | 143.5 | 19.83 | 5.982 |
| | deviation | | | | | | | | |
| Zr-fum₇₉- | M4 | 8257 | 7432 | 3871 | 508.3 | 572.1 | 226.4 | 92.82 | 23.62 |
| mes₂₁-fcu- | M5 | 7999 | 6889 | 3620 | 857.6 | 877.4 | 258.2 | 109.2 | 27.85 |
| MOF | M6 | 8033 | 7082 | 3857 | 1073 | 1290 | 288.0 | 164.3 | 28.50 |
| | Average | 8096 | 7134 | 3783 | 812.9 | 913.2 | 257.5 | 122.1 | 26.66 |
| | Standard | 140.2 | 275.3 | 140.8 | 284.9 | 360.4 | 30.80 | 37.43 | 2.648 |
| | deviation | | | | | | | | |
| Zr-fum₆₇- | M7 | 7217 | 6563 | 3227 | 222.1 | 398.7 | 123.1 | 81.01 | 22.51 |
| mes₃₃-fcu- | M8 | 7405 | 6710 | 3331 | 202.6 | 360.1 | 113.9 | 77.14 | 23.07 |
| MOF | M9 | 7470 | 6776 | 3426 | 209.7 | 410.8 | 134.7 | 82.31 | 23.52 |
| | Average | 7364 | 6683 | 3328 | 211.5 | 389.9 | 123.9 | 80.15 | 23.03 |
| | Standard | 131.4 | 108.9 | 99.36 | 9.890 | 26.49 | 10.43 | 2.694 | 0.5084 |
| | deviation | | | | | | | | |
| Zr-fum₆₀- | M10 | 6531 | 5654 | 1101 | 117.2 | 138.5 | 93.02 | 62.07 | 16.71 |
| mes₄₀-fcu- | M11 | 6811 | 5922 | 1145 | 166.1 | 167.7 | 102.9 | 65.67 | 22.44 |
| MOF | M12 | 6835 | 6011 | 1134 | 167.5 | 173.2 | 105.8 | 68.73 | 17.10 |
| | Average | 6726 | 5862 | 1126 | 150.3 | 159.8 | 100.6 | 65.49 | 18.75 |
| | Standard | 169.0 | 185.9 | 23.05 | 28.63 | 18.65 | 6.694 | 3.333 | 3.201 |
| | deviation | | | | | | | | |
| Zr-fum₄₁- | M13 | 3570 | 1883 | 195.2 | 51.80 | 32.43 | 29.82 | 26.40 | 11.89 |
| mes₅₉-fcu- | M14 | 3241 | 1715 | 185.7 | 33.81 | 29.53 | 25.36 | 27.10 | 10.69 |
| MOF | M15 | 3053 | 1587 | 163.4 | 52.61 | 36.45 | 28.61 | 23.42 | 11.71 |
| | Average | 3288 | 1728 | 181.4 | 46.07 | 32.80 | 27.93 | 25.64 | 11.43 |
| | Standard | 262.1 | 148.6 | 16.35 | 10.63 | 3.478 | 2.308 | 1.950 | 0.6459 |
| | deviation | | | | | | | | |

The permeance cutoff gradually moved toward smaller gas pairs as revealed by changes in ideal selectivities (FIGS. 67A-C). Subsequently, all membranes were evaluated for N₂/CH₄ mixed-gas separation, among which Zr-fum₆₇-mes₃₃-fcu-MOF membranes with fum/mes ratios of 2:1 offered the highest N₂/CH₄ selectivity of 15 and an average N₂ permeance of 3057 GPU (FIG. 54B; Table 13).

TABLE 13
N₂/CH₄ mixed-gas separation performance of the
Zr-fum₍₁₀₀₋ₓ₎-mesₓ-fcu-MOF membranes. At least three independent
membranes for each percentage are prepared and tested.

| | | N₂ | CH₄ | N₂/CH₄ |
|---|---|---|---|---|
| | | permeance | permeance | separation |
| Membrane | Number | (GPU) | (GPU) | factor |
| Zr-fum₁₀₀- | M1 | 4067 | 4696 | 0.8716 |
| mes₀-fcu-MOF | M2 | 3988 | 5359 | 0.7544 |
| | M3 | 4032 | 5000 | 0.8143 |
| | Average | 4029 | 5018 | 0.8134 |
| | Standard deviation | 39.65 | 331.8 | 0.05862 |
| Zr-fum₇₉- | M4 | 3745 | 462.3 | 5.401 |
| mes₂₁-fcu- | M5 | 3535 | 807.6 | 4.393 |
| MOF | M6 | 3696 | 897.8 | 3.990 |
| | Average | 3659 | 722.6 | 4.594 |
| | Standard deviation | 109.9 | 229.9 | 0.7272 |
| Zr-fum₆₇- | M7 | 2894 | 222.1 | 12.63 |
| mes₃₃-fcu- | M8 | 3095 | 199.3 | 15.01 |
| MOF | M9 | 3159 | 199.4 | 15.30 |
| | M16 | 3826 | 293.8 | 13.72 |
| | M17 | 2739 | 182.8 | 14.54 |
| | M18 | 2632 | 166.1 | 15.40 |
| | Average | 3058 | 210.6 | 14.43 |
| | Standard deviation | 426.9 | 44.86 | 1.077 |
| Zr-fum₆₀- | M10 | 942.8 | 112.9 | 8.351 |
| mes₄₀-fcu- | M11 | 979.3 | 154.1 | 6.291 |
| MOF | M12 | 1119 | 165.7 | 6.670 |
| | Average | 1014 | 144.2489 | 7.104 |
| | Standard deviation | 92.80 | 27.74 | 1.096 |
| Zr-fum₄₁- | M13 | 170.1 | 44.38 | 3.834 |
| mes₅₉-fcu- | M14 | 168.7 | 29.82 | 5.597 |
| MOF | M15 | 149.0 | 49.13 | 3.028 |
| | Average | 162.6 | 41.11 | 4.153 |
| | Standard deviation | 11.83 | 10.06 | 1.314 |

For the parent Zr-fum₁₀₀-meso-fcu-MOF membranes, both N₂ and CH₄ could freely permeate, showing selectivities close to those governed by Knudsen diffusion. Steadily increasing the proportion of mesaconate led to a drastic decrease in CH₄ permeance, and a slight decrease in N₂ permeance when mes %≤33%, thus enhancing the N₂/CH₄ selectivity (FIG. 54B). The enhanced separation is mainly attributed to the pore-aperture irregularity and its mismatch with CH₄ tetrahedron rather than size exclusion. This is because ethylene (C₂H₄) molecule with a larger kinetic diameter than that of CH₄ but a pseudo-linear shape showed higher permeance than CH₄ for Zr-fum₆₇-mes₃₃-fcu-MOF membranes (FIG. 54A). The separation driven by kinetic diameter difference would favor the diffusion of smaller CH₄ molecules, while configuration-mismatch favors the faster diffusion of pseudo-linear C₂H₄ (FIG. 54C). However, further increase in mes %, e.g. beyond 33%, cannot afford higher selectivity; instead, selectivity decreased. Apparently, when the fum/mes ratio is higher than 2:1, more than one mesaconate might be present in some triangular windows, leading to a significant narrowing of pore apertures and a decrease in N₂ permeance (FIG. 54B). Consequently, a Zr-fum₆₇-mes₃₃-fcu-MOF membrane composition represents a membrane that optimally performs the mismatch-induced separation with both high permeance and selectivity.

Molecular simulations revealed, after replacing one fumarate by mesaconate in the triangular window, the diffusion energy barrier for CH₄ increased by more than 150%, whereas that for N₂ increased by only 33%, leading to enhanced N₂/CH₄ selectivity (FIGS. 54D-J; FIG. 68, Table 14).

TABLE 14
Lattice parameters of the DFT-optimized unit cells
for the three Zr-fum-mes-fcu-MOFs.

| fum:mes | a/Å | b/Å | c/Å | α/° | β/° | γ/° | Volume/Å³ |
|---|---|---|---|---|---|---|---|
| 100:0 | 17.97 | 17.98 | 17.97 | 90.0 | 90.0 | 90.0 | 5805.2 |
| 67:33 | 17.95 | 17.95 | 17.94 | 90.0 | 90.0 | 89.9 | 5781.9 |
| 33:67 | 17.92 | 17.92 | 17.91 | 90.2 | 89.9 | 89.9 | 5753.1 |

Additionally, Zr-fum₆₇-mes₃₃-fcu-MOF membranes offer excellent thermal stability. Both the N₂ permeance and the N₂/CH₄ selectivity increased at elevated temperatures, with apparent activation energies for the N₂ and CH₄ permeation at 6.8 and 4.4 kJ mol¹, respectively (FIGS. 69A-B). Zr-fum₆₇-mes₃₃-fcu-MOF membranes show a superior performance than other membranes in terms of both N₂ permeance and N₂/CH₄ selectivity, surpassing the upper bounds for polymeric and zeolite membranes (FIG. 55A).

For practical applications, N₂/CH₄ separation at high pressures (30-60 bar) is preferred. For zeolite membranes, e.g. state-of-the-art SSZ-13 membranes, high feed pressure leads to severe selectivity loss, decreasing by a half to only ˜6 for a 25 bar feed (FIG. 55B). By contrast, when the feed pressure is elevated to 50 bar and the permeate side is maintained at 1 bar without sweep gas, Zr-fum₆₇-mes₃₃-fcu-MOF membranes still maintain excellent N₂/CH₄ separation performance (FIG. 55B). The N₂ permeance decreases at higher pressures due to the nonlinear adsorption behavior of the Zr-fum₆₇-mes₃₃-fcu-MOF, but without notable effect on selectivity (FIG. 70).

In terms of absolute N₂ flux and N₂/CH₄ selectivity, Zr-fum₆₇-mes₃₃-fcu-MOF membranes exhibit a N₂ flux more than two orders of magnitude bigger than those of other membranes with reasonable selectivity (i.e., approximately 10) (FIG. 55C; FIGS. 71A-D). Additionally, Zr-fum₆₇-mes₃₃-fcu-MOF membranes suggest exceptional robustness and the separation performance does not degrade after continuous permeation for 150 days (FIG. 55D). The complex feed streams was further mimicked with trace amounts of impurities, e.g. water vapor, hydrocarbons, and corrosive hydrogen sulfide (FIGS. 72A-B). The occurrence of hydrocarbons led to a slight fluctuation in N₂/CH₄ separation, while water vapor and hydrogen sulfide occurrence resulted in decreased permeance owing to their strong affinities to the MOFs, blocking other species. However, once the feed was switched back to normal, N₂/CH₄ separation always reverted back to its initial benchmark values, indicating the excellent membrane stability.

Considering the variability of N₂ concentrations across different natural gas fields, we evaluated the N₂/CH₄ separation performance with varying N₂ concentrations from 5% to 15% in the feed stream. In contrast to zeolite membranes, for which lower N₂ concentration cause reduced N₂ permeance and N₂/CH₄ selectivity, both N₂ permeance and N₂/CH₄ selectivity of Zr-fum₆₇-mes₃₃-fcu-MOF membranes increased at lower N₂ concentrations (FIGS. 73A-B). The slightly enhanced permeance is attributed to the nonlinear adsorption behavior for nanoporous membrane materials (FIG. 70). Notably, this pressure-resistant behavior is maintained at low N₂ feed concentrations at elevated pressures of 50 bar, as exemplified by the use of a 15% N₂/85% CH₄ feed stream (FIGS. 74A-B).

The excellent performance at low N₂ concentrations drove the exploration of the possibility of purifying natural gas from ternary mixtures, namely simultaneously removing CO₂ and N₂ from CH₄, given that CO₂ molecule also shows a linear configuration. When a ternary mixture containing 35% CO₂/15% N₂/50% CH₄ at 10 bar was used as the feed, the membranes offered an average CO₂ and N₂ permeance of 6432 and 3098 GPU, respectively, and average CO₂/CH₄ and N₂/CH₄ separation factors of 28.5 and 15.5, respectively (FIG. 55E). Taking CO₂ and N₂ together as a single contaminant with a concentration of 50% in the feed gas, an overall removal permeance of impurities (CO₂+N₂) of 5344 GPU and impurity/CH₄ separation factor was derived, namely α((CO₂+N₂)/CH₄), of 24.6 (FIG. 55E). Again, the pressure-resistant capability of Zr-fum₆₇-mes₃₃-fcu-MOF membranes provided stable operation at high pressures up to 50 bar (FIG. 55F; FIG. 75A-B). The simultaneous removal of CO₂ and N₂ from CH₄ using membranes has scarcely been reported except for rare examples of polymers and mixed-matrix membranes, probably owing to poor N₂-removal efficiency under low N₂ concentrations for other membranes. Compared with others, Zr-fum₆₇-mes₃₃-fcu-MOF membranes exhibit a better separation selectivity and a three orders of magnitude higher permeance.

In addition, pore-aperture-edited MOF membranes exhibited the potential to separate other gases (FIG. 76). Through stepwise pore-aperture editing, originally less effective frameworks were transformed into highly selective ones. Furthermore, Zr-fum₆₇-mes₃₃-fcu-MOF membranes supported on cheap SSN exhibited similarly excellent separation performance, including high feed pressures up to 50 bar, at low N₂ feed concentrations, and in CH₄ purification from ternary mixtures (FIGS. 77-80).

### Technoeconomic Analysis

To evaluate the energy and cost savings of our membranes for nitrogen rejection, a process simulation using Aspen Plus® was performed. As a base scenario, a conventional cryogenic distillation process was first modeled (FIG. 81), using 15% N₂/85% CH₄ or 50% N₂/50% CH₄ as feed and targeting a CH₄ purity with 3% N₂²⁴. The model indicates that 3.75 MW of energy duty for a 1000 kmol h⁻¹ feed is required.

When membranes are applied, for the 50% N₂/50% CH₄ feed, the membrane alone cannot provide the required purity; therefore, a hybrid system is needed, where the membrane acts as a pre-separator to reduce the load on columns. The model shows 67% of the total energy of distillation columns can be saved using the membrane-distillation hybrid system, translating to 74% utility cost savings (FIG. 55G). For the 15% N₂/85% CH₄ feed, the membrane can virtually replace the cryogenic distillation system. Moreover, because the membrane is N₂-selective and the purified CH₄ retentate is maintained at the high-pressure side, no recompression is needed; therefore, all of the energy associated with the column can be saved (FIG. 55H).

For the total purification costs, massive cost reduction was observed using membranes, regardless of the membrane price or stream composition (FIGS. 55J-K). For the 50% N₂/50% CH₄ feed, ˜66 k tons of CH₄ was purified, with a ˜32% reduction in purification cost (FIG. 4j). Meanwhile, for the 15% N₂/85% CH₄ feed, ˜114 k tons of CH₄ was purified, with a ˜66% reduction in purification cost (FIG. 55K).

The simultaneous removal of CO₂ and N₂ from natural gas using membranes was also evaluated. Particularly, amine-based CO₂ capture was simulated by simulating methyl diethanolamine (MDEA) absorption of a stream composition of 35% CO₂/15% N₂/50% CH₄ which requires 11.5 MW heating duty and 10.9 MW cooling duty for CO₂-removal, translating to US$0.34 MMBtu⁻¹ (Metric Million British thermal unit) of purification cost. Combined with the costs of N₂-rejection columns for sequential N₂-removal, the total energy duty and utility cost for the removal of CO₂ and N₂ are 26 MW and US$1.58×10⁶, respectively (FIG. 55I). Accordingly, the CH₄ purification cost is increased to US$0.62 MMBtu⁻¹. By contrast, for this particular stream composition (35% CO₂/15% N₂/50% CH₄), the membrane can virtually replace the amine and cryogenic combination to simultaneously remove CO₂ and N₂, saving 100% of the heating and cooling duties and delivering the required purities to reach pipeline specifications (Table 15). Ultimately, for the 35% CO₂/15% N₂/50% CH₄ feed, ˜72 k tons of CH₄ was purified, and deployment of our membranes reduced purification costs by ˜73%.

TABLE 15
Stream composition of the membrane process for simultaneous
CO₂ and N₂ removal from the 35% CO₂/15% N₂/50% CH₄ feed.

| | | | |
|---|---|---|---|
| Stream name | NATGAS | CH4MEM | N2MEM |

Mole Flows (kmol/h)

| | | | |
|---|---|---|---|
| CH₄ | 500 | 467 | 33 |
| N₂ | 150 | 9.9 | 140.1 |
| CO₂ | 350 | 10.85 | 339.15 |

Mole Fractions

| | | | |
|---|---|---|---|
| CH₄ | 0.5 | 0.957458 | 0.064422 |
| N₂ | 0.15 | 0.020297 | 0.273499 |
| CO₂ | 0.35 | 0.022245 | 0.662079 |

### Defective MOF Frameworks as Fillers for MMM for Enhanced Separation and Plasticization Resistance

Industrial separations are usually based on the thermal-driven process, which consumes around 50% of the total energy input in industry. In particular, natural gas processing is by far the largest gas separation application in the world and the associated purification is also one of the most energy intensive processes. Carbon dioxide (CO₂) is one of the common contaminants in raw natural gas—that needs to be removed since it often causes pipeline corrosion during the transportation. Conventional CO₂ removal in industry is accomplished by amine-based absorber-stripper units, which consumes vast energy duties for heating and cooling. In contrast, a transition from the thermal methods to energy-efficient nonthermal technologies, such as membranes, may present an opportunity to reduce the associated energy consumption by 90%.

In the past decades, various types of membranes have been extensively studied for CO₂/CH₄ separation, including inorganic crystalline membranes and organic polymer membranes. Usually inorganic membranes are expected to show both high permeability and high separation selectivity, such as polycrysalline zeolite or metal-organic framework (MOF) membranes. However, challenges associated with the large-scale membrane fabrication have prohibited their real-world application. On the other hand, organic membranes that based on the solution-processable polymers are scale-up friendly, and accordingly the current membrane market is largely dominated by polymer membranes. However, there are still two pitfalls for the deployment of polymer membranes. First, their separation performances are usually hinted by an upper-bound trade-off between CO₂ permeability and CO₂/CH₄ separation selectivity, so the mutual improvement on the permeability and selectivity is challenging. Second, polymer membranes are largely susceptible to plasticization at typical natural gas processing pressures (30-60 bar), where the high-pressure CO₂ cause the polymer chains to swell, thus accelerating the diffusion of CH₄ and decreasing the CO₂/CH₄ separation selectivity. A number of commercialized upper-bound polymer membranes have been found to suffer from plasticization and show dramatically diminished separation performance under high pressures. Accordingly, a practical membrane for CO₂/CH₄ separation must show preserved separation performance at high pressures.

In order to break the upper-bound trade-off among polymer membranes, incorporating microporous fillers (e.g. MOFs) into the polymer matrix to construct mixed-matrix membranes (MMMs) is considered a promising strategy, since it combines superior separation ability from the fillers and the solution processability from polymer matrix. However, in the molecular scale, the microporous fillers and polymer chains are still isolated from each other, with the polymer chains being still highly mobile. As such, the challenges acclimated with the plasticization continue to affect the practical utilization of MMMs under high pressures. On the other hand, in order to enhance the plasticization resistance of the polymer membranes, one conventional strategy is to crosslink the polymer chains with the purpose of decreasing their mobility and limit their swelling. However, this approach is usually at the price of reducing CO₂ permeability. An alternative route is to use MOFs with exposed open metal sites as fillers for MMMs, such as MOF-74. The high porosity of MOFs can avoid the decreasing of CO₂ permeability, while the open metal sites are expected to interact strongly with the polymer chains to restrict their mobility, leading to the enhanced plasticization resistance. Despite that, due to the large pore size of MOF-74 that lacks of molecular sieving ability, the contribution to the selectivity improvement is less significant and the membrane performance is still below the upper bound.

Embodiments herein describes the deployment of defective metal-organic frameworks as the fillers in mixed-matrix membranes for the simultaneous enhancement of separation performance and plasticization resistance.

There is a seesaw dilemma for the selection of fillers in MMMs. On one hand, ultra-microporous fillers with the aperture size of <6 Å is effective to mutually improve CO₂ permeability and CO₂/CH₄ separation selectivity and go beyond the polymer upper bound. However, the lack of open metal sites or the narrowed apertures that prevent the polymer chains to penetrate for intereaction, makes these MMMs prone to plasticization and lose selectivity under practical pressures. Contrastly, fillers with large pore apertures and abundant open metal sites are able to impart plasticization resistance, but the improvement to separation performance is not substantial enough.

To balance the two requisites, the defect engineering approach to MMMs is demonstrated, where a defective Zr-fum-fcu-MOF is used as a filler in order to mutually enhance CO₂/CH₄ separation performance and plasticization resistance (FIG. 82). The existence of defects is shown within the nanofillers without spoiling the separation selectivity. In particular, the narrowed triangular windows of Zr-fum-fcu-MOF are beneficial to improve CO₂/CH₄ separation, while the large-size apertures as well as the uncoordinated Zr open metal sites resulting from the missing-linker or missing-cluster defects can contribute to strengthen the intereaction between polymer chains and fillers to form a potential inter locking, thus enhancing plasticization resistance (FIG. 83). Accordingly, the resultant defective Zr-fum-fcu-MOF/6FDA-DAM MMM with 52.7% MOF loading shows improved CO₂/CH₄ separation, breaking the polymer membrane upper bounds, and represents one of the best-performing membranes under practical operation pressure of 50 bar (FIG. 84). The amount of MOF loading can be about 40%, about 50%, about 60%, between about 30% and 70%, between about 40% and about 60%, or between about 45% and 55%, for example.

It is shown that the defective nature of the fillers does not necessarily result in decreased separation selectivity. Indeed, there is almost no influence in selectivity when the defects are not inter-connected. On the other hand, the defects in Zr-fum-fcu-MOF that give rise to hierarchical porosity and open metal sites, are proved critical to mutually enhance the separation capability and plasticization resistance of the MMMs. The resulted MMM with an ultrahigh filler loading of 52.7% shows the best CO₂/CH₄ separation performance at the practical pressure up to 50 bar, with the CO₂ permeability higher than 2100 bar and CO₂/CH₄ separation selectivity above 20, which can meet the industrial requirements. Since plasticization is a major pitfall that prohibits the implementation of many solution processable upper-bound membranes, it is anticipated that the rational utilization of defects in MOF fillers represents an easy yet effective solution to this problem, especially for the separation of highly plasticizing gases.

1. A method of making a continuous metal-organic framework membrane, the method comprising:
contacting a rare earth- or zirconium-containing compound, an acid, a solvent, and optionally water, sufficient to form a hexanuclear cluster solution;
contacting the hexanuclear cluster solution with one or more ditopic ligands, sufficient to form a metal-organic framework (MOF) solution;
contacting the MOF solution with a support;
applying a current to the MOF solution with support, sufficient to provide a continuous fcu metal-organic framework membrane.

2. The method of claim 1, wherein the rare earth-containing compound comprises one or more of La, Ce, Pr, Nd, Sm, Eu, Gd, Dy, Ho, Er, Tm, Yb, Lu, Tb or Y, for example, terbium (Tb3+) and yttrium (Y3+).

3. The method of claim 1, wherein the rare earth-containing compound comprises yttrium.

4. The method of claim 1, wherein the acid comprises one or more of 2-flouro benzoic acid, formic acid, acetic acid, and propionic acid.

5. The method of claim 1, wherein the solvent comprises one or more of DMF, water, and methanol.

6. The method of claim 1, wherein the one or more ditopic ligands comprises one or more of carboxylate or tetrazolate functional groups, fumaric acid, mesaconic acid, terephthalic acid. 1,4-naphthalenedicarboxylic acid, 2-aminoterephthalic acid.

7. The method of claim 1, wherein the support comprises stainless steel or alumina.

8. The method of claim 1, wherein the support further comprises a conductive layer.

9. The method of claim 8, wherein the conductive layer comprises one or more of Pt, Pd, and Au.

10. The method of claim 1, wherein the fcu metal-organic framework membrane comprises one or more of Y-fum-fcu-MOF, Zr-fum-fcu-MOF, Y-mes-fcu-MOF, Zr-mes-fcu-MOF, Y-tpa-fcu-MOF, Zr-tpa-fcu-MOF, Y-naph-fcu-MOF, Zr-naph-fcu-MOF, and Y-aminotpa-fcu-MOF, and mixed ligand combinations.

11. The method of claim 1, wherein applying a current comprises applying about 0.1 mA/cm² to about 2.5 mA/cm², about 0.2 mA/cm² to about 2 mA/cm², about 1.2 mA/cm² to about 1.8 mA/cm², about 1.5 mA/cm², about 0.15 mA/cm² to about 0.3 mA/cm², about 0.25 mA/cm².

12. A continuous metal-organic framework membrane system, comprising:
a support; and
an fcu metal-organic framework membrane layer positioned on at least a portion of the support and wherein the fcu metal-organic framework membrane comprises a thickness of less than about 150 nm.

13. The system of claim 12, wherein the support comprises one or more of stainless steel or alumina.

14. The system of claim 12, wherein the fcu metal-organic framework membrane layer comprises one or more of a rare earth or zirconium fcu metal-organic framework membrane layer.

15. The system of claim 12, wherein the fcu metal-organic framework membrane layer comprises one or more of Y-fum-fcu-MOF, Zr-fum-fcu-MOF, Y-mes-fcu-MOF, Zr-mes-fcu-MOF, Y-tpa-fcu-MOF, Zr-tpa-fcu-MOF, Y-naph-fcu-MOF, Zr-naph-fcu-MOF, and Y-aminotpa-fcu-MOF, and mixed ligand combinations.

16. The continuous metal-organic framework membrane system of claim 12 for the separation of gases.
